(19) United States
(12) Patent Application Publication
(10) Pub. No.: US 2004/0204861 A1
(43) Pub. Date: Oct. 14, 2004

(54) Evolution-based functional proteomics

(76) Inventor: Steven Albert Benner, Gainesville, FL (US)

Correspondence Address: Steven A. Benner, 1501 N.W. 68th Terrace, Gainesville, FL, 32605-4147, US

(21) Appl. No.: 10/349,819

(22) Filed: Jan. 23, 2003

(51) Int. Cl. G06F 19/00

(52) U.S. Cl. 702/19

(57) ABSTRACT

This disclosure describes processes that permit a scientist to generate experimentally testable hypotheses concerning the function of a protein starting from an evolutionary analysis. This begins with a process to determine relative and absolute dates of events in the molecular record by examining exchanges involving transitions at silent sites in two or more DNA sequences. A process is then disclosed for determining, for a specific lineage, features of the divergent evolution of the protein family. Processes are then disclosed that use these as tools to identify, at the level of hypothesis, protein pairs that are functionally linked, including functional interactions in pathways and regulatory networks. Processes are then disclosed that use these tools to correlate events recorded in the molecular sequence record with events recorded in the paleontological and geological records, permitting the association of genes with preselected physiologies in higher organisms. Processes are also disclosed for hypothesizing changes of functional behavior within a protein family. Also disclosed are computer systems comprising databases that support the performance of these processes.

### FIELD OF THE INVENTION

This invention relates to the area of computational interpretive genomics, more specifically to computational methods for analyzing evolutionary relationships between genes and proteins to generate information about, understanding of, and hypotheses about, their structure and function. More particularly, the invention pertains to methods that extract information from homologous proteins by analyzing patterns of variation at specific sites in a sequence alignment, analyzing simultaneously multiple sites in these alignments, using evolutionary relationships between proteins to support these analysis, reconstructing ancestral states for protein families, and correlating in time events in the molecular, paleontological, and geological records.

### BACKGROUND

Proteins are linear polypeptide chains composed of 20 different amino acid building blocks. They are synthesized from genes made of DNA, where three nucleotides in the DNA sequence encode each amino acid in the protein sequence. Determining the sequence of amino acids in a protein is now experimentally routine by direct chemical analysis of the proteins themselves. Further, protein sequences can be deduced by translation of the DNA sequences of genes that encode proteins, provided that start sites, stop sites, and intron boundaries are correctly identified. Thousands of DNA sequences are determined every day in laboratories around the world; many of these encode protein sequences. Thus, DNA sequencing is today contributing the most to the growth of the protein sequence database. The size of protein sequence databases will grow explosively over the next decade, and the growth is expected to continue throughout the century.

Genomic sequence data are widely believed to hold the key to a revolution in biology. This belief is the primary drive for the collection of new sequence data. For that revolution to occur, however, processes must be invented that help biological scientists generate hypotheses about protein structure and function. These goals determine the utility of processes that analyze protein sequences. Further, to support these processes, genomic data must be placed within database structures that are able to assist scientists who wish to retrieve sequences from the database and analyze them. These goals create some of the utility of database structures.

When analyzing sequence data, a substantial premium is placed on processes that are purely computational, or that combine computation with only limited experimentation. Experiments are expensive. Genomic data are not, or more precisely, their cost has already been sunk. Further, in modern science, the number of experiments that are possible is astronomical. Any guidance that can be gotten by computer analysis of a genome sequence that will help an experimentalist decide which of many possible experiments to do next will have utility.

For this reason, functional bioinformatics processes need not generate “indisputable conclusions” for them to have a broad utility. The utility would be substantial if the process did nothing more than suggest a hypothesis about the function of a gene, or rule out protein families as relevant for a function, especially if that hypothesis targets subsequent experiments.

This is well known to one of ordinary skill in the art. Biological science is driven by useful hypotheses, where the utility of a hypothesis is determined largely by its testability, and the degree to which the hypothesis can provides focus. Even incorrect hypotheses have been useful, when they led to a focused test.

Supreme Court decisions have noted that any process having novelty and utility is patentable, even if it involves computational steps. As a consequence, new database structures have been patented. An example is U.S. Pat. No. 6,023,659 (Seilhamer, et al., “Database system employing protein function hierarchies for viewing biomolecular sequence data”, Feb. 8, 2000) [Sei00], which covers a computer system that comprises a database that names a function to a protein using an organized hierarchy. Likewise, processes that involve computational analysis of sequence data have been patented. An example is U.S. Pat. No. 6,280,953 (Messier, et al. “Methods to identify polynucleotide and polypeptide sequences which may be associated with physiological and medical conditions”, Aug. 28, 2001) [Mes01], which provides methods for identifying polynucleotide and polypeptide sequences in human and/or non-human primates which may be associated with a physiological condition, such as disease (including susceptibility (human) or resistance (chimpanzee) to development of AIDS) or enhanced breast development. As a demonstration of the utility of evolutionarily organized (also known as naturally organized) databases and computational manipulations of these, the MasterCatalog is a commercial product sold by EraGen Biosciences under license to U.S. Pat. No. 5,958,784.

The Distinction Between Function and Behavior

Generating hypotheses concerning possible biological functions that a gene might have is part of the “annotation problem” in modern interpretive genomics. “Annotation” and “function” mean different things to different people. Much literature treats “function” in terms of “behavior”, what is measured in the laboratory. Crystallographers occasionally view “function” in terms of “structure”. Throughout this disclosure, we distinguish between “homology” (relationship by common ancestry), “structure” (at two levels, as known in the chemical arts, “constitution”, meaning “sequence”, and “conformation”, which is commonly referred to as “the fold” or, incorrectly, “the structure” by structural biologists), “behavior” (what is measured in the laboratory), and “function”. Under Darwinian theory, “function” in a protein refers to adaptive behavior, properties that confer fitness, the ability of an organism to survive and reproduce. The Darwinian paradigm holds that the only way to achieve function is by random variation of genetic structure (mutation) followed by natural selection.

A statement concerning the function of a gene is ultimately a statement about how that gene contributes to the fitness of the host organism. For this reason, orthologous proteins in different species generally do not have identical functions, as different species have different requirements for fitness. They may, however, have “analogous” functions. As we disclose below, even subtle differences in function between orthologous proteins in different organisms can be interesting, and can be the key to delivering a useful understanding of “function” to biological and biomedical scientists. Therefore, tools that suggest (again, as a hypothesis) that the function of two homologous genes might be different are frequently as useful as those that suggest that the two genes have analogous functions.

Prior Art Concerning the Features of Proteins Divergently Evolving Under Functional Constraints

In the mid 1970's, a relationship between evolutionary ancestry and protein conformation was established. In 1976, for example, Rossman noted that lactate, glyceraldehyde-3-phosphate, and alcohol dehydrogenases acting on quite different substrates all have a domain that folds to give a parallel sheet flanked by helices (a “Rossman fold”).[Rossman, M. G., & Argos, P. (1976). Exploring structural homology of proteins. J. Mol. Biol. 105, 75-95]. These proteins displayed no strong sequence similarity, however, and the conclusion that the proteins were homologous (related by common ancestry) was based on an analogy between the folds. Thus, by the time of filing of Ser. No. 07/857,224, this and other contributions had already taught one of ordinary skill in the art that homologous proteins can have diverged so much that no significant sequence similarity remains between them, even though their overall folds might be the same. As is well known to those skilled in the art, sequence analysis becomes ineffective as a tool to establish homology after sequence identity between two homologous proteins drops below approximately 25% for a protein of typical length, depending on how gaps are treated, and certainly when identity drops below ca. 20%.

Since 1976, many have attempted to exploit the fact that homologous proteins have the same fold as a tool for predicting fold. For cases where the target protein was sufficiently similar in sequence to a protein with a known conformation to establish homology with reasonable statistical similarity, “homology modeling” was used. Homology modeling is best defined strictly as a process for building a model of the conformation of a target protein that begins by identifying a protein with known conformation that is a homolog of a target, and uses the homolog as a starting point to model the conformation of the target [May95][Sal95]. At this point (the “twilight zone”), at least some non-homologous sequences from a large database will share the same level of sequence similarity with a target protein as homologous sequences, making it impossible to determine from sequence data alone whether two proteins are homologous or not.

Prior Art on Functional Analyses Using Evolutionary Models. Annotation Transfer

The most common way in which evolutionary analysis is used today in the art to annotate sequences exploits pairwise sequence comparisons to detect homology between two proteins. The conventional process for inferring the “function” of a target open reading frame (the target sequence) using evolutionary analysis comprises five steps:

1. Use the target sequence as a probe in a BLAST [Alt90] or FASTA [Lip85] search of the Genbank database (or an equivalent).

2. Identify “hits”, proteins in the database whose sequence resembles that of the target.

3. Evaluate the hits based on a statistical model.

4. Download the annotation of the statistically best hits that have functional annotation of their own.

5. Infer that the function of the target protein is the same as the function of the best protein hit

This process is known as “annotation transfer”. The annotation known (or believed) for one protein is transferred to its homolog, and becomes the annotation of the homolog.

Those annotating genomic sequences using this process recognize several of its limitations. These include:

(a) The BLAST server returns no hits.

(b) The BLAST server returns sequences of possible homologs, but with similarity scores too low to be certain that the sequence found is indeed a homolog.

(c) The homologous sequences that the server returns have no annotation indicating function.

The consequences of these problems are mentioned in most contemporary reviews of genomics. Because of the limitations of the annotation transfer process, some 40% (depending on the details of the homology search) of the proteins in a typical genomic sequence have not been reliably assigned any function. It is well recognized that this arises because as powerful as it is, BLAST cannot detect homologs after their sequences have diverged far into the “twilight zone” of sequence similarity [Doo87]. For this reason, tools that detect more distant homology are being actively sought.

Prior Art Resolving the “No Interesting Hit” Problem with Annotation Transfer

To solve this “no interesting hit” problem, many workers have attempted to extend the power of the pairwise alignment tool to detect increasingly distant homologous protein sequences. For example, the concept of a “profile” was developed by Eisenberg and his coworkers [Gri87] in the late 1980's for this purpose. To do a profile analysis, a set of sequences of members of a protein family is examined. The sequence similarities in this set of proteins must be sufficient to establish that the proteins in the set are homologous and adopt the same fold. A multiple alignment of the sequences is then constructed. Then, for each position in the multiple alignment, a position-specific scoring matrix is constructed using as input the amino acids at that position for each protein in the multiple alignment. A “profile” of the protein is the collection of each of these matrices for each position for the entire protein sequence alignment. The sequence of a protein that is a possible homolog of family (but whose sequence is too dissimilar from that of any individual member of the family to give a score that is statistically adequate) is then matched against the profile and scored. If a particular amino acid is conserved at position i in a protein sequence family, a match with a putative distant homolog having that amino acid contributes to the score more than a comparable match where the amino acid is not conserved. If the score is high, the hypothesis that the protein is a possible homolog of the family is strengthened.

In practice, profile analyses identify many proteins in a database that are possible homologs, where the correct “hits” are buried in a large number of false positives. For this reason, profile analysis is virtually useless as a tool for excluding the possibility that two proteins are homologous, or contain the same core fold.

Another approach for identifying long distance homologs when alignment scores are statistically marginal is to search for sequence “templates” or “motifs”, short segments of polypeptide chain that might be conserved over long distances [Tay86][Tay84][Wie86]. Here, the presence of analogous motifs in two protein sequences can be used to infer long distance homology between a target protein and a protein with known conformation, and from this inference, a model of the target protein can be modeled on the structure of the other. As with profile modeling, the presence of a template is not a reliable indicator of long distance homology and similar fold. For example, in the first example presented in Ser. No. 07/857,224 (for protein kinase), several groups had noted that the protein has a sequence motif Gly-Xxx-Gly-Xxx-Xxx-Gly (where Xxx is any amino acid) [Ste84]. Further it was noted that a similar motif was found in adenylate kinase, where a crystal structure was known. Therefore, it was proposed that the two structures are homologous. From this proposal, it was deduced in the literature that protein kinase would adopt the same fold as adenylate kinase.

This proposal was proposed in Ser. No. 07/857,224 to be incorrect, and later shown to be incorrect experimentally [Kni91]. Further, motif analysis failed to infer the absence of homology. A higher order of sequence analysis was required to have utility. In this higher order analysis, patterns of variation and substitution at individual sites different from those expected by simple stochastic (and/or Markovian) models carry information. Patterns of variation and substitution at multiple sites must be examined. Patterns of variation and substitution at sites in different proteins must be examined and correlated.

The prior art ideas of profiles and motifs have been reworked many times since their introduction. Especially prominent in the art, even today, are Hidden Markov Models (HMMs) and neural networks designed to detect distant homologs by seeking similarity between the sequence of a distant homolog to a profile extracted from a family of aligned sequences. These HMMs and neural networks displayed few innovative features beyond those already present in the original work by the Eisenberg group [Gri87].

As they are normally constructed, profiles and HMMs are deficient because they would be biased should the family database contain may copies of the same protein, and many copies of closely related proteins. It is remarkable that the prior art does not seem to contain a case where it was recognized, as it was in Ser. No. 08/914,375, that the correct way to resolve this problem involves using an evolutionary model that computes a tree, and uses as the “profile” the reconstructed ancestral sequence near the root of the tree. For example, Lipman and his coworkers in 1997 [Neu97] described a fully automated program for constructing profiles from alignments, and attempted to avoid this deficiency. Instead of implementing the evolutionarily correct approach, they simply removed closely related sequences, and noted that this generated results similar to those generated by a weighting scheme described by Henikoff and Henikoff [Hen94].

Prior Art Resolving the “No Interesting Hit” Problem with Annotation Transfer Disclosed in Ser. No. 08/914,375

The evolutionarily correct way to construct a position-specific scoring matrix was disclosed in Ser. No 08/914,375. In the invention disclosed therein, the ancestral sequences at nodes in the corresponding evolutionary trees are reconstructed for a protein family. Processes that reconstruct ancestral sequences at nodes within an evolutionary tree are well known in the art. The sequence associated with the node placed at the center of gravity (or, more preferably, the actual root) of the tree (the “Founder Sequence”) is then used as a surrogate for all of the descendent sequences. It is, from an evolutionary perspective, the sequence that is closest to any outgroup sequence, that is, the sequence that is the closest to any distant homolog. For that reason, the Founder Sequence will give the highest score of any sequence derived from the set of sequences within the family to any true analog. Further, because the Founder Sequences is constructed using a per stirpes analysis, the problem of redundancy within or non-equal representation by subfamilies is avoided.

The surrogate database of Founder Sequences is much smaller than the complete database that contains the actual sequences for each protein in the families, as each Founder Sequence represents many descendent proteins. Further, because there is a limited number of protein families on the planet, there is a limit to the size of the surrogate databases. Based on our work with partial sequence databases [Gon92], Ser. No. 08/914,375 anticipated that there would be fewer than 10,000 families after all of the genomes of all of the organisms on Earth (the global genome) are sequenced.

In Ser. No. 08/914,375, the number of families (the concepts of “nuclear” and “extended” had not yet been introduced) was estimated to be ca. 10,000, based on analyses of Dorit et al. [Dor90], Chothia et al. [Cho92], and Gonnet and Benner [Gon92]. We now know that the number of nuclear families will likely be closer to 100,000 when the global biosphere is totally sequenced.

A collection of all of the families in the database, with each family being represented by a multiple sequence alignment, an evolutionary tree, and a Founder Sequence, constitutes a naturally organized database (NOD). The first value of a NOD as disclosed and claimed in Ser. No. 08/914,375 is that it is rapidly searchable. As disclosed in Ser. No. 08/914,375, searching the surrogate databases for homologs of a probe sequence proceeds in two steps. In the first, the probe sequence (or structure) is matched against the database of Founder Sequences. As there will be on the order of 100000 families of proteins after all the genomes are sequenced for all of the organisms on Earth, there will be only on the order of 100000 match attempts. Thus, this search will be far more rapid than with the complete databases.

A NOD can also contain the reconstructed sequences at some or all of the internal nodes, as well as all of the nucleotide substitutions and amino acid replacements that occurred along each branch (“change reports”). Because the ancestral sequences and reports occupy a significant amount of storage space, and because these are usually transformed to provide useful information, it is often useful to construct in the database derivative functions. Thus, claims are appropriate for a full database of ancestors, containing all reconstructed ancestral sequences, or for a full database of ancestral events, containing all of the nucleotide substitutions and amino acid replacements that occurred along branches of the tree, or both. Claims are also appropriate for a database containing one or more features calculated from the ancestral sequences, or calculated from the nucleotide substitutions and amino acid replacements that occurred along branches of the tree, or both. Even in 2002, no database exists that implements the features disclosed herein with respect to dating events by examination of silent substitutions. They are clearly useful.

One can chose the features of a model to be delivered in a pre-computed form for the purpose needed by the user. It is possible even to iterate a cycle, building models for the global proteome using an inexpensive tool, determining the characteristics of sequence evolution from the resulting families, refining the model, and then iterating to build a better model, and then returning after the model is built to simpler tools to analyze individual site replacement patterns.

As noted in Ser. No. 08/914,375, additional utility is provided for an evolutionary model if episodes in the history of a protein family represented by nodes and branches of an evolutionary tree and episodes recorded in other historical records, in particular, in the species, paleontological and geological records. The enhanced model places explicit dates on key nodes in the tree. Not every node must carry a date for the dating to be useful, as dates can be interpolated. Such data structures are novel, and are claimed here.

Should the search yield a significant match, the probe sequence is identified as a member of the family whose Founder was matched. The probe sequence is then matched with the members of this family to determine where it fits within the evolutionary tree defined by the family. The multiple alignment, evolutionary tree, and reconstructed ancestral sequences may be different once the new probe sequence is incorporated into the family. If so, the different multiple alignment, evolutionary tree, and predicted secondary structure are recorded, and the modified reconstructed ancestral sequence and structure are incorporated into their respective surrogate databases for future use.

The advantage of this data structure over those used when Ser. No. 08/914,375 was filed is apparent. As presently organized, sequence and structure databases treat each entry as a distinct sequence. Each new sequence that is determined increases the size of the database that must be searched. The database will grow roughly linearly with the number of organismal genomes whose sequences are completed, and become increasingly more expensive to search. The search time for a NOD, as disclosed and claimed in Ser. No. 08/914,375, will never dramatically increase once most of the families in the global biosphere have been identified.

Prior Art Resolving the “No Interesting Hit” Problem with Annotation Transfer Disclosed in Ser. No. 07/857,224

Other approaches for detecting distant homologs have been based on the fact that proteins diverging under functional constraint can retain their core folded structure long after sequence similarity has vanished [Ros75]. This makes possible the detection of distant homology by comparison of protein structures. When experimental structures are not known, predicted structures are needed.

Ser. No. 07/857,224, filed Mar. 25, 1992, and issued as U.S. Pat. 5,958,784 on Sep., 28, 1999, provided the first useful processes to predict the folded structure (or “conformation”) of proteins from sequence data. These were based on an evolutionary analysis of patterns of variation and conservation within a family of homologous protein sequences diverging under functional constraints.

Ser. No. 07/857,224 also showed for the first time how predicted structures could be used to generate the hypothesis that two families of proteins are (or are not) distantly homologous. Thus, the process disclosed in Ser. No. 07/857,224 partly alleviated the difficulties outlined above with the annotation transfer process. Predicted structures could be used to confirm or deny weak suggestions based on sub-statistical sequence similarity that two protein families shared common ancestry, after a Founder-Founder comparison became no longer statistically convincing. Many others have followed this lead, including a particularly interesting study by Barton and his coworkers [Rus96]. These are summarized in a review article showing various applications of this process [Ben97].

Through their ability to detect distant homologs of proteins whose functions are known, the processes disclosed in Ser. No. 07/857,224 have proven to be quite useful because they generate hypotheses about proteins with unknown function. For example, these tools were applied to the heat shock protein 90 (HSP90) family, for which no member had an assigned function. A model for the conformation of the protein was built for HSP90 as part of the CASP2 prediction contest [Ger97]. The conformation model was recognizably similar to the fold for the N-terminal ATP binding domain of gyrase. This generated the hypothesis that HSP90 and gyrase were distant homologs. This generated the hypothesis that HSP90 bound ATP as it contributed to the fitness of its host organisms. This hypothesis contradicted experimental papers available at the time claimed that HSP90 did not bind ATP [Jac96]). The prediction was correct; the experimental papers were incorrect [Pro97]. And this success was recognized both by the CASP2 judges and the group that solved the crystal structure of HSP90, who wrote:

“The tertiary fold of Hsp90N-domain has a remarkable and totally unexpected similarity to the N-terminal ATP-binding fragment of . . . DNA gyrase B protein. This similarity was not initially recognized by the authors of either the human or yeast structures but was determined (by Gerloff and Benner) within the CASP2 structure prediction competition. Our observation of specific ADP/ATP binding to Hsp90 completely contradicts the careful and widely accepted biochemical analysis of Jakob et al. (1996) who demonstrated that Hsp90 could not be photolabelled with 8-azidoATP, was not retained on C8 agarose, and did not enhance the fluorescence of MABA-ADP.” [Pro97]

A year later, the processes disclosed in Ser. No. 07/857,224 were used to analyze functional and structural relationships for ribonucleotide reductase [Tau97]. Other examples in our laboratory and elsewhere are summarized in [Ben97]. These examples showed how very distant homolog detection had utility in annotating gene sequences, simply by generating experimentally testable hypotheses concerning their physiological function.

The inventions disclosed in Ser. No. 07/857,224 were advanced over those in the prior art. Some efforts had been made to use predicted structures (as opposed to experimental structures) to detect long distance homology. For example, Pearl and Taylor [Per87] and Bazan and Fletterick [Baz88] were able to interpret a secondary structure prediction made by consensus GOR prediction for viral proteases with unknown structure to confirm the speculation that these proteases are homologs of aspartic proteases with known experimental structures. Sheridan et al. [She85] were perhaps the first to suggest than an array of predicted secondary structural elements might be used as a query to search proteins of known conformation to detect possible distant homologs. In none of these studies, however, was it recognized that core secondary structural elements must be weighted strongly in this comparison. Nor was is clear how to generate predicted secondary structural elements for the process to have utility.

Prior to Ser. No. 07/857,224, however, no art had concerned itself with the question of how to use predicted structures to show that two proteins were not homologous. While secondary structure predictions, coupled with experimental data, could on occasion detect similar folds (primarily all helical folds), they were clearly insufficiently reliable to permit the exclusion of homologous folds in proteins that had a potential for distant relationship. Both threading and profile analyses methods usually generate long lists of potential targets, without clearly excluding any as homologs.

Tools able to rule out homology will become more important as genome projects begin to produce large numbers of data. As is well appreciated by those of ordinary skill in the art, genome sequencing projects frequently identify the sequence of a protein for which little or nothing is known about its physiological function. Under these circumstances, the most reliable approach for assigning physiological function to a protein is to identify a homologous protein with known function. It is frequently the case that no homolog with known function is known with a sequence similarity that allows a statistically significant case to be made for homology. In these cases, tools that rule out long distance homology are as useful as tools that establish it, as they limit the number possible long distance homologs.

The Need for Processes to Identify Episodes in the Divergent Evolution of Protein Sequences Families Where Function Changes, and Where Function Does Not Change

This discussion so far concerns only the technical problems with applying the annotation transfer process to construct hypotheses about the function of proteins. All of these attempt to address the limitations of the process when it fails to reliably identify homologs that have annotation. Annotation transfer has more fundamental limitations, however, those that lie in the logic that stands behind it. These apply even if a homolog with cultural annotation is provided, where cultural annotation means a linguistic description of the behavior of the protein.

Annotation transfer requires that a simple logic hold:

(a) Sequence similarity between two proteins implies that the two proteins are homologous (share common ancestry).

(b) Homologous proteins have analogous conformations (folds).

(c) Analogous folds implies analogous behaviors (what is measured in the laboratory). Thus, homologous proteins bind analogous ligands, catalyze analogous reactions, and have analogous physical properties.

(d) Homologous proteins have analogous function, that is, they contribute to survival in analogous ways.

These assumptions are widely accepted (see, for example, [Fet98]). Even today, the logic appears to be the only logic that is understood and used by those of ordinary skill in the art. For example, U.S. Pat. No. 6,023,659 [Sei00] assigns function to a new sequence through sequence comparison alone, and defines a product score that starts with a BLAST score as the metric to detect homology. Here, it is assumed that two proteins sharing common ancestry have, for the most part, analogous functions.

The value of the logic is indisputable. Indeed, much of the value of the inventions disclosed in Ser. No. 07/857,224 and its continuations-in-part arise has come when they have identified a distant homolog, permitting annotation to be transferred from it. This was the case with the heat shock protein, mentioned above.

Element (a) has sound statistical basis, at least within the context of a particular evolutionary theory. Element (b) is known from empirical analysis to be generally true, as discussed above, provided that the two proteins have diverged under functional constraints. Elements (c) and (d) are, however, are certainly not universally true, and may not be true in general. Frequently, new function is generated in biological systems by recruitment of a protein that performs a different function.

In the Applicant's view, it was well described in the prior art, even in art generated in the 1980's, that different members of the same protein family can have different functions. Indeed, the Applicant himself, in 1988, long before the genomics revolution began, published a review article pointing out where the logic would fail [Ben88]. Four examples illustrate how severely elements (c) and (d) of the logic can be violated. The first is chosen from eubacterial enzymology, and relates to four enzymes playing three distinct roles in microbial metabolism, fumarase (in the citric acid cycle), aspartase (involved in amino acid degradation), argininosuccinate lyase (in amino acid biosynthesis), and adenylosuccinate lyase (essential for nucleic acid biosynthesis). The four proteins are clearly recognizable as homologs. Their sequences share statistically significant similarity.

Also, the overall folded form of the four proteins is the same (an 8-fold alpha-beta barrel). They catalyze reactions that, at least at a mechanistic level, have some degree of analogy. From a biologist's perspective, however, they have very different functions. The annotation transfer logic used by virtually every genome annotation tool would be defeated by this family.

The second example is from metazoan biology, and involves the family of proteins known as the src homology 2 (SH2) domains. SH2 domains are clearly all homologous. The proteins all have analogous folds and analogous behaviors; they all bind to a polypeptide that carries a phosphotyrosine. But they bind different peptide sequences flanking the phosphotyrosine. For this reason, they have very different functions, as the biologist defines it relative to the demands of fitness, and more significantly, very different behaviors that confer survival value. Some SH2 domains are in viruses, and regulate viral growth. Some participate in the immune response. Others are involved in the regulation of division of non-immune cells. For virtually any practical purpose (pharmaceutical target identification, for example), the analogies between the behaviors of different SH2 domains are less important than the differences in their function.

A third example, placed in the public domain by the inventor in 1989 [Ben89], although not in computational form, involved alcohol dehydrogenases from yeast and alcohol dehydrogenases from mammalian liver. Here, patterns of variation and conservation were different in different branches of the evolutionary tree that represented all of these alcohol dehydrogenases at their leaves. These different patterns reflected different function in the yeast and mammalian alcohol dehydrogenases. On a model for the three dimensional structure of the protein, Benner [Ben89] highlighted those sites that were more mutable in the mammalian alcohol dehydrogenase subfamily, and more conserved in the yeast alcohol dehydrogenase. Many of the sites identified lay at the substrate binding site of the protein, and their replacement correlated with changes in substrate specificity in the protein (although, at the time of the publication, it was not yet clearly recognized that one should reconstruct the ancestral states and correlate changes explicitly with episodes in the sequence evolution). Others were proposed to be involved in the different quaternary structures of the two families of dehydrogenases; the alcohol dehydrogenases from yeast are tetramers, while the alcohol dehydrogenases from mammalian livers are dimers. This represents an early case where non-stationary patterns of mutability, as analyzed by examining the sequences at the leaves of the tree, were analyzed computationally to correlate changing functional behavior with amino acid replacement.

The fourth compares protein serine kinases and protein tyrosine kinases, an important example given in Ser. No. 07/857,224. These families are clearly homologous, the latter having been recruited from the former ca. 600 million years ago. The chemist would say that both classes of enzyme operate via analogous reaction mechanisms, differing only in the source of the nucleophile in the phosphoryl transfer reaction. The biologist would note, however, that the physiological function of the two classes of proteins are greatly different. For any biomedical application, the biologist would be correct. The physiologically relevant differences in behavior, central to the understanding of biological function (phosphorylation on tyrosine versus phosphorylation on serine) cannot be inferred for one family from the other using the conventional logic.

If proteins with recognizable (indeed, often high) sequence similarity can have different functions, the a fortiori argument can be made that surely recruitment is possible for protein homologs with marginally significant sequence similarities. This argument suggest that the focus of efforts, including those disclosed in Ser. No. 07/857,224, might add only some to our ability to provide reliable annotation. Both approaches are needed. Therefore, there is a need in the art for processes that both suggest for and/or against recruitment within a protein family, or suggest both for and/or against changes in functionally significant behavior within a protein family. Such processes are expected to become increasingly more important as the genomes of metazoans are sequenced. It is now clear that the last 500 million years of molecular evolution in higher organisms has involved repeated recruitment of existing folds to perform new functions.

Prior Art Processes to Identify Episodes in the Divergent Evolution of Protein Sequences Families Where Function Changes

Kₐ/Kₛ Ratios and Their Equivalents

One tool for detecting changing functional behavior has become widely accepted within the prior art. This tool is known as the Kₐ/Kₛ ratio; a closely analogous tool is known as the dN/dS ratio, and other ratios appear in other ways in the literature. Basically, the tools all estimate the number of non-synonymous substitutions that separate two genes that encode two homologous proteins, estimate the number of non-synonymous substitutions that separate the two, and compare the two numbers, express the comparison as a ratio of the two numbers, and often adjust the calculation to reflect an estimate of the number of synonymous and non-synonymous sites aligned in the two sequences. If the ratio is higher than a specified value, often chosen to be the value expected for a DNA sequence suffering mutations randomly, the hypothesis is generated that the two proteins differ in some functionally significant way, either at the level of sequence itself (adaptive change in sequence), or in a sequence-derived behavior. Reference is also made to U.S. Pat. No. 6,280,953 [Mes01] for a description of the art in this regard.

The Kₐ/Kₛ tool was originally developed to compare two extant sequences [Li85]. In this implementation, the nucleotide replacements separating two genes were counted as non-synonymous or synonymous depending on whether they altered the sequence of the encoded protein. Normalizing the ratio of non-synonymous:synonymous replacements for the number of non-synonymous and synonymous sites gave the Kₐ/Kₛ ratio. A Kₐ/Kₛ value of unity is expected for a gene wandering neutrally without functional constraints. When the function of a protein is constant, however, non-synonymous changes are usually detrimental, and are therefore removed by natural selection, while synonymous changes are not. The Kₐ/Kₛ value is therefore lower (generally) than unity in a protein divergently evolving under constant functional constraint.

The opposite is often the case when new function (implying at least some new behavior) arises within a protein family. Non-synonymous changes are the only way to change the behavior of a protein to perform its new role. Therefore, natural selection during an episode of functional change favors non-synonymous changes. If these are many, then the Kₐ/Kₛ value is higher than unity.

Tests that exploit the Kₐ/Kₛ ratio have been used to demonstrate the occurrence of Darwinian molecular-level positive selection. For example, McDonald and Kreitman [McD91] proposed a statistical test of neutral protein evolution hypothesis based on comparison of the number of nucleotide substitutions that led to amino acid replacements, and the number of synonymous substitutions in the coding region of a locus. When they applied this test to the Adh locus of three Drosophila species, they concluded that the analysis showed that there might have been adaptive fixation of selectively advantageous mutations. This is a change in “function” that might defeat annotation transfer, although it was not explicitly so designated in this paper. Further cases are reviewed in U.S. Pat. No. 6,280,953 [Mes01]. It should be noted that most of the prior art has been set in the context of an analysis of the classical “neutralist versus evolutionist” debate, which seeks indisputable proof that amino acid replacement has been driven by changing adaptive demands, rather than amino acid replacement reflecting simply a loss of functional constraints on amino acid replacement. Only in the work of the Inventor with David Liberles, under license to U.S. Pat. No. 6,377,893, have these approaches been incorporated into database structures [Lib00].

Prior Art Concerning Changes in Function: Ka/Ks Values Between Ancestral Sequences

A major advance in the Kₐ/Kₛ analysis was made when it was recognized that sequences of genes at nodes within the protein sequence are available, even in approximate form [Pam93][Tra96][Mes97], through the analysis of derived sequences. When they are, the Kₐ/Kₛ ratio can be calculated for individual branches of the tree between nodes. These branches represent individual episodes of sequence evolution.

While academic arguments continue over the precision of the reconstructions (and hence of the Kₐ/Kₛ values calculated using them), these values have been very useful for generating experimentally testable hypotheses [Jer95][Mes97][Ben98]. Consider, for example, the leptin family, discussed in Ser. No. 08/914,375. As noted in that disclosure, an extraordinarily high value of Kₐ/Kₛ is observed in branches leading to the leptin genes in apes from the genes in more primitive primates. The only interpretation of this fact (within the margin of statistical fluctuation) is that mutant leptins conferred more survival value than non-mutant leptins during this episode. In the language of molecular evolutionists, leptin has undergone an episode of adaptive sequence evolution during this period of time. This implies, as a hypothesis, that some aspects of the behavior and function of leptin are changing. This behavioral change, in turn, arises from amino acid replacements.

Here, medicinal chemists seeking to use genomic data find value in hypotheses that relate to the question: Does the mouse offer a good analog (“model organism”) for the human when developing drugs targeted against human obesity. The annotation transfer logic, as well as the Pfam, TIGRfam, Hovergen, and ProDom databases all indicate “yes”. The computer systems disclosed within U.S. Pat. No. 6,023,659 [Sei00] indicate “yes”. The methods disclosed in Ser. No. 08/914,375 indicate “no”, however. This “no” hypothesis has special utility to the user. In particular, it is not surprising that leptin behavior in humans is quite different than it is in mice. Further, the possibility that the computational method might yield a “no” hypothesis makes the “yes” hypothesis more significant when it emerges.

Ser. No. 08/914,375 disclosed yet another utility of having databases with Kₐ/Kₛ values constructed between ancestral sequences: the use of correlated values for the ratio as a tool for identifying receptor-ligand interactions. Drawing 1 of Ser. No. 08/914,375 showed an evolutionary tree was used to show the evolutionary history of the leptin family of proteins. Heavy lines showed branches with expressed/silent ratios higher than 2. These were calculated between ancestral sequences. Hatched lines in this diagram showed branches with expressed/silent ratios from 1 to 2. Dotted lines showed branches with expressed/silent ratios less than 1, or indeterminate. Numbers on the lines indicated the ratio of expressed/silent changes for that branch. An “x” at the end of a branch signified that a sequence for the protein is available in the database.

Drawing 2 of Ser. No. 08/914,375 showed another evolutionary tree showed the evolutionary history of the corresponding leptin receptors. Again, heavy lines showed branches with expressed/silent ratios higher than 2. These were also calculated between ancestral sequences. Hatched lines again showed branches with expressed/silent ratios from 1 to 2. Dotted lines showed branches with expressed/silent ratios less than 1, or indeterminate. Numbers on the lines indicated the ratio of expressed/silent changes for that branch. An “x” at the end of a branch signifies that a sequence for the protein is available in the database.

One of ordinary skill in the art recognized that the evolutionary model for the leptin receptor is not as complete as the evolutionary model for leptin. In particular, fewer primate sequences are available for the leptin receptor than for leptin itself. Thus, the reconstructed ancestral sequences are less precise with the leptin receptor family, and the assignment of expressed and silent mutations to the tree are less certain. Nevertheless, one of ordinary skill in the art would recognize that the leptin receptor family appears to have undergone an episode of rapid sequence evolution at the same time as the leptin family itself. This suggests that the two proteins, the leptin receptor and the leptin protein, interact as they function.

The approximate correlation between the episode of rapid sequence evolution in the leptin family and in the leptin receptor family suggests a need for more advanced processes that correlate episodes in the evolution of protein families. These are provided by the instant invention.

The strengths of the Kₐ/Kₛ tool are matched by some weaknesses. Some of these are practical. Others are theoretical.

From a practical perspective, the accuracy of a Kₐ/Kₛ ratio obtained from ancestral sequences is determined by the accuracy of the reconstructed ancestral sequences, of course. This, in turn, are improved by accurate placement of gaps and having an accurate tree, although maximum likelihood tools lead to ancestral sequences that are less subject to modest changes in the trees than do maximum parsimony tools. Methods for improving gap placement and improving tree construction are provided by the instant invention.

With a well articulated tree, the quality of the reconstructions increases. Thus it is possible to refine the Kₐ/Kₛ ratios assigned to individual branches of the tree by adding more leaves to the tree. This can always be improved by increasing numbers of derived sequences, which permits more reliable reconstruction of ancestral gene sequences. As the most certain feature of our post-genomic future is an increase in the number of sequences, the quality of the reconstructions of ancestral sequences will improve over time.

Also from a practical perspective, the Kₐ/Kₛ calculation cannot be applied when the time separating the two sequences is so large that the nucleotides at the silent sites have equilibrated. This is widely recognized in the art, and may be a reason why many have not used the Kₐ/Kₛ tool for practical applications. The relevant time depends first on the rate constant for silent substitutions. As node-node distances are shorter than leaf-leaf distances, this problem is helped by performing Kₐ/Kₛ calculations between nodes. This too requires that ancestral sequences be reconstructed with some degree of reliability, although it can be shown that any analysis based on more than two sequences must improve the reconstruction of historical events, and therefore diminish the problem of equilibration. However, from the disclosure below, it is clear that the details of a useful evolutionary model can be selected based on these considerations. As the database grows, we expect that more trees can meet these details. Nevertheless, a useful database emphasizes families whose models do display these features.

In principle, the Kₐ/Kₛ ratio also has limitations. For example, this method assumes that codon selection is not strongly selected. Equivalently, the approach as described in the prior art assumes that with synonymous mutations in coding regions are neutral, or nearly neutral. This is certainly not true in eubacteria, or in highly expressed genes in yeast, for example. Frequently, this is known as “codon bias”. Methods for addressing this problem are provided by the instant invention.

Equivalently, the approach as described in the prior art assumes that if codon usage is biased, that the bias is time-invariant. It is known that codon bias can change between taxa that are “closely” (by human standards) related, especially in plants [Tif02]. Methods for addressing this problem are provided by the instant invention.

For other reasons, Kₐ/Kₛ values have limitations as interpretive tools. Even when the function of a protein is changing, some residues (such as those holding together the fold) cannot change without destroying the ability of the protein to serve as a scaffold for function. Thus, the Kₐ/Kₛ value for specific sites can be very high during an episode of divergent evolution, perhaps even much higher than unity. But because Kₐ/Kₛ values are calculated for the sequence as a whole, the sites undergoing rapid substitution are counted with “core” sites undergoing slow substitution, giving a Kₐ/Kₛ value for the protein as a whole of less than unity.

Thus, if directly applied, the Kₐ/Kₛ method of the prior art miss episodes where function is changing. Indeed, while a Kₐ/Kₛ ratio greater than unity compels (subject only to questions concerning statistical significance and the accuracy of the reconstructed sequences themselves) the conclusion that adaptive amino acid replacement has occurred, and that this must be associated with some functionally significant change in behavior, a more useful metric would be one that captures more of the episodes of functional change at a risk of including a few where this inference is not compelled. U.S. Pat. No. 6,280,953 attempted to do this by suggesting a cutoff of 0.75. Improved methods for addressing this problem are provided in the instant invention.

Further, in the leptin-leptin receptor case disclosed in Ser. No. 08/914,375, when correlating the tree of the leptin receptor and the tree of the leptin family to identify branches in one that occurred at the same time as branches in the other, it was assumed that the proteins at the leaves of both trees were orthologs, and that the branches in the trees correlated with speciations. While this may be true for this pair of trees, it cannot generally be assumed to be true from an analysis of sequence data alone, for reasons discussed further below. Further, it was clear that in the example in Ser. No. 08/914,375, Kₐ/Kₛ ratios greater than unity were sought. Thus, the approach will have limited value, for the reasons outlined above, and is in need of improvement. These improvements are part of the instant invention.

Prior Art Processes to Identify Episodes in the Divergent Evolution of Protein Sequences Families Where Function Changes

Non-Stationary and Stationary Gamma Models

Analysis of the stationarity of patterns of mutability within an evolutionary family is an alternative way known in the prior art to infer whether functional behavior is constant, or changing, along a single branch of an evolutionary tree. Some sites in a protein sequence are more mutable than others. Higher mutability might arise from fewer functional constraints on amino acid replacement (implying that the residue at that site is not particularly important for fitness). It may arise from adaptive replacement (implying that the residue at that site is extremely important for fitness).

In the art, the distribution of mutability is modeled using a gamma distribution with a single parameter (known as alpha). This is used in the art to determine the evolutionary distance between sequences using a model that captures more of the reality of sequence divergence than the standard Dayhoff model, which assumes that each site in a protein sequence suffers replacements with equal likelihood.

Generally, the gamma model is assumed to “stationary”. Here, positions that are more mutable in one branch of an evolutionary tree are assumed to be more mutable in every branch of the tree. Positions that are conserved in one branch of a tree are assumed to be the conserved in all branches of the tree. In the gamma model, a single alpha parameter applies everywhere, and recalculation of the alpha parameter for sub-branches of the tree generates (within the statistical variance) the same value for alpha.

In real proteins, the mutability of individual sites need not be the same across the evolutionary tree. This is especially so when the functional behavior of the protein is changing. Homologous proteins have analogous folds even when they perform different functions. But generally, when proteins perform different functions, at least some of the analogous sites within the analogous fold perform different functions, and are subject to different constraints on divergence.

More than a decade ago, the Inventor placed in the public domain in a non-computational form an example where non-stationary behavior in the family of alcohol dehydrogenases from yeast and mammalian liver indicated a change in function [Ben89]. The specific residues that were more mutable in the mammalian alcohol dehydrogenase subfamily, and more conserved in the yeast alcohol dehydrogenase, lay primarily in the active site of the mammalian enzyme. These residues were involved in the changing substrate specificity of the mammalian enzyme, which in turn reflected changing function in the mammalian alcohol dehydrogenase subfamily as the protein evolved to handle different toxins in the liver.

Further, the yeast enzymes are tetramers, while the mammalian enzymes are dimers. This means that some sites involved in quaternary contacts in yeast (and therefore cannot suffer unconstrained divergence) are exposed to solvent in the mammalian enzymes (and are therefore less constrained). In the liver, mammalian enzymes are detoxification enzymes whose substrate specificity is rapidly evolving, presumably to handle different environmental toxins. The rapid sequence evolution in the active site of mammalian enzymes is interpreted as an example of positive adaptation; the substrate specificity of the fungal enzymes is constant, in contrast; they all act on ethanol/acetaldehyde.

Gaucher et al. recently added another example that illustrated the power of coupling an evolutionary analysis with a three dimensional crystal structure ([Gau01]).

This analysis is independent of a Kₐ/Kₛ analysis. Indeed, analysis of the stationarity of the gamma model is often complementary to a Kₐ/Kₛ analysis. First, the Kₐ/Kₛ analysis becomes useless once silent sites have equilibrated. It is less useful if codon bias is significant, or changes over the period of time being examined. Analysis of the stationarity of the gamma model suffers from none of these problems. In contrast, the Kₐ/Kₛ analysis can be applied to events that occurred recently in the history of the family. The tree representing these events may not be sufficiently articulated to apply the stationarity model, because the alpha parameter must be calculated from a larger (preferably more than 10) homologous sequences.

Prior Art Concerning Databases

A key feature of the instant invention concerns the design, construction, and use of databases to support the interpretive genomics tools of the instant invention, and others as well. The invention of a naturally organized database, or NOD, is already disclosed by Ser. No. 08/914,375, which claims a method for constructing databases of the databases of sequences within a family of proteins. A naturally organized database groups protein sequences by families. GenBank, in contrast, is a relational database.

It is important to understand the prior art regarding database structures, recognize the novel and inventive features of the database claimed by Ser. No. 08/914,375, and recognize the novel and inventive features of the database claimed here.

Some naturally organized databases were known in the prior art long before the filing of Ser. No. 08/914,375. Indeed, Margaret Dayhoff collected proteins by families, and presented these with evolutionary trees and multiple sequence alignments in her famous Atlas of Protein Sequence [Day78]. This Atlas can be viewed as a first generation NOD.

Other implementations of this same data structure have been placed in the public domain since. They include the Hovergen [Dur94], Pfam [Bat00], DOMO, SCOP [LoC00], Prodom [Cor00], and TIGRfam databases. They are all preferable over the Dayhoff NOD because they are accessible by computer.

Prior Art Concerning Databases from the Inventor

At the time that Ser. No. 07/857,224 was filed, virtually all of the databases were relational. Within a relational database, different fields in a record hold different pieces of information about a single sequence. Such fields often (but not always) include the protein sequence, the encoding DNA sequence, the organism that provided the sequence, and an index number for reference. This remains true today. Thus, the database that is offered by the National Institutes of Health through the NCBI web page hosted by the National Library of Medicine is relational. For biomolecular sequences, it is perhaps the most widely used sequence database today in the United States.

It is clear that much useful information that can be extracted from protein sequences cannot be extracted from sequences of individual proteins. It is equally clear that more information can be extracted from sequences of many different proteins that are all members of an evolutionary family, where the family members are related by common ancestry. These are “homologous” proteins, and their historical relationship is described by an evolutionary model.

For example, Ser. No. 07/857,224 provided the first compelling tools to generate models of the three dimensional structure of proteins from sequence data. This was widely thought at the time to be impossible [Hun92]. At the core of the invention disclosed by Ser. No. 07/857,224 were methods that extract structural information about a protein fold from the patterns of conservation and divergence of amino acid sequence within a set of homologous protein sequences. This required for the protein family an evolutionary model.

An evolutionary model consist of at least two parts: (a) an evolutionary tree interrelating members of a protein family, (b) a multiple sequence alignment, which shows the evolutionary relationship between specific amino acids in the different proteins within the family. In addition, several of the interpretive processes disclosed by Ser. No. 07/857,224 relied on the reconstructed sequences of ancestral proteins represented by nodes in the tree. The last permitted the detection of correlated amino acid replacements at sites distant in the linear sequence, but near in space in the protein's folded structure, as disclosed in Ser. No. 07/857,224.

One of ordinary skill in the art may have recognized from the disclosure in Ser. No. 07/857,224 that it would be useful to have databases structured to support these tools. For example, in describing the utility of tools that enabled the prediction of models for the folded structure of proteins, Ser. No. 07/857,224 disclosed how such models could be used to decide whether two separate families of proteins were themselves distantly homologous. For this purpose, it would be useful to have all of the sequences in the genome sequence database organized by family.

Recognizing that the database structure had utility in itself, and could support functional analyses in addition to structure prediction, Ser. No. 08/914,375 (a continuation in part of Ser. No. 07/857,224) claimed a method for organizing sequence databases comprised of constructing for each independently evolving unit a multiple alignment, an evolutionary tree, and ancestral sequences at nodes in the tree, constructing a corresponding multiple alignment for the DNA sequences that encode the proteins in the protein family, assigning silent and expressed mutations in the DNA sequences to each branch of the DNA evolutionary tree a secondary structure is predicted for the family, and this predicted secondary structure is aligned with the ancestral sequence at the root of the tree.

Ser. No. 08/914,375 provided greater details, as noted below:

(a) A multiple alignment, an evolutionary tree, and ancestral sequences at nodes in the tree are constructed by methods well known in the art for a set of homologous proteins. These three elements of the description are interlocking, as is well known in the art. The presently preferred methods of constructing ancestral sequences for a given tree is the maximum parsimony methods, as implemented (for example) in the commercially available program MacClade [Mad92]. Trees are compared based on their scores using either maximum parsimony or maximum likelihood criteria, and selected based on considerations of score and correspondence to known facts. Step (a) is part of the process used to generate the predictions of secondary structure using the method disclosed in Ser. No. 07/857,224.

(b) A corresponding multiple alignment is constructed by methods well known in the art for the DNA sequences that encode the proteins in the protein family. The multiple alignment is constructed in parallel with the protein alignment. In regions of gaps or ambiguities, the amino acid sequence alignment can be adjusted to give the alignment with the most parsimonious DNA tree. The presently preferred method of constructing ancestral DNA sequences for a given tree is the maximum parsimony method. The DNA and protein trees and multiple alignments must be congruent, meaning that when amino acids are aligned in the protein alignment, the corresponding codons are aligned in the DNA alignment. Likewise, the connectivity of the two evolutionary trees must show the same evolutionary relationships. In regions where the connectivity of the amino acid tree is not uniquely defined by the amino acid sequences, the tree that gives the most parsimonious DNA tree is used to decide between two trees or reconstructions of equal value. Finally, the ancestral amino acids reconstructed at nodes in the tree must correspond to the reconstructed codons at those nodes. When the ancestral sequences are ambiguous, and where the DNA sequences cannot resolve the ambiguity, the reconstructed DNA sequences must be ambiguous in parallel. Approximate reconstructions are valuable even when exact reconstructions are not possible from available data, and the tree is preferably constrained to correspond to evolutionary relationships between proteins inferred from biological data (e.g., cladistics).

At this point, the organization of a naturally organized database is completely described. We can now add value to a naturally organized database by using the sequences of extant genes for proteins existing in organisms today to reconstruct models for events that happened in the historical past, and protein sequences that existed in the historical past.

(c) Mutations in the DNA sequences are then assigned to each branch of the DNA evolutionary tree. These may be fractional mutations to reflect ambiguities in the sequences at the nodes of the tree. When ambiguities are encountered, alternatives are weighted equally. Mutations along each branch are then assigned as being “silent”, meaning that they do not have an impact on the encoded protein sequence, and “expressed”, meaning that they do have an impact on the encoded protein sequence. Fractional assignments are made in the case of ambiguities in the reconstructed sequences at nodes in a tree.

Such a description of the family database could then support the structure predictions made using the tools disclosed in Ser. No. 07/857,224, as well processes newly disclosed in Ser. No. 08/914,375. The specific processes that applied this database included:

(d) Intermediates in the evolutionary tree may then be prepared in the laboratory using protein engineering and biotechnology methods well known in the art [Jer95].

(e) The invention disclosed in Ser. No. 07/857,224 may then be applied to each protein family. For each protein family, a secondary structure is predicted for the family, and this predicted secondary structure is aligned with the ancestral sequence at the root of the tree. If the root of the tree is unassigned, the predicted secondary structure is aligned with the ancestral sequence calculated for an arbitrary point near the center of gravity of the tree.

As disclosed in Ser. No. 08/914,375, because the quality of a multiple alignment and the precision of the reconstructed ancestral sequences decreases if proteins are included in the family with sequences diverging by over 150 PAM units, where a PAM unit is the number of point accepted mutations per 100 amino acids, while the quality of the secondary structure prediction determined by the methods disclosed in Ser. No. 07/857,224 becomes worse if the family does not contain at least some protein sequence pairs 40 PAM units or more divergent, families used in this invention preferably contain at least some protein sequence pairs more than 40 PAM units divergent, but contain no protein pairs more than 150 PAM units divergent. Most preferably, a majority of protein pairs are 40 or more PAM units divergent and no protein pair is more than 120 PAM units divergent.

These features are optimal for a protein family that is to be used to support the process disclosed in Ser. No. 07/857,224. They are not necessarily the features that are optimal to support analysis of a family of proteins to detect changing function within the family, or to detect pathways, functional interactions between members of different protein families. These features are disclosed here, as are evolutionary models for specific families that contain these features, and databases that collect models for many families, some of which contain these features.

As disclosed in Ser. No. 08/914,375, once the models for secondary structure predicted by the methods disclosed in Ser. No. 07/857,224 are placed into their evolutionary context as described above, the naturally organized database can be used in the following ways:

1. Rapidly Searchable Database

The ancestral sequences are surrogates for the sequences of the individual proteins that are members of the family. The reconstructed ancestral sequence represents in a single sequence all of the sequences of the descendent proteins. This makes it possible to define a surrogate database for the sequences in the genome sequence database. The surrogate database collects from each of the families of proteins in the databases a single ancestral sequence, at the point in the tree that most accurately approximates the root of the tree. If the root cannot be determined, the ancestral sequence chosen for the surrogate sequence database is near the center of mass of the tree. The second surrogate database is a database of the corresponding secondary structural elements. The surrogate databases are much smaller than the complete databases that contain the actual sequences or actual structures for each protein in the family, as each ancestral sequence represents many descendent proteins. Further, because there is a limited number of protein families on the planet, there is a limit to the size of the surrogate databases. Based on our work with partial sequence databases [Gon92], we expect there to be fewer than 100000 families.

Searching the surrogate databases for homologs of a probe sequence thus proceeds in two steps. In the first, the probe sequence (or structure) is matched against the database of surrogate sequences (or structures). As there will be on the order of 100000 families of proteins as defined by steps (a) through (c) after all the genomes are sequenced for all of the organisms on earth, there will be only on the order of 100000 surrogate sequences to search. Thus, this search will be far more rapid than with the complete databases. A probe protein sequence (or DNA sequence in translated form) can be exhaustively matched [Gon92] against this surrogate database (that is, every sub-sequence of the probe sequence will be matched against every sub-sequence in the ancestral proteins) more rapidly than it could be matched against the complete database.

Should the search yield a significant match, the probe sequence is identified as a member of one of the families already defined. The probe sequence is then matched with the members of this family to determine where it fits within the evolutionary tree defined by the family. The multiple alignment, evolutionary tree, predicted secondary structure and reconstructed ancestral sequences may be different once the new probe sequence is incorporated into the family. If so, the different multiple alignment, evolutionary tree, and predicted secondary structure are recorded, and the modified reconstructed ancestral sequence and structure are incorporated into their respective surrogate databases for future use.

The advantage of this data structure over those presently used is apparent. As presently organized, sequence and structure databases treat each entry as a distinct sequence. Each new sequence that is determined increases the size of the database that must be searched. The database will grow roughly linearly with the number of organismal genomes whose sequences are completed, and become increasingly more expensive to search.

The surrogate database will not grow linearly. Most of the sequence families are already represented in the existing database. Addition of more sequences will therefore, in most cases, simply refine the ancestral sequences and associated structures. In any case, the total number of sequences and structures in their respective databases will not grow past ca. 100000, the estimate for the total number of sequence families that will be identifiable after the genomes of all organisms on earth are sequenced. If a dramatically new class of organism is identified, this estimate may grow, but not exponentially (as is the growth of the present database).

Further, alignment of ancestral sequences with ancestral sequences has an advantage in detecting longer distance homology, as the ancestral sequences contain information about what amino acid residues are conserved within the nuclear family, and therefore are more likely to be conserved between diverging nuclear families. As disclosed in the present invention, it is desirable to place the ancestral Founder sequence as close to the true root as possible for this purpose, and processes are disclosed here for this purpose.

Appended to Ser. No. 08/914,375 was a broad claim that combined the database structure (points (a) through (c)) to which value had been added through the addition of ancestral sequences, and its application (points (d) and (e), see Ser. No. 08/914,375). Additional value was created by having a database of these (as opposed to a evolutionary model for a single protein sequence) through the comparison of different families, either to detect distant homologs (through structure prediction or ancestral sequence comparison), or through time correlation of events in the trees.

One of ordinary skill in the art recognized that steps (a)-(c), which create the database with utility, are separable from steps (d) and (e), which apply components of the database. Indeed, Ser. No. 08/914,375 disclosed specific utility associated with a database structured using points (a) through (c) alone. The first of these was to create a rapidly searchable database.

What is fundamentally novel in the databases of models of family history disclosed and claimed broadly in Ser. No. 08/914,375 is their incorporation of information derived from reconstructed ancestral sequences. Again, reconstruction of ancestral sequences has long been known in the art. Analysis of synonymous and non-synonymous mutations using a Kₐ/Kₛ metric associated with specific episodes in the history of a protein family, represented by a branch in an evolutionary tree, was placed in the public domain by Messier et al. [Mes97]. Presumably, because these analyses were viewed as being largely of academic interest, however, no database in existence prior to the filing of Ser. No. 08/914,375 contained information derived from ancestral sequences. Indeed, this information was not captured by Dayhoff, and is not captured within the Hovergen, Pfam, DOMO, SCOP, Prodom, or TIGRfam databases.

We can only speculate why databases did not incorporate information derived from reconstructed ancestral sequences. Perhaps, this was because these ancestral sequences, and analyses based upon them, were viewed as being largely of academic interest, and of no practical utility. The use of ancestral sequences to do covariation analysis disclosed in Ser. No. 07/857,224 provided a concrete example where utility might be derived from ancestral sequences.

The databases disclosed in Ser. No. 08/914,375 were designed to support two specific types of functional analysis. The first involved structure prediction. The second involved Kₐ/Kₛ analysis as it was commonly practiced in the art. The preferred parameters for the models incorporated within such databases, as specified above, are different from those preferred to support the processes disclosed herein for the processes of the instant application. especially those that are improvements over the .Kₐ/Kₛ analysis as it was commonly practiced in the art for detecting functional change.

### SUMMARY OF THE INVENTION

This disclosure describes processes that permit a scientist to generate experimentally testable hypotheses concerning the function of a protein starting from an evolutionary analysis. This begins with a process to determine relative and absolute dates of events in the molecular record by examining exchanges involving transitions at silent sites in two or more DNA sequences. A process is then disclosed for determining, for a specific lineage, features of the divergent evolution of the protein family. Processes are then disclosed that use these as tools to identify, at the level of hypothesis, protein pairs that are functionally linked, including functional interactions in pathways and regulatory networks. Processes are then disclosed that use these tools to correlate events recorded in the molecular sequence record with events recorded in the paleontological and geological records, permitting the association of genes with preselected physiologies in higher organisms. Processes are also disclosed for hypothesizing changes of functional behavior within a protein family. Also disclosed are computer systems comprising databases that support the performance of these processes.

### BRIEF DESCRIPTION OF THE DRAWINGS

Drawing 1. Because genes can be gained and lost in the time since taxa separated, the true relationship of proteins in a set of contemporary organisms, including a statement about whether any two genes from any two taxa are orthologs, cannot be inferred from sequence data alone. This tree shows various possible evolutionary histories to illustrate this.

Drawing 2. A curve describing the first order approach to equilibrium involving an exchange at one site between two occupants, A and G, both mathematically and graphically.

Drawing 3. Values for ƒ₂, placed at nodes in trees by calculating the ƒ₂ value pairwise for descendants beneath the node, can distinguish between orthologs and paralogs. The corresponding TREx values, derived by taking the natural logarithm of the ƒ₂, value after adjusting for the final equilibrium value, provides distances between branches.

Drawing 4. A cartoon illustration of the evolutionary origin of genes in a single genome. Some genes are introduced laterally from other organisms at different times (the arrows to the right). Some genes, whose lineages are associated with the genome lineage for as far back as can be detected, come in paralogous sets, through recent or more ancient duplication.

Drawing 5. Histogram showing the distribution of duplication events generating paralogs in S. cereviseae as a function of ƒ₂. Note in particular the duplication events that cluster near ƒ₂≈0.82.

Drawing 6. The metabolic pathway identified by contemporaneous events in the history of yeast, as found using TREx dating of duplication events in the history of the genome that generated paralogs. Genes underlined are duplicated in the historical event represented by the peak at ƒ₂=0.82 in the histogram in Drawing 5.

Drawing 7. A demonstration of the superiority of the ƒ₂ metric came from the direct comparison of the history of gene duplications in yeast using the tool that is based on nucleotide exchanges at silent sites, analyzed as described in the prior art (left) [Li85][Lyn00] and the TREx process (right). Because it does not aggregate different rate processes that have different rate constants, the ƒ₂ metric must provide a clearer definition of simultaneous events. The analysis based on the prior art missed every interesting feature in the genome duplication history. It did not identify the fermentation pathway. Nor did it generate the hypothesis that three pathways arose recently from the interaction between yeast and humans [Ben02]. In the left histogram, most recent duplications are at the left; in the right histogram, most recent duplications are at the right.

Drawing 8. The histogram collects a representative from all families of proteins where at least one representative is found in two preselected taxa, in this case mouse and human. When paralogization has occurred, some of the intertaxon pairs do not have purely orthologous relationships. To identify likely intertaxon orthologous pairs within each family, the intertaxon pair with the lowest ƒ₂ value for each family was extracted and represented on the histogram. Because neither the human nor mouse genomes are complete (even in their “draft” forms), some of the intertaxon homologs will not be true orthologs, and will have ƒ₂ values lower than expected for true orthologs, because they diverged before the mouse and human species diverged. In the absence of lateral transfer between the taxa, no ortholog will have an ƒ₂ value higher than that expected for true orthologs, after considering that ƒ₂ values are calculated from a discrete set of characters, meaning that the values will be, for reasons of sample size, distributed around that expectation value. Therefore, on the histogram, the orthologs separate themselves from the paralogs, where the former are presumed to be the pairs that are distributed in a Poisson fashion around the ƒ₂ value that is the expectation value for two genes diverging at the date when the species diverged. A Gaussian-type curve based on the number of characters used to calculate the ƒ₂ values is fitted to the cluster with the high ƒ₂ value. The top of the curve is the ƒ₂ value expected for diverging orthologs.

Drawing 9. Transitions/transversion in nucleotide replacement. Each of the 12 arrows addresses a different exchange processes, and may be associated with a different rate constant.

Drawing 10. To illustrate this application, consider four hypothetical proteins, just 4 amino acids in length, having the sequences ALKD, MVKD, ALER, and MVER. Exactly two topologies exist for unrooted trees that relate these four sequences. Both reconstructions have two ambiguous sites in both ancestors. In Topology I, the first two positions are ambiguous; in Topology II, the last two positions are ambiguous. Both trees require four “homoplastic” events (independent mutations that cause sequence convergence). Both trees require exactly six changes. Classical parsimony tools therefore rank these two topologies as equally likely. The two topologies are different, however, with respect to the extent to which charge changes are compensated. In Topology I, a charge altering replacement is 100% likely to be compensated. In Topology II, however, a charge altering replacement is only 50% likely to be compensated. If we postulate that compensatory covariation is maximized, then Topology I is preferred over Topology II. Conversely, an analogous logic can be used to assign preferred ancestral states involving charged residues. For the tree on the left, the ancestral states involving charged residues are fixed. For the tree on the right, the preferred ancestral sequences are in reconstructions IIa and IIb.

Drawing 11. Non-stationary behavior in the details of sequence evolution can help detect changing function. In particular, if more conserved sites in one subfamily are not the same as those in another, and if more mutable sites are not the same in one tree as in the other, then functionally significant change in behavior is implied along the branch that connects the two subfamilies. See [Ben89].

Drawing 12. An example of homoplasy taken from the evolution of alcohol dehydrogenase from yeast (position 30). No matter what the reconstructed ancestral sequences are, at at least three points in the tree, a P→A substitution occurred independently. The site toggles between Ala and Pro, without tolerating any of the other 18 amino acids at this site. This suggests that functional constraints at this site are conserved in the time represented by the tree, and serves as an example of the use of homoplasy to generate this hypothesis. Examination of this site using a crystal helps enhance this hypothesis by offering suggestions as to what phenotype, associated with the region in the fold where the site is placed, is conserved.

### DESCRIPTION OF THE INVENTION

Definitions

Nuclear family: A collection of protein sequence modules sharing relationship through common ancestry, wherein the multiple sequence alignment (MSA) describing that relationship is largely robust with respect to alternative tools for placing gaps within it. Nuclear families have greatest utility to support processes to extract inferences and hypotheses from patterns of variation and conservation at individual sites.

Standard family: Collection of proteins where the scores of all intrafamily sequence pairwise comparisons is greater than a cut-off chosen to be a significant indicator of homology, but where the multiple sequence alignment is significantly different when different tools are used to place gaps within it. Standard families have greatest utility to support processes to extract inferences and hypotheses from patterns of variation and conservation at individual sites not near gaps.

Extended family: Collection of proteins where all inter-family sequence pairs are connected by a path of pairwise comparisons that score sufficiently to be significantly homologous, but where standard tools to place gaps within the multiple sequence alignment do not agree on gap placement. Extended families have greatest utility to support processes to extract inferences and hypotheses from patterns of variation and conservation at individual sites not near gaps, especially processes that are seeking sites conserved over long distances (for example, processes seeking to identify active site residues, to characterize motifs that are highly conserved, or to find distant homologs that might have cultural annotation for a target sequence that is lacking from its closer homologs.

Superfamily: Collection of homologous proteins where homology between distantly related members of the superfamily need not be detectable with significance using sequence similarity alone, but non-sequence based attributes (e.g., nature of the fold) are needed to establish homology. Superfamilies have particular utility when seeking homologs that might have cultural annotation for a target sequence that is lacking from its closer homologs, or when trying to understand globally the processes by which proteins have been created and evolved.

Independent innovations: Collection of proteins where all members are descendants of a common ancestor, which represents an innovation independent of the innovation of all others, where innovation implies the generation de novo of a new protein sequence. This is at present largely a theoretical.definition, something not easily subject to operational test. Those interested in origins eventually wish to know how many times polypeptide chains have been invented.

Cultural annotation: The linguistic construct used to describe the function of a protein, which may include (for example) statements about the topology of the fold, the types of molecules bound, the types of reactions catalyzed, the nature of proteins that it interacts with, the pathways within which it participates, the conditions under which it is expressed, the cellular processes that it contributes to, and/or the macroscopic phenotype that it is associated with.

Temporal Correlation as a Process in Interpretive Genomics

One strategy underlying the instant invention is temporal correlation. Temporal correlation refers to the process of identifying events that occurred at the same time, or as near in time as the analytical method used to measure time can detect. Temporal correlation is useful because two (or more events) that occur nearly simultaneously are more likely to be functionally related than two events that do not.

To apply this strategy, a process must seek events in the history of the biosphere that are contemporaneous. When a correlation is observed, it suggests (as a hypothesis) that a functionally significant relationship exists between the time-correlated events.

This strategy for generating hypotheses is not a strategy for proving them. Post hoc ergo propter hoc is well known not to be a logic that supports proof. But processes that do not involve proof may nevertheless have utility. In part, this is because “proof” is not possible for any theoretical statement concerning the natural world, something well known in the art. Rather, biological science is driven by useful hypotheses, where the utility of a hypothesis is determined largely by its testability, and the degree to which the hypothesis can provides focus. Even incorrect hypotheses have been useful, if they lead to a focused test. Given that contemporary science is faced with an enormous volume of sequence data, almost any process that generates focused, testable hypotheses has utility.

Temporal correlation has long had utility in science. Temporal correlation is a key strategy in interpretive paleontology, for example. Paleontologists often generate and analyze hypotheses that imply causal relationships between historical events based on their near simultaneity of events recorded in the paleontological record. The uncertainty in measuring dates can be as much as several million years, without a loss of utility. For example, temporal correlation is used to ask whether the arise of angiosperms (flowering plants) helped caused the decline of the dinosaurs.

Such discussions are generally placed within the context of the geological and paleontological records, without making any reference to the molecular record captured in gene sequences. Central to the instant invention is the analysis of the molecular record as well as geological, physiological, wet biochemical, and paleontological data. Here, temporal correlation can be involved in several ways. For example, relative dates of events (such as gene duplications) reconstructed from a genome sequence database (from the sequences of two paralogous proteins) can be time-correlated with dates of other events reconstructed from a genome sequence database. Such a process can be used to generate hypotheses about whether the two families interact as they function. Alternatively, for example, the absolute date of an event in the molecular record can be compared with dates known or inferred from the geological and paleontological record, and temporal correlation between the molecular, geological, and paleontological records can be used to draw useful hypotheses and inferences. Other approaches are disclosed below.

Absolute dates are not needed for temporal correlation, of course. A process that places only relative dates on events can support useful temporal correlations as well. In classical paleontology, for example, relative dating is done using stratigraphy. Fossils found in the same strata are hypothesized to be derived from organisms living at the same time. Those found in higher strata lived later, while those found in lower strata lived earlier. Temporal correlation in paleontology was therefore possible long before radiochemical dating pernitted absolute dates to be placed on igneous rocks.

As a tool for interpreting genomic sequence data, temporal correlation has not been widely used in the prior art. This is in part because protein and nucleotide sequence data have been shown to be poor molecular clocks [Aya99]. After much discussion, it is commonly viewed in the art that one cannot estimate the date at which two sequences diverged simply by estimating the number of amino acid replacements or nucleotide substitutions that separate them.

When temporal issues are raised in the art, it is generally as part of a discussion (often dispute) about the exact temporal ordering of species divergence. Examples of these types of disputes include the relative timing of divergence of chimpanzees, gorillas, and humans, or the specific branching of the tree that generated mammal orders, or the dates when plants emerged on to land. These are distinct from the invention disclosed here, which does not have the dating of speciation as a goal, but rather can use estimates of speciation dates as input.

Placing Dates on Events that Gave Rise to the Molecular Record

Using Fossil Records to Date Nodes in a Tree, when the Tree Contains Only Orthologs

The most direct way to assign dates to events in a tree is also the one well known in the art. It assumes that all of the leaves on the tree correspond to orthologous genes in the taxa that provided the sequences. If this is the case, then the nodes in each tree represent speciation events that led to the taxa at the leaves of the tree. This permits us to correlate features of the molecular record with features of the paleontological record.

In the leptin tree shown in Ser. No. 08/914,375, now issued as U.S. Pat. No. 6,377,893, for example, the mouse gene for leptin and the human gene for leptin are presumed to be orthologs. If this presumption is true, then the genes for mouse and human leptin diverged at the same time as mouse and humans as species diverged.

But when was that? In the absence of a fossil record and geological dates, we would not know. Fortunately, a growing fossil record, coupled to radiochemical dating, provides considerable information about when taxa diverged within many lineages, especially metazoans (multicellular animals) and multicellular plants. Some of this is summarized in Table 1.

TABLE 1
An approximate time scale for the paleontological record, and an overview of
major features in the historical record near this time*

| Million Years | |
|---|---|
| Before Present | Name of the era; Prominent features |
| | Pleistocene (Cenozoic) |
| 1.6 | |
| | Pliocene (Cenozoic) |
| 5 | |
| | Miocene (Cenozoic) |
| 24.5 | |
| | Oligocene; (Cenozoic) at the beginning, have the massive cooling of the Earth; |
| | grasslands emerge; this is the radiation of the artiodactyl families |
| | deer/antelope/camels |
| 38 | |
| | Eocene (Cenozoic) this is the garden of Eden, warm weather. |
| 54 | |
| | Paleocene; (Cenozoic) warm weather, mammals take over from dinosaurs; the |
| | secondary orders of placentals diverge here (whales, artiodactyls) |
| 65 | this date corresponds to a mass extinction |
| | Cretaceous (Mesozoic)the principal orders of plancentals diverge here (primate, |
| | rodent, elephant, carnivora, ungulates); angiosperms become dominant |
| 146 | |
| | Jurassic, (Mesozoic)first angiosperms, according to Dilcher |
| 208 | |
| | Triassic (Mesozoic) |
| 250 | by this point, mammals, birds (dinosaurs) and reptiles are diverged); this date |
| | corresponds to a mass extinction |
| | Permian (Paleozoic) |
| 280 | |
| | Pennsylvanian (Paleozoic) coal beds |
| 320 | |
| | Mississippian (Paleozoic) coal beds, plants heavy on land without very |
| | successful land animals to eat them; animals are starting to go on to the land |
| | Hedges speaks of stem amphibians 338 Ma |
| 345 | |
| | Devonian (Paleozoic) 370/360 lobe finned fish become tetrapods ready to go on |
| | to land |
| 395 | |
| | Silurian (Paleozoic) bony fishes |
| 438 | |
| | Ordovician (Paleozoic) fishes |
| 510 | |
| | Cambrian (Paleozoic) tunicate versus other chordates probably diverge by end |
| 543 | (Paleozoic starts, the start of the Phanerozoic) This is recognized as the last |
| | date for the divergence of the major metazoan phyla, such as worm, fly, chordate |
| | Precambrian |
| 1000 | Major lineages probably established, probable eukaryotic fossils |
| 2200 | Oxygenic photosynthesis clearly established; certain microbial fossils |
| 3800 | First fossils (?) |
| 4500 | Earth forms |
| *The rodent-primate divergence, for example, was clearly not later than 70 Ma, probably not earlier than 150 Ma. The marsupial-placental divergence was certainly not later than 150 Ma; Hedges, using a protein-based molecular clock, suggests 173 Ma, while fossil evidence says 178-143, but is poorly attested. The mammal-archosaur divergence was certainly not after 310, and probably not before Ma. Hedges says that it occurred a bit more than 310. | |
| # The land-fish divergence was certainly not after 338 (Hedges' date for amphibians), and probably not before 370 Hedges suggests 360 Ma. The bony fish-cartilaginous fish (shark) divergence was probably around 400 Ma. | |

Correlating Two Trees, Assuming that All Proteins on the Tree are Orthologs

The most direct way to temporally correlate two trees is to ensure that the two trees carry only orthologs, and that the organisms providing the orthologs are the same on the two trees. In a tree presenting orthologs only, the internal nodes in the tree reflect points where speciation took place. If the two trees have the same species at their leaves, then the speciation events represented by the nodes on one tree are the same as the speciation events represented by the nodes on the other tree, both with respect to the species being formed, but (more to the point) in time. Thus, branches between the nodes in one tree span the same interval of geological time as branches between the analogous nodes in a second tree.

Time correlation using this process was used to correlate in time episodes having adaptive evolution in the tree for the leptin protein family and the tree for the leptin receptor family, as disclosed in Ser. No. 08/914,375. In Ser. No. 08/914,375, the observation that an episode having a high Kₐ/Kₛ ratio in the leptin tree, because it occurs at the same time (given the resolution that the articulation permits) as an episode having a high Kₐ/Kₛ ratio in the leptin receptor tree, gives rise to the hypothesis that the leptin receptor at the beginning and end of the episode has a functionally significant interaction with the leptin at the beginning and end of the episode.

The Ortholog-Paralog Problem: Impact on Simple Temporal Analyses Based on Taxa Distribution

While dating events in trees with that contain only orthologs and a congruent set of species is simple, making temporal correlation between two trees, both that contain only orthologs direct, being certain that a collection of sequences contains only orthologs is not. The difficulty arises because the ortholog-paralog relationship between proteins need not be transparently clear from the data that one has available. It is, we believe, fair to say that the literature contains no method that can, in silico, generate assurances that a tree contains only orthologs.

Drawing 1 illustrates the problem. In the event of loss, the true ortholog-paralog relationship between proteins in modern species can be mistaken. This fact, and the fact that loss of genes is frequent, especially in some lineages, makes the problem of temporal correlation difficult. It is therefore rarely used, and almost never used in a purely computational setting. This creates a need for the processes of the instant invention that enable temporal correlation.

Relative Dates Obtained if Different Events are Molecularly Coupled

One feature of any invention that exploits temporal correlation is the process used to date events. In some situations, time-correlation of two events in the history of a biomolecular system is direct. Ser. No. 07/857,224 illustrated one type of situation, when it disclosed a method for using time-correlated amino acid replacement at different positions within a single protein sequence as a tool to predict which amino acid residues are in contact in the functionally active folded structure. The approach disclosed in Ser. No. 07/857,224 began with an alignment of multiple sequences of proteins related by common ancestry, and a tree interrelating those sequences. Then, the amino acids found in ancestral sequences represented by nodes in the tree were reconstructed using a parsimony tool. From these reconstructions, amino acid replacements were modeled for individual branches of the tree. When compensatory replacements at two sites (site A and site B) occurred in the same branch of the tree, then the replacements were taken to be time-correlated, and the hypotheses was generated that the two amino acids at those two sites are in contact in the folded, functioning form of a protein.

This hypothesis is a simple example of functional analysis arising from the time-correlation of two events. Our ability to time-correlate replacement at two sites is based on the fact that a single tree is used to describe two histories, the history of replacement at site A, and the history of replacement at site B.

In principle, two evolutionary trees for the two sites could have been independently constructed from characters at those sites; we would then need to time-correlate events represented on two trees. By assuming that multiple sites within the same polypeptide sequence have evolved together, however, we can model replacements at the two sites with the same tree, where that tree is constructed from characters from the protein sequences as a whole. Events that occur along a specific branch in the tree at site A are therefore contemporaneous (to the extent that the tree is articulated) with events that occur along the same branch at site B.

It is important to recognize the meaning in the phrase “to the extent that the tree is articulated”. Branches on a tree represent episodes of evolution whose beginnings and ends are defined by the nodes at their endpoints. These nodes represent specific ancestral sequences that suffered duplication, either within a species (the immediate descendent sequences are paralogs) or associated with speciation (the immediate descendent sequences are orthologs). Thus, the time represented by a branch is the time difference between the first and second duplication represented by the nodes at the beginning and end of the branch.

The time distance represented by the branch is the resolution to which two or more events occurring along the branch can be said to be time-correlated. With a highly branched (or articulated) tree, the times between duplications represented by the nodes can be arbitrarily short. But in a poorly articulated tree, the times can be tens of millions of years (or more). Thus, the extent to which a tree is articulated determines the resolution in time afforded by the model.

In the past, most trees constructed solely from sequences in a database have been inadequately articulated to provide useful time correlation. The protein kinase family, discussed in Ser. No. 07/857,224, was an exception in 1990, a family of protein with many members in the then-existing database. The corresponding tree was well articulated, and there was no need to obtain additional sequences by further sequencing to do time correlation using the method disclosed in Ser. No. 07/857,224, which concerned specifically correlated amino acid replacement at site in contact in the folded protein.

Since Ser. No. 07/857,224 was filed, additional processes have become evident that exploit time correlation and have utility. As disclosed below, these trees have certain features that make them optimally useful Most of these features concern branch lengths, which are generally short, and the degree of articulation, which reflects the number of nodes per unit time on the tree. The preferred tree need not exclude longer branches, or subtrees that are poorly articulates. Additional sequences that are joined to the tree via longer branches add value to the tree, especially if they help to root the tree, incorporate within a family homologous proteins whose crystal structures have been solved, or describe other global features of the protein family, such as positions within the multiple sequence alignment that accept insertions and/or deletions (indels). This means that the presently preferred tree need not be composed exclusively of branches meeting the preferred parameters. But the instantly disclosed processes based on temporal correlation will not be applicable to trees where no branches meet these parameters. In particular, these processes will not be applicable if all of its branches represent more than 100 million years, or where the distances along all of the branches are more than 100 PAM units.

As sequence databases grow, standard sequence databases will support trees having this level of articulation for most families of proteins. Today in 2002, the articulation of the trees for many protein families, built solely from sequences in a standard database, is sufficient to support a wide variety of interpretive processes that exploit temporal correlation. Should the standard sequence database not contain sufficient sequences, it remains preferred to sequence more proteins, selected strategically from organisms to articulate the tree more efficiently, to improve the time resolution, and confirm branch placement.

The process comprising identifying two sites in the amino acid sequence that suffered replacement at the same time generates, as an output, a hypothesis that the amino acids resident at these sites are in contact in a functionally significant state of the protein. This is the process disclosed in Ser. No. 07/857,224. It is important to recognize the meaning in the phrase “functionally significant state”. We hypothesize that this is the functioning form of the protein because, if the contact was made in a form of the protein that was not functioning (i.e., not contributing to fitness), then there would be no Darwinian mechanism to drive simultaneous substitution.

Relative Time Correlation in Different Polypeptide Chains that Interact when They Function

Time correlation is also useful to support processes to detect functionally significant interaction between two amino acids if the two amino acids are on different polypeptide chains, and the functional interaction in question involves the contact between two different protein molecules. An example of this was disclosed in Ser. No. 07/857,224, where the appearance and disappearance of a pair of cysteines generates the testable hypothesis that those two cysteines form a disulfide bond at the time that the system is functional. This applies for intermolecular interactions as well, with the ribonuclease A/bovine seminal ribonuclease being a well known example. Here, cysteines appear at positions 31 and 32 in the same episode of evolution. These are hypothesized (and indeed do) form intermolecular disulfide bonds.

An intermediate case is also easily envisioned. Here, the two contacting sites might be within the same polypeptide chain, but on different modules. Modules are defined as segments of polypeptide that can have independent evolutionary history [Ril97], even though at times in that history the segments are joined, and share a common history. Modules may also be referred to as “sequence units related by common ancestry.” An example of this is the src homology 1 (kinase) domain, the src homology 2 (phosphotyrosine-binding module, and the src homology 3 (proline-rich polypeptide binding (?)) modules found in many proteins involved in signal transduction in higher organisms. Time correlation in the shuffling of these modules, or intermodule temporal correlation of amino acid replacement, can be used to generate functional hypotheses about these.

The challenge once the intramolecular connection is broken is to ensure that the two trees representing two polypeptide chains are congruent. Ensuring orthology is one of these. Several other methods for doing this are outlined below.

Geological Dates Sought by Using Molecular Clocks

Geological dates are “absolute”, in that they are measured in years. On physical samples (such as rocks), these are today nearly universally determined by examining the amounts of radioisotopes and their decay products within the rocks. Radioactive isotopes are useful for dating events in the geological record because of the first order nature of nuclear decay, and the remarkable extent to which the associated rate constants are independent of environmental factors. Its first order nature means that the decay can be modeled using a simple exponential rate law, with the fraction of initial atoms remaining f after time t defined by the expression f=1−exp(−kt). Here, k is the rate constant for the decay, which gives the half life τ=ln 2/k. The independence of k of environmental factors means that one need know nothing about the history surrounding the sample to calculate a date from this process. Simply by measuring the amounts of decay products from two isotopes of uranium in a zircon crystal, for example, precision to better than a million years is nearly routine when dating an igneous rock 500 million years old [Bow93].

Dates assigned to fossils in the paleontological record can be obtained by the association of specific fossils with specific radiochemically dated rocks. Unfortunately, fossils are found in sedimentary rocks. Crystallization of a rock from molten rock is needed to set the radiochemical clock, making it radiochemical dating possible only for igneous rocks. In some cases, volcanic strata or igneous rocks are closely associated with sedimentary rocks, enabling the transfer of a date from one to another. More frequently, dates of igneous rocks constrain the dates of fossils, without establishing their age precisely. Correlating igneous rocks with sedimentary rocks, and correlating sedimentary strata with the fossils that they contain, is an ongoing exercise in geobiology.

No known chemical process has rate properties that are comparable to those displayed by radioactive decay. Many chemical processes display first order (or pseudo-first order) kinetics, of course. But the rate constants for nearly all of these are influenced dramatically by environmental factors, including temperature, salt concentration, and pH (for example). How unsuitable chemical processes are as a metric for age is well illustrated by examples where dating tools based on chemical reactions were sought. Amino acid racemization is perhaps the most widely used of these. But the rates of amino acid racemization vary dramatically depending on conditions, making this a “second choice” dating tool, at best.

Given this, it may appear hopeless to try to identify a chemical process in living systems that has sufficient first order character to be useful to date biological events, especially one reflected in DNA or protein sequences (Fitch, 1976). We do not know the microscopic chemical processes that are responsible for natural mutations in natural populations. Indeed, it is conceivable that many microscopic chemical processes contribute, including deamination, oxidative damage, polymerase error, and failure of repair. Further, natural selection can play a major role in determining what mutations are fixed in a population. When DNA mutations result in the replacement of an amino acid in an encoded protein (a non-synonymous mutation), the behavior of the protein can change. Protein behavior can be intimately connected to function and natural selection. Therefore, encoding DNA sequences are not expected to diverge with a time-invariant rate constant whenever the demands of selective pressure are changing, even if the microscopic chemical processes that create a pool of mutations occurs with a time-invariant rate constant (Ayala, 1999).

Nevertheless, one can hope that some parts of a DNA sequence will diverge in a process that might display first order kinetics approximately. Synonymous sites in a gene, sites where nucleotide substitution does not change the encoded amino acid, are frequently examined for this purpose [Li85]. Because these cannot alter the behavior of a protein, synonymous substitutions are likely to be freer of selective pressure than substitutions at non-silent sites. Thus, these are candidates for mutations that diverge with (pseudo) first order kinetics.

Prior art from outside the laboratory of the inventor that examines synonymous substitutions does not use an approach-to-equilibrium kinetic processes to model these. Rather, prior art attempts to enumerate substitutions at synonymous sites by comparing two extant sequences, counting the silent differences, and using a correction to estimate the number of times multiple substitutions have occurred at the synonymous site [Lyn00]. From this is extracted a number for the synonymous substitutions per site. Further, prior art metrics attempt to count all synonymous mutations that occur at each site, including those within two fold redundant codon systems, within four fold redundant coding systems, and within codons that have also suffered non-synonymous mutations well. Most treat transitions (which replace pyrimidines by pyrimidines, or purines by purines) and transversions (where pyrimidines and purines are interconverted) together, even though these are known to occur at different rates [Goj82].

Pre-Application Disclosure of a Molecular Clock Tool Based on Silent Substitutions

The notion of an approach to equilibrium was introduced in late 2001 in a Ph.D. dissertation of Stefan Audetat, a graduate student working at the direction of the Inventor. This dissertation mentioned work by the Inventor re-examining the problem of using silent substitutions to date divergence events from the biomolecular record. It recorded an approach where silent sites were extracted codons from a pairwise alignment where two-fold redundant amino acids (in the one letter code, CDEFHKNQY) are conserved. Substitution at the silent position was then modeled with an exponential “approach to equilibrium” rate law, where ƒ₂ is the fraction of the codons that are themselves conserved: ƒ₂=[0.5·exp(−kt)]+0.5, where k is a single pseudo first order rate constant for transitions, and t is the time [Juk69]. A neutral evolutionary distance (NED) between two genes x and y was defined by NED_{x,y}=kt_{x,y}=−ln{(ƒ_{2x,y}+0.5)/0.5}.

In a “proof of concept” study, NEDs were then examined as a tool to date the divergence of mammalian species. The NED is a measure of evolutionary distance, not time. If one knows the rate constant, and assumes that k is constant over the relevant period of evolutionary history, one can calculate the time t of divergence. Alternatively, given the same assumption and the date of evolutionary divergence of two sequences, one can calculate k. As Table 2 shows, NEDs were found to provide reasonable distances with consistent rates.

TABLE 2
Average NED values for pairs of proteins extracted
from humans, pigs, oxen, rabbit, rat, and mouse

| | | | kt | Date | k (calc) × | k (average) × |
|---|---|---|---|---|---|---|
| Species | Species | Number | (range) | (fossil) | 10⁹ | 10⁹ |
| 1 | 2 | of pairs | NED | Ma | changes/base/year | |
| Human | Pig | 225 | 0.3990 | 80 | 2.5 | |
| Human | Ox | 410 | 0.3800 | 80 | 2.4 | 2.4 |
| Pig | Ox | 140 | 0.2755 | 60 | 2.3 | |
| Rabbit | Human | 203 | 0.4845 | 80 | 3.0 | |
| Rat | Human | 584 | 0.4893 | 80 | 3.0 | 3.1 |
| Mouse | Ox | 147 | 0.5130 | 80 | 3.2 | |
| Mouse | Human | 918 | 0.4988 | 80 | 3.1 | |
| Mouse | Rabbit | 87 | 0.5083 | 60 | 4.2 | 5.2 |
| Mouse | Rat | 926 | 0.2470 | 20 | 6.2 | |

A Correctly Formulated Molecular Clock Tool Based on Silent Substitutions

We now know that the NED formulation as presented in the Audetat dissertation is incorrect. The error comes in its treatment of the endpoint of the exponential decay. Specifically, the dissertation requires the end point to be 0.5. This turns out to be incorrect whenever the natural system has selected one nucleotide over another in any particular coding system. This is known in the art as “codon bias”, and codon biases are generally not 0.5. Thus, the formulation presented in the Audetat dissertation is incorrect theoretically in any case, and incorrect from a practical perspective whenever when the codon bias is not 50:50.

The Inventor subsequently attempted to account for bias by making the end point not 0.50, but rather by making the end point reflect the codon bias. For example, when the codon bias is 60:40, the end point was taken to be 0.60. When the codon bias is 65:35, the end point was taken to be 0.65. This also turns out to be incorrect. Indeed, it was puzzling for some time why an intraspecies comparison of the ƒ₂ values of paralogs was considerably below 0.65 even when the codon bias was known to be 0.65.

We now disclose a correct formulation, which is one subject of the instant application. Consider a two state system interconverting species A and G, using the kinetic scheme:

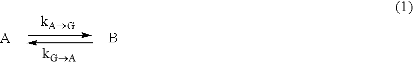

approaches equilibrium via an exponential process, where the observed rate constant k_{obs} is equal to the forward rate constant for the conversion of A to G, plus the reverse rate constant for the conversion of G to A, that is, k_{obs}=k_{A→G}+k_{G→A}. Further, at equilibrium, the ratio of G to A is equal to the ratio of the forward and reverse rate constants, that is, G_{eq}/A_{eq}=(k_{A→G)/(k}_{G→A}), where G_{eq} and A_{eq} are the respective concentrations of G and A at equilibrium. In the general case, the concentration of A as a function of time is:

$$\frac{A ( t )}{{A}_{0}} = {f}_{Geq} exp - ( {k}_{A -> G} + {k}_{G -> A} ) t + {f}_{Aeq} \qquad ( 2 )$$

where f_{Geq} and f_{Aeq} are the fractions of G and A at equilibrium (that is G_{eq}/(G_{eq}+A_{eq}) and A_{eq}/(G_{eq}+A_{eq})). These two fractions, expressed in terms of the microscopic rate constants, are k_{A→G}/(k_{A→G}+k_{G→A}) and k_{G→A}/(k_{A→G}+k_{G→A}). The analogous expression can be written for the concentration of G as a function of time:

$$\frac{G ( t )}{{G}_{0}} = {f}_{Aeq} exp - ( {k}_{A -> G} + {k}_{G -> A} ) t + {f}_{Geq} \qquad ( 3 )$$

The two fractions of G and A at time t always sum to unity.

Consider now the case where A and G are nucleotides at a site constrained to accept only purines, A or G. The rate constants k_{A→G} and k_{G→A} now correspond to pseudo first order rate constants for two transition processes, the mutation of A to give G, and the mutation of G to give A. Again, the k_{obsR} (R for purines) is equal to k_{A→G}+k_{G→A}. The fraction of sites occupied by A and G reflect the A/G bias at such sites at equilibrium (which we assume holds throughout).

Let us now consider two identical sequences that are given the opportunity to diverge. We assume that the initial proportion of A and G at these sites is equal to the bias, that is, that the fractions of A and G represent the fractions expected at equilibrium. We also assume that each site suffers mutation independent of other sites, and that the forward and reverse transition rate constants are the same for all sites. How will the identity at purine-constrained sites diverge?

Let us consider separately the sites that are occupied by A at t=0 and the sites that are occupied by G at t=0. For those that are occupied by A, the sites that are considered to be “conserved” at time t are those that retain A at time t. As a fraction of the total sites originally A, equation (2) can be deconvoluted as follows:

conserved sites arising from A [f_{Geq} exp(−k_{obsR}t)+f_{Aeq}]f_{Aeq} (4a)

conserved sites arising from G [f_{Aeq} exp(−k_{obsR}t)+f_{Geq}]f_{Geq} (4b)

The fraction of all sites conserved as a function of time is the sum of these two:

f_{2R}=f_{Aeq}f_{Geq} exp(−k_{obsR}t)+f_{Aeq}f_{Aeq}+f_{Geq}f_{Aeq}exp(−k_{obsR}t)+f_{Geq}f_{Geq}=2f_{Aeq}f_{Geq} exp(−k_{obsR}t)+f_{Aeq}²+f_{Geq}²=P_{R} exp(−k_{obSR}t)+E_{R} (5)

where P_{R} is the pre-exponential term (=2{f_{Aeq}²+f_{Geq}²}) and E_{R} is the f_{2R} reached at equilibrium, and is equal to f_{Aeq}²+f_{Geq}².

This is calculated for purine-purine exchange (where the subscript R in f_{2R} refers to the puRines, A and G). An analogous function applies for pyrimidine-pyrimidine exchanges, to give an f_{2Y} (where the subscript Y in f_{2Y} refers to the pYrimidines, G and C). For many applications, especially when the number of relevant sites is few and the rate constants for the two exchange processes are comparable, it is preferably to aggregate the two to give a simple f₂.

Thus, ƒ₂ as a function of time follows a first order exponential decay from unity to an end point defined by the expression (f_{Aeq}²+f_{Geq}²). These two terms, in turn, are defined by {k_{G→A}/(k_{A→G}+k_{G→A})}² and {k_{A→G}/(k_{A→G}+k_{G→A})}². If A and G appear with equal frequency, then the end point f₂=0.5. If, however, A and G appear with a relative frequency of 0.6 and 0.4, then the end point is 0.52. This is illustrated in Drawing 2.

For many applications, a distance is preferred over a fraction, because it is additive, behaves according to the triangle inequality, and can be used to construct trees. Here, a kt distance can be extracted from Equation (5) via a simple transformation:

kt distance=TREx distance=k_{obs}t=1n {(f₂−E)/P}

This formalism therefore captures codon bias, as long as codon bias is time-invariant. Thus, it resolves one of the problems cited above with the Kₐ/Kₛ metric. It is possible to simply replace the Kₐ/Kₛ metric by the number of replacements that are non-synonymous by the kt length of the branch, given the known end point that reflects the two rate constants that create the codon bias.

If the rate constants are assumed to be time-invariant, we can also treat ƒ₂ as a molecular clock. It is a very special one, in that it involves only two specific rate constants from the 12 that are possible with the four letters in the genetic alphabet. Further, it considers only those sites where the amino acid has been conserved, constraining the silent site to accept only a transition. As the rate constants for transitions and transversions are known to be different, this particular clock should (from first principles) generate better dates than one that aggregates the 12 different processes.

To obtain an ƒ_{2R} value that represents a separation of two sequences based on an A/G approach to equilibrium, we must align two protein sequences and their corresponding encoded DNA sequences. We then identify sites in the DNA sequence alignment that have been constrained to mutate between A and G only. Codons for three amino acids (Glu, Gln, and Lys, or E, Q, and K in the one letter code) are so constrained if the amino acids are not replaced. To implement the process, we examine the pair of aligned protein sequences for the amino acids where Glu, Gln, and Lys are conserved between the two protein sequences. The number of A's matched with A's at the third (silent) position in these codons is added to the number of G's matched with G's at the third (silent) position to give the number of conserved nucleotides at the informative sites. Then the number of A's matched with A's at the third (silent) position in these codons is added to the number of G's matched with G's at the third (silent) position, the number of A's matched with G's at the third (silent) position in these codons, and the number of G's matched with A's at the third (silent) position to give the total number of informative sites. The number of conserved sites divided by the number of total sites is the ƒ_{2R} value, a number that lies between zero and unity.

An analogous kinetic expression can be written for pyrimidine-pyrimidine transitions to generate an ƒ_{2Y} value (where the subscript Y refers to the pYrimidines, C and T). The third positions of six amino acids (Cys, Asp, Phe, His, Asn, and Tyr, or C, D, F, H, N, and Y in the one letter code) are constrained to have only T or C, if they are not replaced in the protein coding sequence. Again, inspection of a pair of aligned protein sequences for positions where these amino acids are conserved identifies synonymous sites as candidates that fit a pyrimidine-constrained kinetic behavior. To implement the process, we return to the pair of aligned protein sequences for the amino acids where Cys, Asp, Phe, His, Asn, and Tyr are conserved between the two protein sequences. The number of T's matched with T's at the third (silent) position in these codons is added to the number of C's matched with C's at the third (silent) position to give the number of conserved nucleotides at the informative sites. Then, the number of T's matched with T's at the third (silent) position in these codons is added to the number of C's matched with C's at the third (silent) position, the number of C's matched with T's at the third (silent) position in these codons, and the number of T's matched with C's at the third (silent) position to give the total number of informative sites. The number of conserved sites divided by the number of total sites is the ƒ_{2Y} value, also a number that lies between zero and unity.

It is useful for any system to plot the ƒ_{2Y} values for a series of systems against the corresponding ƒ_{2R} values in a set of aligned homologous proteins from the same system (say, paralogs from a single genome). If this plot lies along a straight line starting at (1,1) and ending near (0.5,0.5), then the rate constant for the pyrimidine-pyrimidine transitions and the rate constant for the purine-purine transitions are approximately equal. The numbers collected for the silent sites involving purines and pyrimidines can then be aggregated, and the resulting ƒ₂ value can be used to analyse dates. For the remainder of this discussion we will use ƒ₂ values, recognizing that in many circumstances, separate examination of ƒ_{2Y} values and ƒ_{2R} values may give better results than examination of their aggregate, ƒ₂. This is likely to be so particularly in systems where the rate constant for the pyrimidine-pyrimidine transitions and the rate constant for the purine-purine transitions are very different. This will be indicated by a curved plot of the ƒ_{2Y} values for a series of systems against the corresponding ƒ_{2R} values.

For the purposes of this disclosure, we shall refer to ƒ_{2Y}, ƒ_{2R} and ƒ₂ clocks as “transition redundant exchange” clocks, or TREx clocks. The expression kt is a distance, in that it is additive, and is referred to as a TREx distance. The TREx distance does not require that silent transitions be absolutely neutral. If the A-G transition (for example) is not neutral, this fact will be reflected in the equilibrium fractions of the two nucleotides at silent sites. A preference for A or G at the silent sites will be a codon bias), and may reflect pressure that causes a time-invariant bias at the silent sites. Alternatively, it may reflect a different in the A-to-G and the G-to-A rate constants. Using the TREx clock does assume, however, that the bias be the same at each synonymous site. It also assumes that this selection pressure is time-invariant, that is, that it not change in the time separating the sequences whose divergence is being dated.

As noted below, a comprehensive analysis of a genome permits one to assess the extent to which codon bias and transition rate constants have changed in the historical past of a lineage. Absence of time-invariant bias means something too, for example, that the evolutionary processes that lead to natural mutation are changing or that the properties of tRNA molecules in the system are changing over the time interval in question. One of the key purposes of whole genome analyses (see below) is to model these processes and properties over time.

The ƒ₂ value can be used to “rank date” events, without the need to know either k or t. If, however, two orthologous genes are found in two taxa, and the date of divergence of the taxa is known from the paleontological and geological records, then the time t separating the two taxa is (approximately) known (more often a more recent limit is set), and the rate constant for the transitions in question can be calculated. The precision of the calculated value for k will, of course, be better if more orthologs are compared. If orthologs from many taxa are known, and if the divergence dates of these various taxa are known (or can be estimated) from the geological and paleontological data, then the rate constants k can be estimated for individual branches of the taxonomical tree. These can be estimated even if they are not time invariant. Variance in the rate constant, expressed in units that are reciprocal in time, may be due to different generation times of ancestral organisms.

The precisions of the rate constants depend on the number of characters used to derive them. All dates contain uncertainty. Uncertainties in geological dates based on exponential radiochemical decay are small, often less than 0.1% for dual isotope chronology on well preserved igneous rocks. Paleontological dates of divergence (from fossils) have larger uncertainties, primarily because of the incomplete fossil record. Fossils near branch points in a phylogenetic tree are rarely found, and those that are need not be associated with isotopically datable igneous formations.

The genomes of the yeast and vertebrates suggests that the main sources of variance in dating using prior art silent substitution metrics [Li85][Pam93][Lyn00] are the approximations made by the underlying model. These create imprecision much greater than the uncertainties due to fluctuations, and the uncertainty in paleontological dates. The approximations embedded into the TREx tool, however, are not as severe (although some still exist, of course). The variance in TREx dates, in contrast, arises primarily from fluctuation (a typical TREx value is calculated from 100 characters); fluctuation accounts for>90% of the variance observed in a data set from mammals. We need not invoke differential rates of silent substitutions in different genes (“hot spots”), different codon biases in different genes, or other non-first order processes to account for the variance. Further, the error in a TREx date is less than the typical errors in dating branch points from the fossil record. For the purpose of planetary biology and genome annotation, this is often as good a precision as is useful. As disclosed below, however, the precision can be improved using various tools.

Single Family Analysis

Applying the TREx Molecular Clock to the Ortholog-Paralog Problem

One application of TREx dating is to resolve the “ortholog-paralog problem” (Drawing 3). Briefly phrased, when examining two homologous genes in two species, we need to know whether the two genes diverge at the same time as the species diverged (in which case, the two genes are orthologs; classical models assume that these have analogous functions in the two organisms), or whether they diverged before the species diverged (in which case, the two genes are paralogs; classical models assume that these have different functions within a single organism). The conclusion influences our interpretation of the function of the genes.

As the ƒ₂ value approaches the equilibrium value (the ƒ_{Aeq}²+ƒ_{Geq}² terms in the equations above), the accuracy of the kt distances becomes poor. This generally occurs after three to five half lives. When equilibration has occurred within the family because it encompasses large evolutionary times relative to the rate constant for transitions, it is no longer possible to use the process to distinguish orthologs from paralogs.

Placing a Root on the Tree Using the TREx Process

The ƒ₂ value can also be used to place a root on a tree. The root is the oldest point on the tree. The root is not identified reliably by any simple analysis of protein sequence data. With ƒ₂ values, however, the root can be placed using the following process.

First, the DNA and protein sequences are reconstructed at nodes in a tree using a tool of choice, such as maximum likelihood, or maximum parsimony. If maximum parsimony is used for the nucleotide reconstruction, it is useful to represent the nucleotide occupancies at sites where parsimony does not give an unambiguous result using fractional likelihoods. Since there is no good model for nucleotide substitutions at the outset of the analysis of any system (although these become better modeled as the details of the system become better known), simple assignment of 0.5:0.5 (when two nucleotides are possible), 0.33:0.33:0.33 (when three nucleotides are possible), and 0.23:0.25:0.25:0.25 (when four nucleotides are possible) is preferred at first. As analysis of a system proceeds, these can be adjusted using a branch length-weighted parsimony or maximum likelihood tools, once the codon distribution of the ancestral systems is better modeled.

Then, nucleotide substitutions along each branch are assigned, and then those are counted where an amino acid encoded by a two-fold redundant codon system is conserved. Fractional conservation of the amino acid is also possible. Then, for each branch, an ƒ₂ value is calculated as the number of transitions at two-fold redundant silent sites, divided by the total number of two fold redundant codon systems that are conserved. As illustration, consider the following case:

| | | |
|---|---|---|
| Site 1, protein A: | 0.5 His | 0.5 Pro, |

| | | | | |
|---|---|---|---|---|
| at the DNA level | | | | |
| Position 1 | C | 1.0 | | |
| Position 2 | C | 0.5 | A | 0.5 |
| Position 3 | C | 1.0 | | |
| Site 1, protein B: | 1.0 | His | | |
| Position 1 | C | 1.0 | | |
| Position 2 | C | 1.0 | | |
| Position 3 | C | 1.0 | | |

| From amino acid site 1, number of “two fold redundant | | |
|---|---|---|
| sites” = 0.5 | | |
| From amino acid site 1, number of “conserved two fold redundant | | |
| sites” = 0.5 | | |
| ƒ₂ calculated for this branch at this codon = 0.5/0.5 = 1.0 | | |
| Codon 2, protein A: | 0.5 His | 0.5 Gln |

| | | | | |
|---|---|---|---|---|
| at the DNA level | | | | |
| Position 1 | C | 1.0 | | |
| Position 2 | C | 1.0 | | |
| Position 3 | C | 0.5 | A | 0.5 |

| | | |
|---|---|---|
| Codon 2, protein B: | 0.5 His | 0.5 Gln |

| | | | | |
|---|---|---|---|---|
| Position 1 | C | 1.0 | | |
| Position 2 | C | 1.0 | | |
| Position 3 | C | 0.5 | A | 0.5 |

From amino acid site 1, number of “two fold redundant
sites” = 0.5
Changes assigned to the branch between the sequence:
C->A 0.25 (= 0.5 × 0.5), C->C 0.25, A->C 0.25, A->A 0.25,
From amino acid site 1, number of “conserved two fold redundant
sites” = 0.5 = 0.25 + 0.25
ƒ₂ calculated for this branch at this codon = 1.0

Each ƒ₂ value is then converted to a kt distance (equivalent to a TREx distance) along each branch using the equation above, and a variance is placed on this value.

The root on the tree is then determined by a process that involves starting at any leaf, tracing the tree directly to any other leaf, and summing the kt distances traversed along the branches. Then, one repeats the process for each leaf pair to find the longest kt distance. Once the longest distance is found, the path giving the longest distance is then retraced, but with the tracing stopping at the point where the distance traversed is half of the longest kt distance. This is the point on the tree where the root is placed.

Once a root is found, it is possible to refine its placement. The root defines, most frequently, a point on a branch in the graph. Thus, it defines two subtrees, which we will refer to as the left subtree and the right subtree. The ƒ₂ values for all pairs of sequences where one member of the pair comes from the left subtree and the other member of the pair comes from right subtree correspond to the same time interval. Therefore, one can average these. The average can even be weighted, if desired, using standard statistical methods.

Indeed, a simple way to place approximate ƒ₂ values for a node in the tree is by guessing the root, for example by examining the taxa that yielded the sequences at leaves of the tree and assuming that all of the proteins at the leaves are orthologs, and then averaging the ƒ₂ values for pairs from the subtrees beneath the node, where one member of the pair comes from the left subtree and the other member of the pair comes from right subtree.

As the ƒ₂ value approaches the equilibrium value (the ƒ_{Aeq}²+ƒ_{Geq}²-like terms in the equations above), the accuracy of the kt distances becomes poor. This generally occurs after three to five half lives. When equilibration has occurred within the family because it encompasses large evolutionary times relative to the rate constant for transitions, it is no longer possible to use the process to assign the root. In trees representing such families, the ƒ₂ value places the root within the region where equilibration has occurred. This rooting still has utility, as it provides a direction for time for every branch that emerges from this region, permitting the assignment of a root to every subtree leading from the branch. Once that direction is established, ƒ₂ values can be assigned for every node within the subbrranch using the approximation described above.

Ordering Gene Duplications that Created Paralogs by Analysis of the Genome of a Single Species

The emergence of complete proteomes for an organism provides the opportunity of a complete genome analysis. This generates a process that looks backward in time in a slice of the biosphere, where that slice contains the organism whose genome was sequenced, the ancestors of all of the constituent genes, the ancestors of these ancestors, and so on, back (in principle) to the origin of life.

If each of the genes within a genome arose independently of all other genes, there is little that can be done by way of an evolutionary analysis within a single genome. Any evolutionary analysis requires at least two homologous genes.

Fortunately, some genes within a genome are paralogs (Drawing 4). Paralogs are pairs of genes within a single genome that are related by common ancestry. They most likely arose by a gene duplication at some point in the past history of the organism (although it is also conceivable that an apparent paralog entered the genome by lateral transfer). Sometimes, families of paralogous genes within a genome can be quite large. The ABC transporters, protein kinases, and proteases are examples of gene families that, within vertebrates, have many members. Therefore, an evolutionary analysis of a single genome must focus on these paralogs.

A purely single genome analysis, by definition, also offers no orthologs. This implies that there is no way to calibrate a clock, as the dataset includes no two proteins from two taxa whose divergence can be known from the geological/paleontological records. This does not render the TREx approach useless, however. Within a single genome, the sequential order of gene duplication events can be determined using the ƒ₂ metric. This provides an “ordered dating” of gene duplications. This, in turn, supports many processes that extract information about function within a genome using a strategy that exploits temporal correlation.

This is analogous to the use of stratigraphy in paleontology before isotopic dating was available. In paleontology, the dates of various organisms are ordered by the sequence that they appear in the strata, without any information about the geological dates of the strata. Here, the dates of various gene duplications are rank ordered by the sequence of the ƒ₂ values that characterize them.

A single genome analysis avoids many of the problems in doing such sequential dating that might be encountered if different taxa in different lineages were examined. Because all of the genes are evolving in the same organism at any one time, one is assured that the environment (temperature, pH) and parameters associated with mutation (transition rate constants, transversion rate constants, and codon biases, for example) are the same for all of the genes being studied at any instant in the historical past. One cannot be certain of this if different taxa in different lineages are being examined.

Family Pair Analysis

Analysis of a Genome of a Single Species: Detecting Functionally Linked Paralogs, or Pathways

This ordered dating creates an opportunity to use genomic sequence data to construct hypotheses that identify protein pairs (or larger sets of proteins) that interact when they function. These are called “functionally linked”. Functionally linked proteins have a relationship, but not usually one of homology. Instead, functionally linked proteins form regulatory networks and metabolic pathways.

Temporal correlation was used in Ser. No. 08/914,375 to hypothesize, retrodictively, that the leptin and leptin receptor were functionally linked. Here, two trees were built for two sets of presumably orthologous proteins from mammalian taxa. Temporal correlation was made between the two trees based on the assumption that the proteins at the leaves of the tree were orthologs. If this is the case, then the nodes in each tree represent speciation events that led to the taxa at the leaves of the tree. As the speciation events represented by the two trees are the same, branches in one tree can be directly correlated in time with branches in the other. Thus, the observation that one tree has a high Kₐ/Kₛ ratio for a branch that correlates in time with a branch on the second tree, which also has a high Kₐ/Kₛ ratio, can be used to support a hypotheses that proteins in the two families interact as they function.

In the instant invention, temporal correlation is exploited, but without the need to know the absolute, geological dates of events in the historical past, or to assume that any two proteins are orthologs. Thus, protein families that have suffered duplication at the same time (that is, have generated paralogs with comparable ƒ₂ values), by hypothesis, interact when they function.

Example 1 shows how this was done for the yeast genome. Here, a single completed genome of high quality (Saccharomyces cereviseae) served as a starting point. All paralog pairs within the genome were identified. An ƒ₂ value was calculated for each pair of paralogs, and the pairs were then sorted by decreasing ƒ₂. This should (if the theory is correct, within the error of fluctuation) order the time of these gene duplications, going back in time. A histogram was constructed to show this ordering of the duplications (Drawing 5).

The most striking feature of the histogram in Drawing 5 is its suggestion that duplications are not randomly distributed in time, but rather are episodic. It is also clear that which genes are duplicated in any given episode is not random. For example, one particularly well isolated episode of gene duplication is seen in the yeast genome, with an ƒ₂ of 0.82. Looking at the cultural annotation associated with these entries, the genes that are duplicated are seen to be: hexose transporter (3 duplications), pyruvate decarboxylase (non-oxidizing, from the oxidizing enzyme), alcohol dehydrogenase (Adh I and II isozymes), thiamin transport, glyceraldehyde-3-phosphate dehydrogenase, and a gene with putative involvement in mating. This is a pathway, here, the pathway that ferments glucose to alcohol (Drawing 6). Each of the genes duplicated in this burst of evolution (with the possible exception of the gene involved in mating) is known to be specialized for the fermentation pathway.

The example also illustrated how this process might be used to generate annotation hypotheses about unknown genes. Most trivially, we might hypothesize that the unannotated gene in the yeast proteome that is duplicated at the time when the fermentation pathway originated is also involved in fermentation. This suggest an experiment whereby one knocks out the gene, and examines the ability of the yeast to ferment, as opposed to examining any of a large number of other phenotypes under a large number of possible conditions. A second example is given below, where the occurrence of duplications in the human genome contemporaneous with the duplications of genes involved in the higher nervous system of primates suggests a functional link as well.

A second feature in the example with the yeast genome is the high rate of recent duplication identified by this process in the yeast genome. These too suggest a pathway as a hypothesis. Recent duplications fall into three (and only three) classes: (a) genes that speed DNA synthesis, (b) genes that speed protein synthesis, and (c) genes for malt degradation. The process has produced the hypothesis that these duplication representing yeast's recent association with humans, who offer it a far richer environment than in the wild. These duplications should select for strains of yeast that are able to grow rapidly, divide rapidly, and make beer.

This process does not require, of course, that the proteins physically come in contact when they function. Thus, it is more powerful than the simple correlated substitution process disclosed in Ser. No. 07/857,224. Proteins involved in a metabolic pathway may interact only through the transfer of small molecules that is a product/substrate pair for two enzymes. More generally, and novel in the instant disclosure, is the analysis of features of molecular evolution that might indicate pathway relationships not involving direct protein-protein contact.

Of course, even if one believes that the genes at the leaves of a tree are orthologs, it is helpful to have independent confirmation of that belief. This confirmation can be provided by TREx dating. Thus, it is possible to combine TREx dating with the process for pathway detection disclosed in Ser. No. 08/914,375 to generate an improved method for identifying functionally linked proteins.

Dated Paralog Analysis of a Genome: Correlation with Geological and Paleontological Records

The detection of the fermentation pathway in yeast using the process of the instant invention, and applying it to identify (within the time resolution of the tree in the associated evolutionary model) gene duplications that are correlated in time, was done without making any reference to absolute dates. Adding absolute dates allows the addition of geological and paleontological records to the analysis, however. By doing so, these pathways assume additional biological meaning.

In this particular case, given dates for events represented in the yeast genome, the emergence of the fermentation pathway in yeast genome can be correlated with the emergence of fermentable fruits ca. 80 Ma (million years ago), known from the fossil record of plants [Dil00]. The prominent episode of gene duplication an ƒ₂ near 0.84. This corresponded to duplication events that occurred ˜80 Ma, based on a calibration of the clock using fungal fossils [Ber93].

Fossils suggest that fermentable fruits became prominent ˜80 Ma, in the Cretaceous, during the age of the dinosaurs [Dil00]. That is, the fermentation pathway in yeast arose when fermentable fruits arose. Assuming this correlation to be causative, one can calculate an average transition rate constant for yeast of ca. 3.5×10⁻⁹ changes/base/year. Here the average is both for the pyrimidine-pyrimidine and purine-purine transitions, and over the time since the divergence occurred (these transition rate constants need not be time-invariant). Further, the correlation appeared to be extendible across the ecosystem, with Drosophila (the fruit fly) showing an episode of rapid evolution at the same time. Other genomes also record episodes of duplication near this time, including those of angiosperms (which create the fruit) and fruit flies (whose larvae eat the yeast growing in fermenting fruit) [Ash98][Per95].

In this particular case, two uncertainties make this a hypothesis. First, we do not have direct experimental evidence for a historical transition rate constant in the yeast lineage. Second, we do not know for certain that fermentation arose when fermentable fruits arose. Given one, the other follows, however. Thus, this example illustrates the value of hypotheses even in the absence of proof.

Based on this, it is possible to suggest a time correlation hypothesis that concerns not just two amino acids in the same protein in contact in the functionally significant folded form, or two amino acids that make contact through a protein-protein interaction in a heterodimer, or two or more proteins involved in a metabolic pathway. This time-correlation across the genomes in an ecosystem generates an annotation hypothesis that rests several levels above those enabled by other tools. The process applied to the yeast alcohol dehydrogenase isozymes, for example, goes beyond a statement about a behavior (“this protein oxidizes alcohol . . . ”) and a pathway (“ . . . acting with pyruvate decarboxylase . . . ”) to a statement about planetary function (“ . . . allowing yeast to exploit a resource, fruits, that became available ˜80 Ma”). This level of sophistication in the annotation of a gene sequence is difficult to create in any other way. Further, we can hypothesize that genes duplicating in Drosophila at the same time may be functionally involved in the adaptation of fly larvae to live on fermenting fruit. This is not proof, of course. But considering the number of genes in Drosophila, and the number of possible functions, the hypothesis narrows the experimentation that might be done, and therefore has utility.

This exemplifies another class of time correlation that is disclosed in the instant invention. Here, a time correlation is made between events in the molecular record and events in the paleontological and geological records. One of ordinary skill in the art can imagine many other areas where this type of analysis is likely to have utility. Several more of these are disclosed below.

Multiple Family Analysis

Improvement Over Prior Art for Temporal Correlation Between the Molecular Record and the Paleontological and Geological Records

We now make comments on why the process disclosed here is different from, and frequently preferable to, processes that are found in the prior art to doing temporal correlations.

The prior art tool for analyzing silent replacements originates with a paper by Li [Li85]. While Li was more concerned with functional change more than dating divergences, many have used the Li silent metric as a dating tool.

This tool aggregates all silent mutations into a single value. Because rate constants for transitions and transversions are generally rather different, a pure transition clock captured within the ƒ_{2R} or ƒ_{2Y} metrics (or if the rate constants for pyrimidine-pyrimidine transitions are comparable to those for purine-purine transitions, the ƒ₂ metric), then TREx analyses must order date duplications in a single genome better than a clock that combines transitions and transversions. In practice, it must also generate larger variances, however. Empirically, therefore, the TREx metric is favored when the fraction of four fold redundant codon systems in one family to be compared is different from that fraction in the other family.

Drawing 7 shows the result when the paralog analysis of the yeast genome is repeated, not using the process of the instant disclosure, but rather using the prior art tool for order dating the divergences of paralogs in the yeast genome. The histogram was created by Lynch and Conery [Lyn01], and extracted from the literature.

The first obvious difference is that the histogram based on the prior art tool misses entirely the episode of duplication associated with the emergence of fermentation. It is likely that this is because the metric used to order date duplications from the prior art combines transitions and transversions with different rate constants. Accordingly, the authors of the diagram did not successfully identify the value of time-correlated duplication as a tool to identify pathways. The authors did not even recognize the hypothesized significance of the recent duplication.

Improvement Over Art Concerning Tools for Detecting Pathways Using Genomic Sequence Data

We know of no other approach that can generate this level of functional insight, or capture pathways and regulatory networks as effectively. The prior art from outside the Inventor's laboratory contains very little work attempting to extract hypotheses about protein-protein interaction using evolutionary analyses of this type. One approach was suggested by Pellegrini et al., who extended this type of analysis to generate “protein phylogenetic profiles” for different organisms [Pel99]. Their process assumed that during evolution, proteins that function together tend to be either preserved or eliminated together in a new species. This is a class of correlated events on a genome scale, although these authors did not evidently recognize the temporal features of the process. The process characterizes each protein by its phylogenetic profile, a string that encodes the presence or absence of a protein in every known genome. Proteins having matching or similar profiles are hypothesized to be functionally linked.

Perhaps the closest is work to that of the instant invention comes from the laboratory of Fred Cohen at the University of California (San Francisco). Cohen and his coworkers considered phosphoglycerate kinase (PGK), an enzyme that forms its active site between its two domains. The N-terminal and C-terminal domains of PGK form the active site at their interface and are covalently linked. Therefore, these authors hypothesized that the two must have co-evolved to preserve enzyme function. By building two phylogenetic trees from multiple sequence alignments of each of the two domains of PGK, Cohen and his coworkers calculated a correlation coefficient for the two trees that quantifies the co-evolution of the two domains. The correlation coefficient for the trees of the two domains of PGK was calculated to be 0.79, and these authors suggested that this establishes an upper bound for the co-evolution of a protein domain with its binding partner. Their analysis was extended to ligands and their receptors, using the chemokines as a model [Goh00]. More recently, Pazos and Valencia expanded this approach to try to correlate similarity in phylogenetic trees as indicators of protein-protein interactions [Paz01].

Other processes have been proposed that infer pathway relationships between protein sequences. For example, Eisenberg and his coworkers. Enright [Enro01], and others have also suggested that proteins that interact in a pathway might be connected physically in the genome, either as an operon or, in some cases, in a single expressed polypeptide chain. This interesting approach is applicable to only a subset of the database, and is distinct from the tools disclosed here. [Mar99].

Without diminishing the importance of this work, it fails to exploit most of the information that is available within protein sequences divergently evolving under functional constraints. It also does not diminish the novelty of the instant invention.

The Pathway Discovery Process and its Output.

We can present a list of steps that must be taken to implement the process of the instant invention to generate hypotheses concerning possible pathways within a Target genome. As is evident to those skilled in the art, not all of the steps are required to have utility or novelty. In particular, some of the steps important for human visualization (such as generating a histogram) need not be done if subsequent analysis is primarily computational. Conversely, some of the steps important for computational analysis need not be done if subsequent analysis is to be done primarily through human visualization.

1. Perform a paralog analysis for the genome

1.1 Identify the paralogs. The first step in performing a paralog analysis requires that the paralogs be identified. This involves an “all against all” self-matching of the genome. To do this matching exhaustively, every string in the proteome is compared with every other string, and a score given to the match. The matches are then ranked in order of decreasing score. This may be done by matching the DNA sequences themselves, permitting all gene duplication events to be detected, even those not involving encoded sequences. For the purpose of this discussion, however, we focus on the analysis of regions of the genome that encode proteins.

1.2 For each pair of paralogous genes, calculate an ƒ₂ value, which may be the ƒ_{2R}, ƒ_{2Y}, or ƒ_{2RY} value. Preferably, all three are calculated, as it costs very little to do so, and one can see whether the ƒ_{2RY} value (which has a lower variance) is distinctively different from the ƒ_{2R} and ƒ_{2Y} values.

1.3 Create a table of pairwise ƒ₂ distances between every paralogous gene within the Target proteome. These will permit us to rank the order when the paralogs were formed.

1.4 Create a computer searchable database corresponding to this table. This is Deliverable 1. Each entry is then associated (if possible) with cultural annotation, including putative names of the paralogs, gi and accession numbers that permit reference to be made to standard sequence databases, and links to literature.

1.5 Represent the output as a histogram, where the number of paralog pairs within a particular ƒ₂ window is plotted as a function of ƒ₂ (as in the drawing for yeast). This allows one to observe the pattern and tempo of gene duplications as a function of time. Note, the time (x) axis is logarithmic with respect to geological time. TREx kt distance may also be used as the abscissa of the histogram.

1.6 Identify families that are duplicating at or near the same time. These are events that are correlated in time. Hypotheses are generated that indicate that the proteins encoded by genes that are suffering duplication at the same time may be part of a pathway (metabolic or regulatory). The cultural annotation is then downloaded from the database (wherever it is available) and presented to the biologist, who will use it to make inferences about the function of the genes and proteins involved, and design experiments to test the hypotheses.

This yields Deliverable 2 as an output: A matrix of interconnections between protein families containing representatives of the Target proteome that hypothetically interact when they function (e.g., kinases, kinase substrates, and phosphatases), based on contemporaneous duplications in the interconnected families. This can be in either paper or electronic form, the latter being preferred because it can be electronically searched.

Each interconnected pair suggests a putative functional interaction. This putative interaction can be tested experimentally using methods well known in the art (e.g., two hybrid tests). Thus, this Deliverable is a database of hypotheses about functional links within the genome.

Multiple Organism Analysis: Adding a Second Genome

The principal disadvantage of a single genome analysis is that there are no orthologs, which are homologs from another taxon. As a result, the dataset does not contain any pair of sequences that can be used to calibrate the transition clock, estimate t, and therefore generate an estimate of k. An estimate of k is, in turn, useful when attempting to correlate the molecular record with the paleontological and geological records, as these are denominated in years (absolute, or geological time).

A single homolog from a second species already adds information beyond that extractable from a single genome. If we assume that the homolog is an ortholog of the gene in the Target organism, and if the date of divergence of the two taxa is known (or can be estimated) from the geological/paleontological records, then we can calculate (or estimate) the relevant rate constant k from the ƒ₂ value separating the two orthologs.

Two practical issues must be considered. First, the preferred calculation of the ƒ₂ value must be based on as many sites as possible. Thus, if a single pair of orthologs is available, they should be as long as possible, preferably delivering more than 100 sites as input into the ƒ₂ calculation. More preferable is to have several (still more preferably, many) orthologous pairs of proteins to deliver 1000 or more sites for the ƒ₂ calculation.

Second, one must be certain that one is dealing with orthologous protein pairs. If there were no gene loss, one might gain confidence that one was inspecting true orthologs by finding the gene in the Target genome that had the smallest ƒ₂ value when compared with the gene from the second species. Here, the process involves simply selecting from the Target genome. Unfortunately, gene loss may be common, especially in some taxa (such as plants).

Having second genome offers an approach to generate hypotheses about k and t based on orthologs. Here, a cross matching of the genomes of the two taxa, taxon A and taxon B, is done. In this cross matching, intertaxon ƒ₂ values are calculated. The families are then clustered, and a histogram is made. When only one intertaxon pair is available for a family of proteins, the family contributes only one datapoint for the histogram. When a family has generated many paralogs in the two taxa, however, the family will generate many intertaxon pairs. In principle, an intertaxon pair cannot represent an orthologous pair if its ƒ₂ value is significantly higher than another intertaxon pair. Conversely, the intertaxon pair within a family that includes paralogs is the true ortholog, if the true ortholog has not been lost.

For this reason, it is convenient to create the histogram by choosing the intertaxon pair from the two families with the lowest ƒ₂ value. This will collect true orthologs, whenever true orthologs are contained within the database. When the database contains the complete genomes of the two taxa, then only gene loss will cause the true orthologs to be missing from the database.

This suggests a process as an expedient, which we illustrate here using the human and mouse sequences within the database. The histogram in Drawing 8 collects a representative from all families represented in both taxa. When the families have paralogs, some of the pairs are orthologs and some are paralogous. From each family, the intertaxon pair with the lowest ƒ₂ value was extracted and represented on the histogram. Because neither the human nor mouse genomes are complete (even in their “draft” forms), some of the intertaxon homologs will not be true orthologs, and will have ƒ₂ values lower than expected for true orthologs. In the absence of lateral transfer between the taxa, no ortholog will have an ƒ₂ value higher than that expected for true orthologs, after considering that ƒ₂ values are calculated from a discrete set of characters. Therefore, on the histogram, the orthologs separate themselves from the paralogs, where the former are presumed to be the pairs, distributed in a Poisson fashion around the ƒ₂ value that is the expectation value for two genes diverging at the date when the species diverged. A Gaussian-type curve based on the number of characters used to calculate the ƒ₂ values is fitted to the cluster with the high ƒ₂ value. The top of the curve is the ƒ₂ value expected for diverging orthologs.

From the histogram shown in Drawing 8, calculated from intertaxon pairs from mouse and human, the expectation value for the mean ƒ_{2RY} value for a pair of true orthologs was found to be 0.78. From the Kazusa codon database, at two fold redundant codon systems involving pyrimidines, the C:U ratio is 0.56:0.44, while at two fold redundant codon systems involving purines, the G:A ratio is 0.64:0.36. The ratio of the two codon systems is 2128126.00/1729692=1.23. A slight curvature was seen in the plot of ƒ_{2RY} versus ƒ_{2RY}, suggesting that the two rate constants differed by a factor of ca. 1.4. Neglecting the difference and weighting generated an approximate end point, 0.59²+0.41²=0.52.

The next step in the process involves estimating a rate constant k for the replacement process used in the molecular clock. This requires correlation to a fossil, geological, or other “truly chronological” record. Divergence of humans and mouse is estimated to have occurred 80 million years ago, meaning that 160 million years separate mouse and human orthologs. From this, the formulas above, and the mean ƒ₂ value of 0.78 from the histogram shown in Drawing 8, a time-invariant transition rate constant is was estimated to be ca. 3.8×10⁻⁹ transitions/site/year, and a half life of 182 million years, using the following calculation:

kt=−ln{(0.78−0.52)/0.48}=0.61 t=1.6×10⁸ years, k=3.8×10⁻⁹ transitions/site/year

The precision of the TREx clock is greatest when the gene duplication is near this half life. Remembering that the time separating two orthologs is twice the time since they diverged, and that the divergence of the mammal orders occurred in the Cretaceous, and that the divergence of mammals is associated with many phenomena that have biomedical significance, the TREx clock has the characteristics that are useful for biomedical applications.

Reconstructing genes in the ancestral genome, together with the process of determining lineage-specific parameters of DNA sequence divergence, outlined below, showed that the rate constant in the rodent lineage was about twice that in the primate lineage. The notion that the rate constants may not be time-invariant or lineage-invariant will be discussed briefly. It does not affect the use of the TREx strategy to order the generation of paralogs in a genome.

This permits us to estimate dates for the duplications that generated the paralog pairs recorded in the Deliverable. For every gene duplication that generated a paralog, back to the time when the silent sites have equilibrated, a geological date of duplication can be placed using the ƒ₂ values, and estimates for k based on one or more orthologs. The more orthologs, the better, of course. The presently preferred values for k are obtained for species divergence from a minimum of 1000 two fold redundant sites. The presently preferred number of sites needed for a comparison of two sequences is greater than 50.

Adding Multiple Sequences from a Variety of Taxa

Within a set of paralogous proteins, species populations sizes, generation times, polymerase mutation error rate constants, and other factors that might influence the rate of accumulation of silent mutations are the same for all genes at any instant in time. They need not, however, be invariant over time. That is, the rate constant for transitions might be slower in the lineage leading to modern human in the period since the divergence of humans from mouse, than it is in the lineage leading to human in the period between the divergence of marsupials and the divergence of mouse. Likewise, the rate constant for transitions need not be the same at all in the lineage leading to mouse after it diverged from the lineage leading to human, as in the lineage leading to human.

We can, however, calculate the rate constant for transitions (or, indeed, any other process, including transversions) along any branch between nodes on a tree, provided that we can reconstruct the sequences of proteins at that node. This provides lineage-specific information, information about events, sequences, rate constants, and insertion-deletion probabilities for specific episodes in the historical past of a specific lineage. Reconstructing the sequence of a gene at a datable node in a tree in general requires at least three orthologs, two for comparison, and a third as an outgroup. These are increasingly available. Indeed, with the strong representation of sequences from the mouse and human genome, and with the genome of a third vertebrate (the zebra fish, for example) imminent to serve as the outgroup, the process is implementable today to reconstruct many, and perhaps most of the genes that were present in the last common ancestor of mouse and human, to a reasonable level of accuracy. From these ancestral reconstructions, it will be possible to place constraints on the codon bias in that ancestor, and to assign a sufficient number of mutation and replacement events to the branches that lead from the ancestor to mouse, and from the ancestor to humans. This will provide the constraints on the time-invariance of codon bias, and permit the calculation of all transition and transversion rate constants, shown in Drawing 9.

This is Deliverable 3: A list of characteristics of the lineage going back in time, as far as the tools give reliable read-outs. Specifically, we establish for each lineage:

1 Codon bias, both for the contemporary species, and for species in the historical past. This will improve the TREx dating.

2 Microscopic DNA substitution patterns, including forward and reverse rate constants for all 12 rate processes along each branch in the lineage between nodes where ancestral proteins can be reconstructed. These can be compared with the rate constants for the same processes observed in introns (or other non-coding regions).

3 Rate constants for the ƒ₂ calculation, going back in time, in particular, whether the rate constants are time-invariant.

In some lineages, such as those from plants, this model for lineage history has special utility. It is known that lineage-independent codon bias is not a good approximation [Tif02] of reality, even in the (short) time separating Brassica and Arabidopsis, and certainly not when comparing rice and Arabidopsis. More advanced models must be used to exploit synonymous mutations in angiosperms, and these must be based on a model for the natural history of nucleotide substitution at silent sites within angiosperms.

To illustrate the steps that must be taken to implement the process, consider plants, for example. The strategy for reconstructing codon bias in ancestral angiosperms begins with the Soltis tree that interrelates angiosperm taxa [http://www.flmnh.ufl.edu/deeptime/dating divergences.html]. For each ancestral node, all of the families that contain at least one representative from taxa below the node (left branch and right branch), and one outgroup are identified. We then reconstruct ancestral genes at the node. In a first pass analysis, augmented parsimony is adequate for the silent sites; more refined likelihood tools can be applied later. This is repeated for as many families as are available. The reconstructions are collected for each node, and a table for the codon bias at this node is generated. The presence of an Arabidopsis genome and a rice genome is also invaluable, as it guarantees (whenever orthologs can be found) that we have at least two sequences upon which to reconstruct the ancestral genome.

It should be recognized that while these processes can be applied to the existing genome database today to generate useful deliverables, the databases will grow to contain more information. As they grow, it makes sense to iterate the process. With each iteration, the models about ancient species will become more constrained. Ultimately, multiple genome analyses will converge on a global historical model that will increasingly constrain dates, and this model will constantly be revised over decades as new sequences appear, as new fossils appear, and as we hypothesize interconnections between the molecular, geological, and paleontological records.

Using TREx Distances to Build a Tree

The TREx kt is a measure of evolutionary distance, not of evolutionary time. As distances, kts are additive, and should obey the triangle inequality, provided that k is constant over the period of evolutionary history being examined. A variety of empirical studies shows this to be approximately the case for many protein families. Because they are distances, TREx values may be used in a distance matrix approach to construct a tree for the species.

Improving an Evolutionary Model for a Single Nuclear Family

The basic element of a naturally organized database is an evolutionary model for the nuclear family. This model consists obligatorily of two parts: (a) an evolutionary tree interrelating members of a protein family, (b) a multiple sequence alignment, which shows the evolutionary relationship between specific amino acids in the various proteins within the family. In addition, the family can record information about (c) reconstructed ancestral sequences at nodes in the tree.

These three components of a model for a nuclear family can be constructed from the sequences of members of that family alone. Lineage specific and genome specific information may later be used to enhance the model, but is not necessary to construct the model initially.

We now describe the process for creating an evolutionary model for a nuclear family based on this disclosure. As is evident to those skilled in the art, not all of the components listed below must be present in a model for it to have utility or novelty. In particular, some steps are important for some interpretive heuristics, while others are needed for other interpretive heuristics.

Trees, multiple sequence alignments, and even ancestral sequences have been used in the prior art to describe the history of a protein family. Indeed, they are readily constructed by many standard methods, including MacClade, PAML [Yan97], and PAUP [Swo98]. Therefore, the process of constructing an evolutionary model for the nuclear family is relatively routine:

1. Complete the inventory of homologs.

1.1 Do a BLAST search of the current database; identify genes that have been entered since the last family compilation was constructed.

1.2 Go to the current whole genomes, and get a complete inventory of the homologs in these.

1.2.1 Additional genes might be added to the family compilation family

1.2.2 Use whole genome sequences, where ever possible, to cull a family to remove duplicates.

1.3. Build the core model using standard tools (parsimony, maximum likelihood, PAML, PAUP, and MacClade are all preferred. The core model consists of a tree, a multiple sequence alignment (MSA), and ancestral sequences.

Modifying the Family Content

The input for a computer systems comprising a database of the instant invention is a set of sequences of homologous proteins. These may be protein sequences alone, although the most preferable embodiment of the database includes both protein and DNA sequences. An evolutionary tree and a multiple sequence alignment is then constructed for these using one of the methods cited in Ser. No. 07/857,224 and its various CIPs. In the presently preferred embodiment, the protein sequence alignment is taken as the standard, and the corresponding DNA sequences are aligned to follow the protein sequence alignment.

If an existing, publicly available, family of sequences (such as one from the Dayhoff Atlas) is used as a starting point, the practitioner of ordinary skill in the art may wish to alter the contents of the database. Some possible modifications to the set of data in the family are listed in Table 3.

TABLE 3
Modifying the contents of a nuclear family

Add sequences, perhaps proprietary sequences
Remove apparent duplication
Remove sequences to make the family small enough so that computations
not prohibitive
Remove sequences without DNA (for analyses that require DNA)
Remove “defective sequences” (fragments, dubious intron assignments)
Remove sequences to make the tree less cluttered for presentation

The practitioner may chose to add sequences to those that are delivered as part of the family. Most commonly, the practitioner may possess sequences that is not in the public domain. Alternatively, the practitioner of ordinary skill in the art may wish to remove sequences from the family as it is delivered. GenBank has a bias towards redundancy; virtually every sequence variant that is submitted to GenBank ends up in the database. Often, exact duplicates or near duplicates contain interesting information, and should be retained. But for other purposes, a family with too many sequences may be difficult to visualize, or may slow subsequent computation. In these cases, the delivered family may be culled, to remove exact or near duplicates, or to remove sequences from exceptionally bushy branches. An extended family (if that is what is delivered) may be trimmed, or divided into two nuclear families that each meet the specifications where the PAM width of the tree is less than ca. 150. In either case, the original tree and MSA may be recomputed.

Some general features about each individual family are then noted. First, the overall PAM distance of the family, a measure of the number of point accepted mutations per 100 amino acids between the most distant sequences within the family, is noted. The average PAM distance for the individual branches in the family, is noted, as can the longest branch and the shortest branch. For regions where the silent sites have not equilibrated, the average TREx kt distance along the branches is noted, as can the presence or absence of one or more of these with a kt distance of 1.5-0.5, where the TREx kt distance is particularly accurate. The average Kₐ/Kₛ ratio between nodes is noted, as can the highest and lowest ratio. This ratio can be recalculated using a TREx distance in the denominator.

Then, the features of the tree can be noted relative to the features needed to apply interpretive proteomic tools. For almost all applications, a highly divergent family is better than a family composed from only highly similar sequences. The former contains more information, while the latter resembles (in terms of information) many copies of the same newspaper, therefore not containing much more information than the first copy. The preferred breadth for a useful tree will increase as MSA alignment tools improve. This will be especially true as improved gap placement tools are developed. For the inventions disclosed in Ser. No. 07/857,224, the presently preferred PAM width is ca. 150 PAM units.

For tools disclosed here, the width of the tree is not as important as its articulation and the features of the branches. For these tools, the presently preferred tree contains four or more branches with a kt distance less than 1.5. These are essential for a reliable Kₐ/Kₛ value, permitting an average Kₐ/Kₛ value to be calculated for the family. Alternatively, the presently preferred tree contains two or more sub-branches with at least 10 pairwise separations greater than 5 PAM units. This is a cutoff, somewhat arbitrary, for the number of homologs necessary for calculating a useful alpha parameter for a gamma model describing the distribution in the mutability of different sites in the protein sequence.

This generates Deliverable i, a first pass evolutionary model for family i of homologous proteins.

Rectifying the Family

After the inventory of homologs is completed, the practitioner may desire to rectify the multiple sequence alignment and tree. Rectification means the adjustment of the family and its evolutionary model to obtain a rectified model where, for a specified reason, the practitioner believes that the model more accurately reflects the true historical past for the family.

Generally, rectification of an evolutionary model is needed whenever the practitioner of ordinary skill in the art is dissatisfied with some feature of the evolutionary model for the family of proteins as delivered. For example, the placement of gaps in a multiple sequence alignment is often a source of dissatisfaction. The branching of the tree as determined by a scoring system may disagree with what is known, or believed to be known, about the true evolutionary history of the protein family, for example, from non-sequence information, such as the fossil record, or trees made from the sequences of other biomolecules. The practitioner may not be satisfied with the tools used to construct the evolutionary model. Different practitioners are advocates of different tools to construct trees and MSAs. Some prefer parsimony methods, such as those implemented by PAUP [Swo98]. Others prefer maximum likelihood methods as implemented by PHYLIP (http://evolution.genetics.washington.edu/phylip.html). Preferences vary concerning scoring matrices. A practitioner may wish to alter the tree to allow it to reflect the preferred method.

Also, an evolutionary model might be rectified because some of its sequences are erroneous. Intron/exon and start/stop boundaries may be incorrectly identified, and in silico tools to detect such incorrect identifications might be applied.

TABLE 4
Rectifying the tree

| 1 | Apply more expensive processes to the construction of the MSA/tree | |
|---|---|---|
| | 1.1 | Longer computation times |
| | 1.2 | More sequences |
| 2 | Apply more sophisticated and more realistic processes to the | |
| | construction of the MSA/tree; inch towards reality | |
| | 2.1 | DNA versus protein-based analysis. |
| | 2.2 | Distance-based tool using gamma models, or other refined |
| | | distance metrics, to build the tree, especially with long branch |
| | | lengths. |
| | 2.3 | Incorporate paleontological information to constrain the tree. |
| | 2.4 | TREx distances used to build the tree |
| | 2.5 | Covariation metrics, alternative branching |
| | 2.6 | Sophisticated gap placement, |
| | 2.7 | composite tools, such as TREx distances for recent duplications, |
| | | gamma model distances for ancient duplications around long |
| | | branches. |
| 3 | Robustness metrics | |
| | 3.1 | Build models with alternative sampling of the database |
| | | (robustness to sample size) |
| | 3.2 | Build models with alternative tools |
| 4 | Detect errors | |
| | 4.1 | Intron placement |
| | 4.2 | Start-stop points |

Many of the processes used here are inventive in their own right, and are disclosed in greater detail below.

Above all, computational constraints may require the model may be recalculated. The presently most preferred method to construct these models begins with a distance matrix that incorporates a gamma model. This is then used as a starting point for the search for an optimal tree PAML-type tools, and features derived from our own empirical studies of replacement, insertion, and deletion in protein sequences, as described below. This is an expensive method to build an evolutionary model, however, and becomes computationally prohibitive when the number of proteins in a family is very large. Hence, a variety of expedients are used to manage the process of constructing evolutionary models. Most popular is simply to stop with a distance-based tree, with perhaps some local branch exchange.

Evolutionary models can be rectified using composite construction methods. Some regions of tree (in particular, those involving short PAM distances in highly conserved proteins) are not well defined by protein sequence analysis alone, especially if the proteins have not diverged substantially. Here, silent codon characters are very useful for rectifying the tree. At long distances, however, silent sites equilibrate, and become useless as characters for constructing a tree and ancestral sequences, although augmented parsimony can help. protein sequences are generally useful in these regions. To get the gross patterning of the tree, gapping is useful, but gapping need not be useful to get the fine topology. Even distance-based tree construction can be composite. For example, TREx distances might be used to construct trees for closely related sequences, while PAM distances might be used to construct trees for more distant sequences.

Especially useful are composite tree construction methods. Some regions of tree (in particular, those involving short PAM distances in highly conserved proteins) are not well defined by protein sequence analysis alone, especially if the proteins have not diverged substantially. Here, silent codon characters are very useful for constructing the tree. At long distances, however, silent sites equilibrate, and become useless as characters for constructing a tree and ancestral sequences, although augmented parsimony can help. protein sequences are generally useful in these regions. To get the gross patterning of the tree, gapping is useful, but gapping need not be useful to get the fine topology. Even distance-based tree construction can be composite. For example, TREx distances might be used to construct trees for closely related sequences, while PAM distances might be used to construct trees for more distant sequences.

Trees constructed using parsimony or maximum likelihood tools that retain residue-by-residue information are more powerful than those that are based on distances. When distance tools are used to build a tree, gamma models are presently preferred. These permit different sites in a protein or DNA sequence to suffer replacement at different rates, providing a more accurate measure of distance.

Many practitioners wish to constrain a tree in a way that reflects information from the fossil record. Many practitioners wish to constrain a MSA in a way that reflects information from crystal structures. Each of these are contemplated when constructing a model for the history of a protein family.

We ourselves frequently wish to adjust the placement of gaps within the MSA using advanced gap placement heuristics [Ben93], and to examine alternative trees using our compensatory covariation tools [Fuk02]. We now describe the enabling methods here.

Better Placement of Gaps/Correcting Intron Misidentification

The only truly serious problem in sequence alignment involves the placement of gaps. The only serious problem in eukaryotic gene finding, once a coding region is identified, is the placement of intron/exon boundaries and start and stop points. Processes disclosed here assist in both of these processes.

When an intron is missed, the protein sequence in which it was missed has an insertion relative to other homologs in a multiple sequence alignment. When a segment is removed under a mistaken impression that it is an intron, it leaves a gap relative to other homologs in a multiple sequence alignment. We could in principle identify incorrectly removed/missed introns by looking for gaps. The difficulty is that indel processes occur naturally. Therefore, some gaps are correct, not the consequence of errors in gene finding.

Therefore, the problem of intron assignment rectification based on an MSA analysis comes down to trying to detect which gaps in an alignment arise through true insertion/deletion events in the history of the protein family, and which arise through mistakes in gene finding/intron finding.

The strategy is to recognize that when a gap is created through a true indel event, the segment inserted/deleted is not random. The following processes are useful to identify true gaps:

True indels do not occur randomly in a sequence. Rather, they occur in parsing regions, as defined by Ser. No. 07/857,224, regions where the ends are near in space. These most often occur in turns and coils in the secondary structure. Therefore, a gap that does not occur in a parsing region defined by the sequences of the other proteins in the MSA has a higher probability of arising from a misassigned intron (over or under).

As a consequence, amino acids found in positions just before a gap in the gapped sequence (A), just after a gap in the gapped sequence (B), just before the position of the gap in the aligned sequence (P), just after the position of the gap in the aligned sequence (R), and in the insertion in the ungapped sequence (Q), do not have the same distribution as the amino acids in the database as a whole, when the gap is derived from a true, historical event:

XXXA---------BXXXX
XXXPQQQQQQQQQRXXXX

An empirically derived set of parameters can distinguish more likely and less likely gap assignments. These can be found in reference [Ben93]. The pattern of evolution in the region designated Q is also different when it is gappable. This includes both the rate of substitution (it is higher) and the amino acid distribution in the family (it is more like a parse).

One can place the putative indel event on the evolutionary tree. When a true indel occurs, the rest of the protein responds with an episode of rapid sequence evolution, a change in mutability distribution, loss of compensatory covariation signal, and other events indicative of changing function. If the putative indel is not real, these associated signals will not be found.

These lead to a set of inventive processes that permit the placement of valid gaps correctly in a starting multiple sequence alignment. The starting MSA is preferably generated using the Clustal alignment.

1. Identify anchors in the region flanking the gap in the starting MSA. These are segments where the score is sufficiently high that the gaps will not be pushed through them.

2. Move the placement of the indel between the two anchors, scoring using probabilities derived from [Ben93].

3. Calculating a score for each placement using a formula that includes what amino acids are within the gapped region, what amino acids are flanking the indeled region, and the variability approaching the gapped region.

4. Estimate the extent of sequence divergence in the gapped portion of the multiple sequence alignment. Select the placement of the gap so that the ratio of divergence in the gapped portion, divided by the overall sequence divergence, corresponds to that found in a dataset of verified gapped alignments.

These lead to a set of inventive processes that permit the identification of gaps that arise because of a misassigned intron, exon, or intron-exon boundary.

1. For an optimally placed gap, determine the amino acids at positions A, B, P, R, and Q.

2. Calculate the probability that these are present in a valid gap, based on their frequencies of occurrence in a dataset of verified gapped alignments. If the likelihood of these amino acids being at these positions is more than a factor of ten below that expected by random selection of amino acids based on the database composition as a whole, then the hypothesis is generated that the indel is invalid.

3. Estimate the extent of sequence divergence in the gapped portion of the multiple sequence alignment, relative to the divergence in non-gapped regions. If the sequence divergence is within one standard deviation of that observed in a dataset of verified gapped alignments, then the hypothesis is that the indel is valid. If the sequence divergence relative to the sequence divergence in the non-gapped regions is more than one standard deviation lower than that observed in a dataset of verified gapped alignments, then the hypothesis is generated that the indel is valid.

5. Place the hypothetical indel event on the evolutionary tree. Look to see whether the associated amino acid replacements characteristic of a valid insertion and deletion (“shuddering”). In general, it is expected that when a true insertion/deletion event has occurred, a protein diverging under functional constraints will need to suffer several amino acid replacements to accommodate this indel. Should these not be seen, on a tree that places indel events along specific branches, then the gapping event should be suspected to be incorrect.

One of ordinary skill in the art can recognize from this disclosure that it is useful to actually place insertion and deletion events (indels) that lead to gaps on specific branches within the tree. This permits us to examine the amino acid replacements that have occurred near in time when an indel has occurred. When a true indel has occurred, the rest of the sequence shudders; episodes of rapid sequence evolution occur to enable the protein to survive the surgery. Thus, true indels can be distinguished from “indels” that are misassigned because of a failure to correctly find an intron (or failure to correctly assign an intron-exon boundary), as the latter are not associated with this shuddering.

To assign indel events to branches on a tree, one begins by finding subtrees that comprise families that can be aligned without any gaps in the multiple sequence alignment. These have divergently evolved without any indel events. Inter-subfamily evolution, by definition, then requires an indel event (otherwise, the two subfamilies would be one). Two ancestral sequences are reconstructed for two subfamilies that are neighbors in the tree. and .these are aligned. The pairwise alignment must have one or more gap. Then, the ancestral sequence for a third subfamily, the outgroup for the first two, is matched against the pairwise alignment. Gapped regions in both the outgroup and one of the neighbor subfamilies are (by a rule of parsimony) gapped in the ancestor of the neighbor subfamilies. Ungapped regions in both the outgroup and one of the neighbor subfamilies are (by a rule of parsimony) not gapped in the ancestor of the neighbor subfamilies, and a sequence must be reconstructed in that region. Ambiguities are retained, and the process is repeated, first around the tree until all neighbor groups are considered, and then up the tree, assigning indels to branches deeper within the tree.

Measure Compensatory Covariation Signal for Different Trees, to Identify the Preferred Tree.

It appears as if the signal from charge compensatory covariation in particular, but other kinds of covariation in general, is greater when it is sought via a node-node comparison from reconstructed ancestral sequences at nodes in a tree, rather than leaf-leaf comparison. The compensatory covariation signal, extracted from reconstructed ancestral sequences, provides a metric for the quality of a tree based on organic chemistry, and independent of any mathematical model for evolution. Hypothetically, the best tree should be the tree that places compensatory replacements that are truly driven by natural selection on the same branch. This requires the construction of a tree that reflects the actual evolutionary history. This, in turn, implies that the tree showing the most true compensatory covariation is the tree that is most likely to reflect the actual historical past.

To exploit compensatory covariation in a process that selects the preferred tree from a set of similar trees, one seeks the tree that maximizes the extent of charge compensatory replacement at multiple sites.

This seeks a property of the ancestral sequences that is independent of the mathematical formalism used to reconstruct them. Even if it is small, the compensatory covariation signal can useful as a metric for this application. As evolutionary tools come to underlie most analysis of genome sequence databases, and as this analysis becomes important to extracting biomedically useful information from genome databases, such a metric will likely be very useful.

The last is especially useful. When protein sequences divergently evolve under functional constraints, some individual amino acid replacements that reverse the charge (lysine to aspartate, for example) may be compensated by a replacement at a second position that reverses the charge in the opposite direction (glutamate to arginine, for example). When these side chains are near in space (proximal), such double replacements might be driven by natural selection, if either individually is selectively disadvantageous, but both together restore fully the ability of the protein to contribute to fitness (are together “neutral”).

This type of behavior is called compensatory substitution. It represents a higher order behavior of protein sequences that is not captured by the Standard Model. Some time ago, we noted that a modest signal could be obtained by searching for compensatory changes on branches of trees that lie between two nodes. The signal is most evident when a crystal structure is available, as it can be determined whether the amino acids that are suffering complementary replacement at the same time are actually close in space.

The strength of the compensatory covariation signal undoubtedly depends on the degree to which the trees and the reconstructed ancestral sequences accurately reflect the history of the family. If the branching of the tree or the reconstructed sequences themselves are not correct, a pair of charge compensatory replacements that are coincident, in fact, may not be assigned to the same branch of a tree. In this case, the signal from this pair will be lost.

Getting the branching correct in an evolutionary tree is a difficult problem. Part of the difficulty arises because of the trade-off between the accuracy of the tree and the cost of generating it. For example, the ClustalW [Tho94] and Fitch parsimony tools are relatively inexpensive methods for reconstructing trees and ancestral sequences. ClustalW uses a neighbor joining tool based on estimates of the distances between sequence pairs derived from the Kimura empirical formula [Kim83]. Ancestral sequences reconstructed by parsimony are well known to be sensitive to incorrect branching topology. This may be the principal error associated with the choice of this inexpensive reconstruction tool.

Even more expensive tools do not guarantee a correct tree, of course. In practice, the approximations made in the model may create systematic error larger than fluctuation error. To date, the only way to benchmark a tree requires knowledge of the evolutionary history of the sequences in question [Hil94] or a reconstruction of a simulated evolutionary process [Tak00]. The first is difficult to get for sequences emerging from natural history. The second requires a mathematical model for evolution, which is often the same one that is used to construct the tree in the first place.

Here, the compensatory covariation signal, extracted from reconstructed ancestral sequences, may provide a metric for the quality of a tree based on organic chemistry, independent of any mathematical model for evolution. Hypothetically, the best tree should be the tree that places compensatory replacements truly driven by natural selection on the same branch. This requires the construction of a tree that reflects the actual evolutionary history. This, in turn, implies that the tree has the most compensatory covariation is the tree that is most likely to reflect the actual history.

To illustrate this application, consider four hypothetical proteins, just 4 amino acids in length, having the sequences ALKD, MVKD, ALER, and MVER. Exactly two topologies exist for unrooted trees that relate these four sequences (Drawing 10). Both reconstructions have two ambiguous sites in both ancestors. In Topology I, the first two positions are ambiguous; in Topology II, the last two positions are ambiguous. Both trees require four “homoplastic” events (independent mutations that cause sequence convergence). Both trees require exactly six changes. Classical parsimony therefore ranks these two topologies as equally likely.

The two topologies are different, however, with respect to the extent to which charge changes are compensated. In Topology I, a charge altering replacement is 100% likely to be compensated. In Topology II, however, a charge altering replacement is only 50% likely to be compensated. This is illustrated in Drawing 10 by writing out four trees, each equally likely, that carry reconstructions that the ambiguities require. If we postulate that compensatory covariation is maximized, then Topology I is preferred over Topology II.

Conversely, an analogous logic can be used to assign preferred ancestral states involving charged residues. For the tree on the left, the ancestral states involving charged residues are fixed. For the tree on the right, the preferred ancestral sequences are in reconstructions IIa and IIb.

This metric can be applied even if no crystal structure is available for a protein family. If, however, a crystal structure is available, then (as a practical matter) one would maximize the number of charge compensatory changes that are physically near in space when identifying the preferred tree.

This approach is the first to identify the correct tree by seeking a physical organic property of the molecular evolution. Again, a statistician will find no numerical metric to assess the approach's reliability. This is chemical science, not mathematics. Nevertheless, the tool is useful, if only because it generates a preference for one tree as a hypothesis.

This generates Deliverable i′, a first pass rectified evolutionary model for family i of homologous proteins. One of ordinary skill in the art recognizes that rectification is not needed for Deliverable i to have both novelty and utility. There are, however, only a limited number of protein families in the biosphere. These will all be identified before the end of the current century (barring catastrophes). From then on, there will be nothing but time to improve and improve the models using better and better computational tools. As the models come more and more to reflect the historical past with higher and higher certainty, their value will improve. The database of the instant invention is the context within which this will happen.

Add Value to the Preferred Evolutionary Model

We are now prepared to add value to the preferred evolutionary model. Table 5 summarizes the process, as is illustrated above.

TABLE 5
Adding value to the evolutionary model

| 1. | Adding value to the preferred evolutionary model | |
|---|---|---|
| 1.1 | Add a root to the tree for the family | |
| | 1.1.1 | Find a distant homolog or family; place root using the best |
| | | bridging homolog or family of homologs as an outgroup. |
| | 1.1.2 | Using ƒ₂ analysis to place the root at a point, or at a region. |
| 1.2 | Reconstruct the history of insertion and deletion on the preferred tree | |
| 1.3 | Place dates on tree | |
| | 1.3.1 | Using leaf taxa, assuming orthologs, use paleontological |
| | | record to estimate dates |
| | 1.3.2 | Using ƒ₂ values to confirm ortholog placement |
| | 1.3.3 | Using lineage history, convert ƒ₂ values to TREx kt distances, |
| | | and place dates computationally |
| 1.4 | Assign Kₐ/Kₛ values to branches in the tree | |
| | 1.4.1 | Using prior art processes |
| | 1.4.2. | Using ƒ₂ values in place of Ks |
| | 1.4.3 | Determine the average Kₐ/Kₛ value for the average branch; |
| | | use this to normalize the Kₐ/Kₛ values using the formula |
| | | K/Kₙₒᵣₘₐₗ = {Kₐ/Kₛ}_{for the branch}/{Kₐ/Kₛ}for the average branch |
| 1.5 | Calculate alpha parameters for gamma models | |
| | 1.5.1 | For the entire tree |
| | 1.5.2 | For each subfamily in the tree with 10 or more sequences. |

| | |
|---|---|
| 1.6 | Archive changes at the nucleotide and peptide levels, including |
| | fractional changes, to branches in the tree. These are calculated in the |
| | course of building the evolutionary model; they may be stored, |
| | or recomputed. |
| 1.7 | Incorporate crystallographic information (if a crystal structure is |
| | available; see below) |

As the ordinary practitioner of the art will recognize, not all of these are necessary for all of utility or novelty of the model. Thus, the Deliverable j is an enhanced evolutionary model for each family j that incorporates some, but not all, of these improvements. One can imagine a database of such Deliverables that incorporate only some of these delivered to users having particular applications in mind.

The tree must have particular features for it to be optimally useful. In particular, to calculate a meaningful average Kₐ/Kₛ ratio, at least two branches in addition to the one being examined must represent ancestral or contemporary sequences where the silent sites have not equilibrated. There are several ways of doing this for a single branch. For example, one may require that the time between an extant sequence, one from an organism that presently exists in the biosphere, one from an organism living in the modern biosphere (defined here to include today back 100 years) and the first branch be less than the time required for equilibration. The time required for equilibration can be estimated from the rate constant k for transitions along the lineage. If the time to the nearest branch is less than one half life, which is another way of saying if kt is less than 7 (In 2≈0.7), then the silent transitions will certainly not have equilibrated, even if the comparison involves relatively few (25-50) characters. This is equivalent to saying that the leaf-leaf TREx distance kt is less than 1.4 (two half lives, one half life from the ancestor to one leaf, the other half life from the ancestor to the other leaf). Being extremely conservative, we may require the branch to meet this stringent condition before we incorporate it into any analysis that is based on silent substitutions.

In the presently preferred embodiment where the number of characters that have transition redundant exchange possibilities is greater than 50, equilibration will not erode the signal, even after three half lives (kt≈2.1). If the number of characters that have transition redundant exchange possibilities is greater than 100, useful signal can be obtained after four half lives from transitions. As the transition rate constant is (wherever it has been examined so far) always larger than the transversion rate constant, this will essentially guarantee that the transversion sites will also not have equilibrated. This, in turn, will guarantee that the Ka/Ks ratio will be meaningful.

To construct an average, one needs at least two branches where the silent sites have not equilibrated, of course. A meaningful average requires more, preferably at feast five, more preferably at least 10, branches where the values being averaged are based on silent substitutions that have not equilibrated.

It is interesting to note that the Ka/Ks ratio appears to have value, even though equilibration must have occurred. For example, in different eubacterial taxa, citrate synthase has diverged in some cases to give a methylcitrate synthase. Interestingly, the lineage leading to methylcitrate synthase is associated with a higher Ka/Ks value than the average of the lineages leading to citrate synthases, which was presumably the ancestral reactivity. This is so, despite the fact that assumptions behind the calculation of the value, including time-invariant codon bias, almost certainly do not hold.

There are limitations that constrain the structure of an evolutionary model that arise from the structure of the natural biosphere. The number of speciation events may be insufficient to articulate a tree over a period of time judged relative to the silent site drift rate to permit reliable reconstructions of ancestral states. Extinction may have erased part of the record, placing a limit on the number of derived sequences that can today be found in the biosphere to increase the articulation of a tree. While future discoveries are difficult to anticipate, it is not clear that sufficient sequences have survived in the contemporary biosphere to support the reconstructions that would be needed to apply the Kₐ/Kₛ metric, for example, back to the divergence of the three primary kingdoms of life (archaebacteria, eubacteria, and eukaryotes), for example.

Databases of Improved Families

Based on this disclosure, one of ordinary skill in the art recognizes several additional types of databases that would be useful. The first is a database of pairs of paralogs ordered by date of divergence. This database is based on a single genome. Each of its records contains, minimally, a pointer to the sequence of paralog A in a genome, a pointer to the sequence of paralog B in the same genome, and a TREx distance (or any of the f₂ values that give rise to a TREx kt distance). For a better stand-alone database, the records might contain the sequences themselves, protein or DNA or both, the alignment used to calculate the TREx distance, and/or cultural annotation associated with the pair. This database would be the raw material for searching for paralogs that are functionally linked in a genome. Given one paralog pair, one would search for another paralog pair separated by the same TREx distance. The similarities in TREx distances suggests that the duplication that led to the first pair of paralogs occurred near the same time as the duplication that led to the second pair of paralogs.

A more advanced form of this database would cluster the pairs in f₂ or TREx windows. The windows could be overlapping. This would constitute a precomputed set of hypotheses for functional interactions within a genome. A histogram constructed from this clustering is shown in Drawing 5, which also shows its utility in identifying pathways. The approximately contemporaneous duplication events at ƒ₂≈0.82 generate several pairs of functionally significant matchings between sequence pairs. Examination of the cultural annotation for these shows that the temporal correlation of these events does indeed yield a pathway.

A second type of database begins with an improvement over the single family database that was common in the art, as improved by adding information from ancestral sequences, as disclosed in Ser. No. 08/914,375. Here, one seeks a database that captures an evolutionary model that will be useful as a context for applying metrics based on transitions at silent sites. The equations above offers a useful measure of when the model is so. Specifically, if the family has a number (at least five is presently preferred) pairs of extant sequences where the product of the time separating the two sequences and the transition rate constant at silent sites is less than 1.4 and greater than 0.4, it has a number of pairs where the TREx date is most accurate: near one half life. Having a number of these permits an average to be calculated (when normalizing a Kₐ/Kₛ ratio, for example), or permits the search for orthologs that can be used to obtain rate constants. This ensures practical application of metrics involving transitions. Conversely, a model for a single protein family that has at least two subfamilies containing 10 or more sequences has special utility, especially if the pairwise relationship between sequences is in each subfamily is between ca. 10 and 120 PAM units, as this is a family where one can conveniently detect changing patterns of amino acid replacement, changing rates of amino acid replacement at specific sites (the non-stationary gamma model), or differential patterns of homoplasy. These are all applicable to detecting changing functional behavior.

One of ordinary skill in the art can further appreciate how the model can be improved to increase its utility. For example, different methods can be used to construct the tree in the model, using TREx distances or parsimony based on silent substitutions in regions where they are most suitable (that is, over times that correspond to the half lives of the exchange reaction), PAM distances or amino acid maximum parsimonyaikelihood tools in regions where these are most suitable, and even gapping patterns as a coarse approach to get the overall topology of the tree. These composite trees are made by putting together many of these methods within one tree.

Other improvements that provide utility rectify the multiple sequence alignment to identify misplaced introns by searching for shuddering around indel events placed on trees, or where a root is placed on a tree, or a region of the tree containing the root is defined, using TREx distances.

But in the future, perhaps the most useful enhancement of the tree and the multiple sequence alignment will be one that involves incorporating lineage specific information. This is especially true when placing dates on the tree, correlating the tree with paleontology and geology, or attempting to correlate events on one tree in one genome with events on another tree involving another genome. The more that information is used about transition rate constants during specific episodes in the evolution of specific lineages, the more accurate time correlation will be.

One of ordinary skill in the art will appreciate the utility of a naturally organized genome sequence database that has many families within it that have these improvements. A database of families have the features listed above make the individual models useful, for detecting functional change or identifying amino acid sites important for that change, or that make temporal correlation between individual models possible.

Fundamentally, this is a database of evolutionary families that contains features selected from the list below. Each of these confers novelty to the database. The database can cover the entire genome database, or some part of it. The database is structured as described below. As is evident to those skilled in the art, not all of the components listed below must be present in a database for it to have utility or novelty. In particular, some of the components are important for some interpretive heuristics, and not for others.

A set of trees and multiple sequence alignments, with the corresponding DNA sequences, aligned to be consistent with a protein sequence alignment, wherein

1. TREx kt values are placed on branches of the tree.

2. Nucleotide and amino acid changes, including fractional changes, are assigned to branches of the tree.

3. Kₐ/Kₛ-type values are placed on branches of the tree, wherein said values are:

3.1 Normalized using the average Kₐ/Kₛ value for the tree in branches where silent equilibration has not occurred

3.2 Recalculated using an f₂ value.

4. A root is placed on the tree using either:

4.1 The best putative bridge to an outgroup or a family that serves as an outgroup or

4.2 As a point or a region calculated using the TREx process.

5. Geological date estimates are placed on nodes of the tree using either:

5.1 Paleontological data, once the ortholog-paralog relationship of the sequences is corroborated, or

5.2 Using the TREx process that assumes time-invariant codon biases and transition rate constants.

6. Identification of subtrees that have:

6.1 Stationary gamma models or

6.2 High degree of homoplasy

7. Identification of branches that join subtrees that have

7.1 Different gamma models or

7.2 Different sites displaying homoplasy

8. Add structural biology (see below)

The leaves are identified by the sequences themselves, the corresponding encoding DNA sequences, non-coding DNA sequences in the environment (introns, 3′- and 5′-untranslated regions), citations to the literature, and any of a number of index numbers

One of ordinary skill in the art can recognize from this disclosure that the list above simply lists the minimal additions to a naturally organized database that are needed to confer novelty to the database. The list does not represent all of the additions that can be made by one of ordinary skill in the art, after reading this disclosure. For example, as lineage-specific information is collected, it will be possible to add to Item 5 TREx dating that captures time-variance in either codon bias or transition rate constant, as disclosed above. As a broader historical view of the 12 rate constants for nucleotide substitution becomes available, it should be possible to generate analogous clocks using four fold redundant coding systems, and incorporate transversions into the model.

Adding Structural Biology

Proteins are organic molecules. Therefore, the three concepts of structure (constitution, configuration, and conformation) that apply to all organic molecules apply to proteins as well. Many of the interpretive proteomics tools that we use involve manipulation of those strings as strings. Therefore, interpretive proteomics tools that incorporate conformational analysis add a new “dimension” to the analysis. The process of the instant invention for doing so is summarized in Table 6.

TABLE 6
Correlating three dimensional conformational information

| 1 | Obtain a three dimensional representation of the protein | |
|---|---|---|
| | 1.1 | If there is a single member of the family whose crystal structure has been solved, |
| | | download it |
| | 1.2 | If there are multiple members of the family whose crystal structure has been |
| | | solved, download these |
| | 1.3 | If there is no member of the family who has a crystal structure, seek a structure in |
| | | another family using the bridges to outgroup or outgroup families |
| 2 | Rectify the evolutionary model based on the crystallographic information | |
| | 2.1 | Establish a preferred gapping |
| | 2.2 | Use crystallographic information to identify errors (intron/exon, start/stop) |
| 3 | Build a correlation between the MSA numbering and the crystal structure numbering | |
| | 2.1 | Do an alignment of the Founder Sequence with the sequence of the protein |
| | | whose structure is being used |
| | 2.2 | Build a complete coordinate representation, up to the C-beta atoms, based on this |
| | | superimposition |
| | 2.3 | (For the long term future) Refine the model using homology modeling packages |
| 3 | Display on the graphic residues with special evolutionary properties, for example: Get | |
| | the AA report that tells you what amino acids and what nucleotides are changing along | |
| | individual branches of the tree, for example: | |
| | 3.1 | Display based on its sampling of the 20 amino acids (a profile) |
| | 3.2 | Display based on the mutability of the position across the tree |
| | 3.3 | Display positions that have non-stationary patterns of mutability across the tree |
| | 3.4 | Display positions that have “accelerated evolution” |
| | 3.5 | Display positions that have a homoplasy history, locally and globally |
| | 3.6 | Display positions that suffer mutation on branches with high Ka/Ks |
| | 3.7 | Display positions that suffer mutation on branches with low homoplasy |

One of ordinary skill in the art will see that this analysis goes beyond that found in the prior art. Most closely related to the instant invention is work on evolutionary trace analysis, by Lichtarge, Cohen, and their coworkers [Lic96]. These workers only looked at the conservation of residues, or variability of residues, without incorporating into their process the rich variation in meaning that conservation and variation might have.

A process that captures this meaning through a graphics display that can be used by normal scientists begins with a computer graphics system that accepts coordinates of atoms in the protein molecule and displays a representation of these on a screen (or other medium). Independently, one obtains a model for the evolutionary history for a family of homologs of said protein molecule, wherein the model has a multiple alignment of the sequences of a plurality of the proteins within the family, an evolutionary tree modeling the evolutionary relationship of said sequences, and (in general) a multiple sequence alignment for the DNA sequences that encode said sequences,

One then improves the model using various of the processes of the instant invention. Especially useful is reconstructing models for ancestral sequences at two or more nodes of the tree, and assigning replacements in the amino acid sequence, including fractional replacements, to branches in said tree. One then examines the evolutionary model for sites whose evolution is interesting, using any of the methods disclosed here, or those known in the art. For example, one can use the evolutionary model to identify sites in the protein sequences whose evolutionary history is indicative of change in function, and highlight these. These might be sites where amino acids are replaced in a branch with a high Kₐ/Kₛ value. One might remove from the highlight sites that suffer replacements in branches with a low Kₐ/Kₛ value, as these are likely to be neutrally drifting. One might highlight sites whose patterns and/or frequencies of replacement are different in different subfamilies of the tree. One might highlight sites suffering changes along the branch that reverse hydrophilicity/hydrophobicity. One might highlight sites that display compensatory covariation along a branch in the tree. One might highlight sites that display homoplasy. In each

In all cases, the goal of the user of this graphics display system is to see whether the distribution of the highlighted sites on the folded structure is suggestive of functional change or, more preferably, specific functional change. If mutable sites cluster on the surface of the protein, this suggests the hypothesis that the surface region makes a special contact. This is an improvement over the [Ben89] approach, as ancestral sequences are used.

Functional Analysis within a Family

Single family analysis has several goals, including but not limited to the following:

1. Predict conformation. This is covered by the processes disclosed in Ser. No. 07/857,224.

2. To establish true orthology and paralogy. This is done using ƒ₂ analysis for the regions where the silent sites have not equilibrated, and is described above.

3. Identify episodes of functional change and functional stasis.

The last is the topic of this part of the disclosure, which is summarized in Table 7 below, which also contains remarks concerning the novelty of the approach.

TABLE 7
A summary of methods to analyze change and stasis in functional behavior

| I. | Methods that detect change in functional behavior along a branch | |
|---|---|---|
| | A. | High rates of amino acid replacement per unit time along a branch |
| | B. | High Kₐ/Kₛ ratios along a specific branch of an evolutionary tree; this is novel |
| | | when the Kₐ/Kₛ value is normalized to reflect the average Kₐ/Kₛ value on the |
| | | average branch of that tree, or converted into a Kₐ/Kₛ-type value using TREx-like |
| | | processes. |
| | C. | Non-stationary gamma models in subfamilies connected by a branch. |
| | D. | Low amounts of compensatory covariation |
| | E. | Low amounts of homoplasy across the branch |
| | F. | Replacements that require multiple nucleotide substitutions within a single codon |
| II. | Methods that indicate conservation of functional behavior along a branch | |
| | A. | Compensatory changes |
| | B. | Homoplasy across the branch |
| | C. | Low rates of amino acid replacement per unit time along a branch |
| | D. | Low Kₐ/Kₛ ratios along a specific branch of an evolutionary tree; novel when |
| | | Kₐ/Kₛ value is normalized, or converted into a Kₐ/Kₛ-type value using TREx-like |
| | | processes. |
| III. | Methods that identify individual sites involved in changes in functionally significant | |
| | behavior. | |
| | A. | Sites suffering replacement along branches with high rates of replacement |
| | B. | Sites suffering replacement in episodes with high Kₐ/Kₛ values, minus sites |
| | | changing in episodes with low Kₐ/Kₛ values |
| | C. | Sites associated with non-stationary gamma behavior; |
| | D. | Sites suffer repeated replacement |
| | F. | Replacements on the surface of the folded protein clustered in space and time |
| | G. | Sites suffer replacement that are near an active site, or in another region where |
| | | analysis of a crystal structure suggests that the replacement is near a functional |
| | | site; |
| I. | Multiple sites suffer replacement, where the distribution of replacement is not random | |
| | with respect to the disposition of residues occupying those sites in three dimensional | |
| | space, but are clustered nearby in three dimensional space; | |
| IV. | Methods that identify individual sites involved in conserved of functionally significant | |
| | behavior | |
| | A. | Sites pairs suffering compensatory changes; |
| | B. | Sites displaying homoplasy |
| | C. | Sites that do suffer replacement are scattered on the fold, generally on the surface, |
| | | as a character expected of neutral drift |
| V. | | Methods that involve correlation between the evolutionary histories |
| | | of two families of proteins. |
| | A. | Correlating the topology of evolutionary trees in two families of proteins. This is |
| | | approximately what is suggested in the prior art. |
| | B. | Correlating the relative dates of events in two protein families, including |

| | |
|---|---|
| 1. | Duplication |
| 2. | Episodes having high Kₐ/Kₛ values (this is the invention of Serial No. |
| | 08/914,375) |
| | i. When the Kₐ/Kₛ values are normalized |
| | i When they are Kₐ/Kₛ-type values calculated using the TREx process |
| 3. | Episodes where the gamma model changes |
| 4. | Episodes where sites displaying homoplasy change |

| | |
|---|---|
| C. | Correlating absolute dates of events in two protein families, including |

| | |
|---|---|
| 1. | Duplication |
| 2. | Episodes having high Kₐ/Kₛ values (the invention of Serial No. |
| | 08/914,375) |
| | i. When the Kₐ/Kₛ values are normalized |
| | ii. When they are Kₐ/Kₛ-type values calculated using the TREx process |
| 3. | Episodes where the gamma model changes |
| 4. | Episodes where sites displaying homoplasy change |

| VI. | Methods that involve correlation between the evolutionary history of a | |
|---|---|---|
| | family of proteins and the evolutionary history of the organism | |
| | as known from some source other than genomic sequence data, | |
| | including paleontology, geology, ecology, ontogeny, phylogeny, | |
| | or systematics (collectively known as the “non-genomic record”). | |
| | A. | Correlating dates in molecular evolution with dates in the paleontological, |
| | | physiological, and geological records, when: |
| | | 1. Absolute dates are estimated using the TREx model |
| | | 2. Events in the molecular record are not simply gene gain or loss, duplication, or |
| | | high Kₐ/Kₛ values (this is in the art many times, for example [Jer95], but also |
| | | includes other analyses |
| | B. | Correlating the topology of an evolutionary trees and the non-genomic record |
| | C. | Correlating features of patterns of evolution in specific branches in the |
| | | evolutionary tree with the non-genomic record |
| | D. | Correlating evolutionary events in several protein families occurring at |
| | | approximately the same time with the non-genomic records. |

We now elaborate on processes for analyzing function, its change and its conservation, within a protein family, from the evolutionary models described above. In this process, we will state our current understanding of the prior art, and indicate what we believe to be novel. One of ordinary skill in the art will appreciate from this disclosure that the most powerful tools come from combinations of the tools disclosed below. These have utility that is unexpected from the prior art.

I. Methods that Detect Change in Functional Behavior Along a Branch

A. High Rates of Amino Acid Replacement Per Unit Time Along a Branch.

The Kₐ/Kₛ and related metrics as tools for identifying branches within an evolutionary tree uses silent substitutions as a metric for time. This, in turn, requires that both terms used to calculate the Kₛ metric captures time accurately. The numerator of the term is a metric of silent substitutions that combines both transitions and transversions. As noted previously in this disclosure, these processes have different rate constants in many lineages. Further, the calculation of silent sites, which forms the denominator of the metric, was designed to capture as many silent sites as possible. This creates an undesirable heterogeneity in the metric.

One way to avoid the problem associated with failure of the assumptions that stand behind the Kₐ/Kₛ ratio is to define and interpret absolute rates of change in sequence, the number of amino acid replacements per unit time. This requires that dates be assigned to nodes in an evolutionary tree. This can be done by correlation with the paleontological record, as is disclosed above. In addition, we can use the TREx distances as a metric. The latter, of course, simply reflects the use of narrower definitions for synonymous substitutions and synonymous sites than those captured in the Kₐ and Kₛ terms of the prior art metric.

As originally proposed, a certain rate of protein sequence change might be expected purely from neutral drift. This might accumulate with approximately clock-like behavior, where amino acid replacements accumulate with a time-invariant rate constant, number of replacements per site per unit time. If this were true, then an episode of sequence divergence that contains more numerous replacements than expected for the time elapsed would be one that holds a functional change.

This would seem to be obvious, but does not appear to be part of the prior art. This is perhaps because tools were not available to calculate time. With the use of TREx dates, and more detailed paleontological record, this becomes possible.

When repeated replacements occur at a single site, this may be viewed as evidence that the site is not under any functional constraint, or as an indicator that this site is responding to repeatedly changing functional demands. The latter appears to be the case for the work by Bush, Fitch and their colleagues [Bus99], which predict which replacements in an influenza protein will be fixed in the future in the population.

The process of Bush et al. works well when a very highly articulated tree is available. When the PAM distance along a typical branch is longer than 5 PAM, for example, this becomes more difficult. An alternative approach seeks amino acid replacements that require two or three nucleotide substitutions (for example, a Pro to Gly replacement requires two). This indicates a particular functional constraint. In this example, the intermediate Arg (CGN) or Ala (GCN) is presumably not “fit”, or they would appear in the database. This approach is applicable only if the tree has reasonable level of articulation (branch lengths on the order of 10-20 PAM); with increasing PAM distances, it is increasingly likely that the intermediate is not seen in the current database not because it was not there, but because a modern sequence capturing it is not represented in the database.

B. High Ratios of Silent to Non-Silent Substitution Along Specific Branches of an Evolutionary Tree Including Methods that Address Weaknesses in the Ka/Ks Ratio.

We have noted above reasons why Kₐ/Kₛ values are easily interpretable. Even when the function of a protein is changing, some residues (such as those holding together the fold) cannot change without destroying the ability of the protein to serve as a scaffold for function. Thus, the Kₐ/Kₛ value for specific sites can be very high during an episode of divergent evolution, perhaps even much higher than unity. But because Kₐ/Kₛ values are calculated for the sequence as a whole, the sites undergoing rapid substitution are counted with “core” sites undergoing slow substitution, giving a Kₐ/Kₛ value for the protein as a whole of less than unity.

Likewise, if the evolutionary tree is poorly articulated, a single branch may contain both adaptive and conservative episodes of evolution. In this case, the high Kₐ/Kₛ value for the adaptive episode may be diluted by a low Kₐ/Kₛ value for the conservative episode. The second problem will, of course, subside as more and more genome sequence projects are completed.

One solution to this problem involves normalization of the Kₐ/Kₛ values for a protein family. Here, the average Kₐ/Kₛ value for the average branch of the tree is calculated. Those branches that have a Kₐ/Kₛ value an arbitrary factor higher (the presently preferred factor is two fold higher) are then hypothesized to be undergoing a change in function, even if this Kₐ/Kₛ value is less than unity. More preferably, a statistical analysis is performed where the number of sites undergoing changes is determined for each branch length, the average Kₐ/Kₛ value is calculated, a statistical model is constructed to assess the distribution of Kₐ/Kₛ values on different branches of the tree, and branches that have Kₐ/Kₛ values lying more than two standard deviations above the mean are hypothesized to contain a change in function

The simple Kₐ/Kₛ ratio is not considered to be inventive in light of the prior art, as it was disclosed by Li in 1985. The Kₐ/Kₛ ratio between ancestral sequences was considered to be inventive in light of the prior art, in particular, the publication by Pamilo and Bianchi [Pam93] and Messier et al. [Mes97]. But the use of a normalized Kₐ/Kₛ ratio, where the normalization is based on an analysis of branches in the family overall is novel.

Further, as discussed below, whole genome and whole database analysis can reconstruct the history of codon bias within a lineage. This history can be used to correct for errors introduced into the Kₐ/Kₛ ratio by changing codon bias. This too is novel.

Further, an understanding of the significance of Kₐ/Kₛ values can be had by interpreting these in the context of other measures of adaptive change and functional stasis. For example, if a branch with a questionable Kₐ/Kₛ corresponds as well to a branch where the gamma model undergoes a sub-significant change in its alpha parameter, then these two weak indicators of functional change can be used to make a combined prediction of functional change along the branch. Further, if a branch with a sub-significant Kₐ/Kₛ corresponds as well to a branch where homoplasy observed in a subtree beneath the branch is no longer observed, then these two weak indicators of functional change can be used to make a combined prediction of functional change along the branch. Each of these are novel.

It is worth noting how this process of combining tools differs from that published by Messier et al., and disclosed in Messier's patent [Mes01]. In the patent, Messier attempted to accommodate the problem that evolutionarily significant change in function might be characterized by Ka/Ks values lower than unity. Here, they simply accepted Ka/Ks values as low as 0.75 as possible indicators of evolutionarily significant change in function as well. Here, we propose a rational process to judge when this lower value for the Kₐ/Kₛ ratio should be accepted as an indicator of evolutionarily significant change in function. In this process, one determines for the branch with a sub-unity value of Ka/Ks whether it is a branch across which the patterns of mutability change, or it is a branch with low compensatory covariation, or whether it is a branch set within a larger subfamily that does not display homoplasy. If any of these statements is true, then the sub-unity value of Kₐ/Kₛ is accepted as an indicator of evolutionarily significant change in function.

If a three dimensional model of a member of the protein family is available, further processes can be followed to assess the utility of using a sub-unity value for Kₐ/Kₛ as an indicator of evolutionarily significant change in function. Inspection of the position of the sites suffering amino acid replacement in the three dimensional crystal structure of a protein during an episode assigned a high Kₐ/Kₛ ratio can be used to infer whether the Kₐ/Kₛ ratio is significant. One expects residues changing during an episode of high Kₐ/Kₛ not to be randomly distributed over the three dimensional structure, but rather to be rationalizable in their placement. Therefore, an alternative process for interpreting a Kₐ/Kₛ value that is below unity is to map on a three dimensional structure the sites that suffer replacement during the episode with the sub-unity Kₐ/Kₛ value in question.

Further, the Kₐ/Kₛ ratio can be used to infer which of two duplicates is associated with which. In general, following gene duplication, one expects at least one of the derived sequences to have a changed function. Thus, one expects at least one of the branches to have a high Kₐ/Kₛ ratio. Here, normalized Kₐ/Kₛ ratios are useful. The duplicate that is changing the most is the one with the higher of the two, even if the Kₐ/Kₛ ratio is sub-unity.

This is illustrated in the example with the JAK-STAT family. Here, in the mouse-rat lineage, a JAK gene suffered duplication following the divergence of mouse and rat. So did a STAT sequence. The contemporary duplication based on taxa dating is confirmed using the TREx tool. Further, one of the two branches following the duplication in both families has a higher Kₐ/Kₛ value than the other. This suggests, again as a hypothesis, that the JAK derived along the branch with the higher Kₐ/Kₛ value is partnered in function with the STAT derived along the branch with the higher Kₐ/Kₛ value.

In general, we expect all gene duplications to be followed by two episodes, where one of the episodes has a higher Kₐ/Kₛ value than the other, or where both episodes have a high Kₐ/Kₛ value. When one of the episodes has a higher Kₐ/Kₛ value than the other, the sequence derived from the low value branch is hypothesized to perform the primitive, ancestral function, at least by analogy, while the sequence derived from the high value branch is hypothesized to perform a new function. When both branches have a high Kₐ/Kₛ value, then both derived sequences are hypothesized to perform new functions. In cases where function change is indicated, annotation transfer, and the use of one organism as a model for another, is counterindicated, again by hypothesis.

Analogous analyses can be applied using other processes of the instant invention. When two paralogs are generated, it is conjectured that one continues to perform the primitive role, while the other evolves to perform a derived role. It is useful to try to identify which lineage in the descendent pair of lineages has the derived function:

1 The lineage with the higher rate of amino acid replacement per unit time (or higher Kₐ/Kₛ, etc.)

2 The lineage with different residues more mutable than the other lineages; this lineage holds the derived function.

3 The lineage with the lower compensatory covariation pattern in the branch immediately after duplication; this lineage holds the derived function.

C. Non-Stationary Gamma Models in Subfamilies Connected by a Branch

Functional constraints act differently on different amino acids in a protein sequence. This is the chemical reason underlying different rates of replacement at different sites in a protein sequences. This behavior is captured by what is known as the covarion model for proteins sequence evolution, a term introduced by Fitch [Tuf98]. It has long been known in the art that a model for sequence divergence that captures these different rates yields more useful distances between protein sequences than the standard model used in the art, which finds its origins in work by Dayhoff.

The covarion behavior of sequence divergence is captured by statisticians in a single parameter alpha model. This model, of course, loses most of the information that can be used to detect change in function. To detect such change, one needs to retain information about which sites are more, and which are less mutable. A change in function is then detected by non-stationarity in these, an observation that residues that are more mutable in one branch of the tree are not more mutable in another branch of a tree. One would then seek the branch in the tree around which the patterns of mutability changed, the branch that connected the two subtrees where the patterns of mutability are different.

Statisticians generally rely on statistical metrics for the changing pattern of mutability to decide whether it is large enough to conclude that “function” is changing. From a chemical perspective, it is sufficient to implement processes that examine other features. Particularly powerful is to place sites that suffer changes in mutability within a family on a crystal structure, to see if their placement makes sense.

This is a chemical analysis, one that treats the molecule and its individual sites individually. Consider a family of proteins divided into two subfamilies, SF₁ and SF₂, each with its own set of functional behaviors, where the two sets are not equal (Drawing 11). Let us also define a set of sites in each subfamily, C₁ and C₂, at which natural selection does not tolerate replacement, and a set of sites in each subfamily, V₁ and V₂, at which natural selection does tolerate replacement. Let us further assume that the differences in the sets of functional behaviors results in two inequalities: C₁≠C₂, and V₁≠V₂. This means that sites exist where replacement is not tolerated in SF₁, but is in SF₂, and where replacement is not tolerated in SF₂, but is in SF₁.

Given a sufficient articulation of the trees in the two subfamilies, the two inequalities will be apparent above fluctuation. This then provides a test for change in functional behavior independent of the test involving Kₐ/Kₛ ratios. In some senses, it is superior to the Kₐ/Kₛ ratio test. Changing specifics in the distribution of more and less replaceable sites in a protein sequence can be observed even after synonymous sites have suffered so many mutations that their occupancy has equilibrated.

Much of this process has long been known in the prior art. The first case where this tool was applied, together with a crystallographic analysis, was reported by the Inventor in 1989 [Ben89]. The alcohol dehydrogenases from yeast and mammalian livers are homologous. They perform different functions, however. In different yeasts, the enzyme has the same, narrow substrate specificity, interconverting only acetaldehyde and ethanol, and this substrate specificity has clear physiological significance, as the catalytic process that recycles NADH to regenerate NAD+ in the glycolytic pathway. One expects the amino acids lining the pocket in the enzyme where the substrate binds to be highly conserved to maintain this substrate specificity.

In contrast, the enzyme from mammalian liver plays (according to the best hypothesis) a role in the detoxification of foreign organic compounds, which themselves have varying (and not necessarily anticipatable) structures. Many mammals have paralogs of the liver alcohol dehydrogenase, having different substrate specificities. One expects that sites near the substrate binding site of mammalian ADH to be highly variable.

Benner [Ben89] presented a three dimensional crystal structure highlighting sites that were variable in mammalian ADH subfamily, but conserved in the yeast ADH subfamily. Different from subsequent art, Benner did not use reconstructed ancestral sequences, or employ a formal computation to assess mutability within a subtree. The entire substrate binding region of the active site was highlighted. This is a graphic illustration of how a three dimensional model can be used to make a compelling case that non-stationary behavior in the replacability at different sites indeed indicates change in function.

Gaucher et al. [Gau01] made another compelling case by observing non-stationary, time-variant gamma distributions in the family of elongation factors related to EF-Tu. These proteins are involved in the translation of mRNA in protein synthesis, and serve to present charged tRNA molecules to the ribosome. They are among the most highly conserved proteins on Earth, and no one suspected (from a first generation evolutionary analysis) that they would display functional diversity. Indeed, they would seem to be archetypal examples of a protein that performs the “same” function in all three kingdoms of life. If transfer of the linguistic construct describing function from one member of a protein family to another is ever secure, it would seem to be secure with elongation factors.

This study began with a statistical perplexity. The alpha parameter for the subfamily of eukaryotic elongation factors, and the alpha parameter for the subfamily of bacterial elongation factors were comparable, but not comparable to the alpha value calculated to the family as a whole. Thirty EF-Tu/EF-1α protein sequences were aligned over 380 sites using the alignment program DARWIN. Replacement rates per site for bacterial and eukaryotic EFs were estimated using a gamma-based, maximum likelihood (ML) model for protein sequences (JTT+Γ) and the phylogeny of Baldauf et al. (Baldauf et al., 1996) for EF-Tu and EF-1α. An α of 0.78 was calculated for the entire tree, with a standard deviation (SD) of 0.05 using parametric bootstrapping (evolutionary simulations) [Swo96]. The α values for the bacterial and eukaryotic subtrees were significantly different from that for the entire tree (0.46 and 0.38, respectively). These reductions in α for bacteria and eukaryotes alone are expected of a non-stationary process.

Thirty seven percent of the sites had essentially the same rate in the two groups (rate difference of ˜0), as expected under a stationary gamma process. However, 18 and 21 sites had evidently evolved>2 standard deviations faster in bacteria than eukaryotes, and vice versa, respectively. These 10% of the sites are most responsible for the covarion characteristics of EF-Tu and EF-1α.

Residues displaying abnormal evolutionary behavior were then mapped to a three dimensional model of the protein based on a crystal structure of ET-Tu. These were used to generate structural hypotheses for the different behavioral differences that were known. For example, bacterial EF-Tu binds GDP ˜100 fold tighter than GTP. Eukaryotic EF-1α, in contrast, binds both with similar affinities. EF-Tu regenerates its active form by binding to the single-subunit nucleotide exchange factor EF-Ts. EF-1α requires the multi-subunit nucleotide exchange factor EF-1βγδ. EF-1α in eukaryotes also interacts with the cytoskeleton as it moves from the nucleus to the cytoplasm. EF-Tu, in bacteria, have no nucleus to move from.

The notion of stationary covarion behavior is certainly not inventive in light of the prior art, as it was disclosed as early as 1976. Using non-stationary covarion behavior in light of an analysis of a crystal structure, is not considered to be inventive in light of the prior art in light of [Ben89]. What is innovative is to combine such analyses with other metrics for changing function, and using advanced methods to correlate episodes temporally with unusual covarion behavior. Thus, non-stationary behavior is therefore expected to correlate positively with branches that have high Kₐ/Kₛ ratios, and negatively with incidences of homoplasy. Because Kₐ/Kₛ ratios use a silent substitution clock that ticks rapidly, while covarion analysis does not, the two are somewhat complementary.

D. Low Amounts of Compensatory Covariation

The conservation of the overall fold after extensive divergences raises the possibility that amino acid substitutions at one position in a polypeptide chain might be compensated by substitutions elsewhere in a protein. For example, if a Gly at one position inside the folded protein core is replaced by a Trp, it might be necessary to substitute a Trp by a Gly at a position distant in the sequence but near in space to conserve the overall volume of the core, and therefore the overall folded structure. These assume that if a substitution is not compensated, the organism hosting the protein is less fit.

Individual examples of compensatory changes in proteins have been proposed, both by analysis of families of natural proteins with known structures ] and in proteins into which point mutations have been introduced by site-directed mutagenesis (see review in [Fuk02]. In these examples, amino acid residues distant in the sequence but near in three dimensional space in the folded structure have been observed to undergo simultaneous compensatory variation to conserve overall volume, charge, or hydrophobicity.

Compensatory covariation has been used in the prediction of the tertiary folds. For protein kinase [Ben91], for example, an antiparallel beta sheet was predicted for the core of the first domain because of two specific compensatory changes identified in consecutive strands in the predicted secondary structural model. The subsequently determined crystal structure [Kni91] showed not only that antiparallel beta sheet existed, but that the side chains of the two residues undergoing compensatory covariation were indeed in contact.

Systematic studies have suggested, however, that the compensatory covariation generates only a small signal. The early work by Lesk and Chothia with the globin family found that replacements of hydrophobic residues in the core of the protein fold are usually accommodated by small shifts of secondary structural elements rather than by size complementary amino acid substitutions (see review in [Fuk02]). More recent studies have suggested that a weak compensatory covariation signal might exist. Some authors have doubted, however, that the signal is adequate to be useful in structure prediction. Others have been more optimistic. More recently, Chelvanayagam et al. noted that the signal is improved if examples of compensatory covariation were sought within explicit evolutionary context (see review in [Fuk02]).

In the literature, compensatory changes have been sought by comparing the sequences of two extant proteins from contemporary organisms. In principle, any position where an amino acid residue had undergone substitution at any point in the time separating the two proteins via the common ancestor might be paired with any other position that had also suffered substitution in this time. Such an approach is problematic because the evolutionary time separating two contemporary protein sequences can be long; in years, it is twice the time since the most recent common ancestor of the two proteins.

A different way to detect compensatory covariation seeks specific changes in a protein sequence can be assigned to (and isolated to) specific branches of the evolutionary tree. Within the context of a reconstructed model for the historical past, compensatory covariation should appear as two substitutions occurring on the same branch of the evolutionary tree. As these branches can be rather short in length, an analysis based on a reconstructed history of a protein family can identify changes that occur nearly simultaneously. These are expected to be true indicators of compensation. In principle, a weak compensatory covariation signal observed by the comparison of extant sequences should be strengthened by examining individual episodes in divergent evolution as reflected by specific branches in the evolutionary tree.

Conversely, when functional behavior is changing, there may be no need to compensate individual replacements in a sequence. Indeed, an uncompensated change is more likely to generate a protein with different behaviors, whose (now) different behaviors contribute most to the (now different) requirements for fitness. In this view, compensatory covariation should not be observed, or should be observed less frequently, whenever functional behavior is changing.

Given this observation, compensatory substitutions are useful in functional genomics, complementing Kₐ/Kₛ values and non-stationary gamma models. Here, compensatory changes would indicate functional constancy, while uncompensated changes would indicate functional change. Because compensatory analysis rests on protein sequences, while the Kₐ/Kₛ value requires measurement of silent substitution rates, and because silent substitution rates are frequently rather high, this metric for functional recruitment may ultimately prove to be more valuable than Kₐ/Kₛ ratios. This is novel in itself, as well as in combination with other metrics.

E. Low Amounts of Homoplasy Across the Branch

One feature commonly observed in the divergent evolution but not modeled well by even advanced stochastic models is molecular homoplasy, defined as a character similarity that arose independently in different subfamilies of an evolutionary tree.

Molecular homoplasy is best illustrated by an example (Drawing 12). Homoplasy so defined is the observed phenomenon; no statement is made as to the mechanism by which homoplasy arises. It may reflect selection pressures.

At one level, homoplasy is simply the statement that selective pressures are forcing the protein to select from a subset of the 20 standard amino acids. Thus, it is similar to the bias that is seen in membrane proteins, for example (where residues are chosen more frequently from a subset of hydrophobic amino acids than in the database as a whole). Homoplasy is more. Not only (in the example) is position 30 limited to A and P, but the selection pressures have toggled between the two more than once in the module's evolutionary history.

This is, of course, a signature that a functional constraint is conserved in the distant branches of the tree protein. For this reason, molecular homoplasy is expected to be a contrarian signature to high Kₐ/Kₛ or non-stationary covarion behavior in a protein. We expect it to occur more frequently with proteins that are not undergoing functional recruitment.

The most interesting homoplasies are those that involve multiple steps. For example, the Pro/Gly homoplasy (at the codon level, CCN to GGN) requires two substitutions. Either of these alone creates a change in the encoded amino acid (CGN, Arg, or GCN, Ala). Observing examples of these without observing the intermediates anywhere else in the tree suggests that selection pressure is remarkably strong at this position, even though two amino acids appear to be nearly equally suited to perform function.

Molecular homoplasy indicates a constraint on structure that implies a constant behavior, which in turn implies a constant function. If this is true, it should correlate negatively with Kₐ/Kₛ ratios. That is, homoplasy should be found less frequently in branches separated by a branch with a high Kₐ/Kₛ ratio than in branches not separated by such a branch. Case studies developed under this project will develop ways to exploit such a correlation.

II. Methods that Indicate Conservation of Functional Behavior Along a Branch

A. Compensatory Changes

The presence of many compensatory changes is a sign of functional stasis along a branch where it is observed, and is novel as an indicator of such.

B. Homoplasy Across the Branch

The presence of much homoplasy is a sign of functional stasis within the subtree where it is observed, and is novel as an indicator of such.

C. Low Rates of Amino Acid Replacement Per Unit Time Along a Branch

Absolute conservation within a defined evolutionary distance is the converse of the rapid change outlined above as a metric for functional change. Conservation at a site, normalized for changing behavior, was used within Ser. No. 07/857,224 to identify active site residues as part of a protein structure prediction exercise. Almost anyone of ordinary skill in the art should have been able to say that a conserved amino acid residue is functionally significant. What was missing from the art in 1991 was a clear statement that this statement had meaning only if placed within a specific evolutionary context.

D. Low Ratios of Silent to Non-Silent Substitution Along Specific Branches of an Evolutionary Tree Including Methods that Address Normalization Issues

We can go another step. Residues that are conserved in one branch of a tree that has a high Kₐ/Kₛ must be involved in a core function.

III. Methods that Identify Individual Sites Involved in Changing Functionally Significant Behavior.

A. Sites Changing Along Branches With High Rates of Replacement

B. Sites Changing in Episodes with High Kₐ/Kₛ Values, Minus Sites Changing in Episodes With Low Kₐ/Kₛ Values.

We have posited that function is changing during an episode with high Kₐ/Kₛ values. As disclosed in Ser. No. 08/914,375, individual residues can be identified as changing during that episode, as the basic evolutionary model has sequences reconstructed at each individual node. These are, at the level of hypothesis, residues that are important to functional change.

As one of ordinary skill in the art recognizes, the episode also includes a number of substitutions that have no relevance to function or the change in function, but rather reflect the background, neutral drift. For example, these residues might lie on the surface of the protein, be in contact with bulk solvent, and not have any especially strong functional constraint that prevents them from diverging. As disclosed in Ser. No. 07/857,224, surface residues may neutrally drift in many sub-families within an evolutionary tree. For this reason, we can identify residues that are changing along branches of an evolutionary tree that have low Kₐ/Kₛ values, and subtract them from residues changing in episodes with high Kₐ/Kₛ values. What remains are residues more likely, again at the level of hypothesis, to be involved in the change in function.

Ser. No. 07/857,224 disclosed and claimed methods for correlating changes in sequence with changes in the behavior of the protein. This in turn provides a method for identifying behavioral changes that are relevant to the change in function. This is considered to be in the public domain based on [Ben89].

TABLE 8
Signatures of a branch having discontinuities in functional behavior

A high Kₐ/Kₛ
A Kₐ/Kₛ value higher than the norm for the rest of the protein family
A change in replaceable sites in different sub-branches joined by the
branch
Different patterns of homoplasy on different sides of the branch
Branch with abnormally low compensatory covariation, compared with
other branches in the tree
Non-random placement of mutable residues along this branch in the three
dimensional structure.

VI. Methods that Involve Correlation Between the Evolutionary History of a Family of Proteins and the Evolutionary History of the Organism as Known from Some Source Other than Genomic Sequence Data, Including Paleontology, Geology, Ecology, Ontogeny, Phylogeny, or Systematics (collectively known as the “non-genomic record”).

Perhaps the most powerful processes for developing hypotheses concerning function are those that couple information from the molecular record with information from the paleontological record. Temporal correlation is a key to these processes. Dating can be obtained either by analyzing the taxa at the leaves of a tree, set within a broader understanding of orthology in the system enabled by TREx dating, or from the TREx dates directly.

A. Correlating the Topology of an Evolutionary Tree and the Non-Genomic Record.

B. Correlating Features of Patterns of Evolution in Specific Branches in the Evolutionary Tree With the Non-Genomic Record. This is Exemplified in the Discussion Above with Yeast Alcohol Dehydrogenase.

C. Correlating Evolutionary Events in Several Protein Families Occurring at Approximately the Same Time With the Non-Genomic Record. This is Exemplified in the Discussion Above With Yeast Alcohol Dehydrogenase.

Again because the basic evolutionary model includes reconstructed ancestral intermediates, the methods of the instant invention identify specific residues that are displaying covarion behavior. These are residues that are under analogous functional constraints in different sub-families of the tree. This, in turn, implies that these particular residues contribute to a behavior that is conserved for a conserved feature of the function in distant branches of the tree.

A Combination of These.

This discussion makes evident the power of second generation tools to analyze function within a single protein family. Unanticipated, however, is the power of these when combined. In this combination, reinforcing and contradicting metrics support with varying degrees the emergence of hypotheses.

VI. Tools that Involve Correlation Between the Evolutionary History of a Family of Proteins and the Evolutionary History of the Organism as Known from Some Source Other than Genomic Sequence Data, Including Paleontology, Geology, Ecology, Ontogeny, Phylogeny, or Systematics (Collectively Known as the “Non-Genomic Record”.

A. Correlating the Topology of an Evolutionary Trees and the Non-Genomic Record.

B. Correlating Features of Patterns of Evolution in Specific Branches in the Evolutionary Tree with the Non-Genomic Record

C. Correlating Evolutionary Events in Several Protein Families Occurring at Approximately the Same Time With the Non-Genomic Record

Some of these tools were disclosed in Ser. No. 07/857,224 and Ser. No. 08/914,375. In many cases, elements of novelty and utility can be found by combining these tools. This disclosure will systematically indicate the Applicant's presently preferred combinations, with statements of where the Applicant believes that the state of the prior art requires reference to the priority dates of parent applications, where it does not.

Further, during episodes of rapid sequence evolution, amino acid substitutions will be concentrated in secondary structural elements defined by the method claimed in Ser. No. 07/857,224. These are secondary structural elements that are important in the acquisition of new function. A general method for identifying secondary structural elements that contribute to the origin of new biological function is comprised of identifying an element in the predicted secondary structure model where the corresponding section of the gene has a high ratio of expressed to silent changes.

Robustness

As noted through these disclosures, no model is guaranteed to reflect precisely the actual evolutionary history of a protein family. As Ser. No. 07/857,224 disclosed, these models are nevertheless useful. However, at the same time, we believe that the better the model captures historical reality, the more useful it is like to be. More specifically, if we know how ambiguous the model is, the practitioner can adjust his use of the model accordingly. For a tree, for example, all models will agree approximately where most branches should be placed. For a MSA, most models will agree approximately where most gaps should be placed. The practitioner would like to have information about the range of variation in the trees that is likely and might need to be considered, and determine the range of variation in the gap placement in the MSAs that is likely and might need to be considered.

For this reason, a plurality of evolutionary models constructed for a single family of protein sequences using a plurality of different tools becomes valuable. Different mathematical formalisms of divergent evolution can give somewhat different trees and multiple sequence alignments. It is conceivable that these differences will lead to differences in interpretations made by an evolutionary analysis of these models. It is therefore useful to ask how robust the interpretations are with respect to plausible variation in the formalism used to construct the model. Indeed, it is useful to ask whether the interpretation is robust even with respect to implausible variations in the formalism.

For this reason, it makes sense during a program of interpretive proteomic analysis with a family to re-compute the tree and MSA using formalisms different from those used to create the first tree and MSA. At the same time, the practitioner might consider recomputing the tree, MSA, and ancestral sequences using the most expensive formalism that the budget will allow, and then determine whether the interpretations are robust with respect to the resulting changes.

Another rectification process recognizes the possibility that the sequences themselves might contain mistakes. In particular, genes that are found by Hidden Markov Models (HMMs) misassign introns, starts, and stops within found genes, with an unknown frequency. These yield incorrect gaps in a multiple sequence alignment. Advanced gap placement tools help remove these mistakes as part of a rectification process.

Over time, the evolutionary model for a family of proteins will be rectified to remove mistakes, enhanced by statistical analysis, and refined through the introduction of non-sequence information (including paleontological information). This, over time, these families come to reflect the historical reality more accurately. The vision is captured by the analogous development of the Periodic Table a century ago. The characteristics of the chemical elements were obtained approximately for each element when it was discovered. Over time, the description of the element was enhanced, however, and more precise values were obtained. Eventually, for each element, the model converged to an endpoint.

We expect the same to occur for each family in the global biosphere. There is only one true molecular history for any individual family of proteins. As more data emerge, including sequence, paleontological, and geological, the parts of this history that can be reconstructed will be reconstructed with increasing accuracy. The parts that have been irretrievably lost will also become evident in the process. Over time, the description of the evolutionary history of each module family will converge to a stationary model, largely unaffected by the addition of sequences.

Identifying the Superfamily

As taught by Ser. No. 07/857,224, the preferred family to support interpretive proteomics is a nuclear family. The assembly of a nuclear family stops once the sequences being added fail to meet a cut-off that is selected to ensure high quality MSAs. The cut-off is, to a degree, arbitrary. Frequently, nuclear families are “bridged” to other nuclear families where the extent of sequence divergence is too great to permit a single nuclear family to be constructed from the two.

When two or more nuclear families are connected by one or more bridges, each nuclear family can be used to “root” the tree of nuclear families to which it is bridged.

Ultimately, we wish to identify superfamilies, collections of protein sequences that may share common ancestry even though the similarities in the sequences of their most distant members is insufficient to support (with an acceptable level of significance) the conclusion of homology. Today, the only reasonably validated to tool for inferring homology at this distance is by noting analogies in the conformation, or fold, of the families; this is the invention disclosed in Ser. No. 07/857,224, and its use for this purpose is claimed in Ser. No. 08/914,375. These are able to both confirm and deny distant homology, as noted in previous disclosures.

Further, analogous folds between two protein families may help align sequence motifs, sequence strings that are too short to support significantly any conclusions of homology, but might be regarded as being suggestive. Alternative tools, including mechanistic analogy (when enzymes are involved) are too susceptible to convergence to be reliable, although they can support a conclusion of homology based on weak sequence similarity and analogous conformation.

Table 9 summarizes the steps used to assemble a superfamily.

TABLE 9
Steps used to identify distant homologs

Record obvious bridges between nuclear families; these are bridges that meet test of statistical
significance
Refine the placement and sequence of the founder based on a root
Use the Founder Sequence to confirm/deny speculative bridges based on sub-statistical
sequence similarity
Use experimental secondary structures to confirm/deny speculative bridges based on sub-
statistical sequence similarity
Refine the secondary structure prediction
Use the secondary structure prediction to confirm/deny speculative bridges based on sub-
statistical sequence similarity

Bridges aid interpretive proteomics most significantly when no cultural annotation, defined as the linguistic construct that indicates function, is available for any members of the nuclear family, or for any members of the extended family linked by bridges. Failing any experimental evidence for function within the nuclear and extended families, the experimentalist is delighted if any broader homology indicators identify possible homologs that have an assigned function. This being said, it is important to note that function can change dramatically within a nuclear family, and it certainly changed within extended families. Therefore, annotation transfer between members of a superfamily may be only conjectural. Nevertheless, as disclosed in Ser. No. 08/914,375 using heat shock proteins as an example, useful inferences about function can be obtained using bridges established by structure prediction.

Correlating with Events in the Historical Past

With the useful NOD model for an evolutionary family as a starting point, and using its pre-computed Kₐ/Kₛ values, we can immediately identify segments of a tree where functional change might have occurred. This is at the level of hypothesis, which can be strong (if Kₐ/Kₛ is very significantly greater than unity), or weaker (if, for example, the case is based on the fact that the Kₐ/Kₛ for a branch is less than unity, but greater than the typical Kₐ/Kₛ branch in the protein family).

The next phase of interpretive analysis seeks temporal correlation between events recorded in the molecular database and events recorded in non-sequence databases. For this purpose, we need to extract dates for the tree. Classically, dates for nodes on trees have been assigned by noting the taxa that provided the derived sequences. We then refer to paleontological information to constrain the geological dates when the taxa might have diverged. This requires that the sequences within the family be true orthologs.

Once paleontological information is extracted, we can ask whether the molecular data are compatible with events in changing physiology at the time when the molecular changes occurred. This is easily illustrated using the leptin family of proteins. Whenever a mouse foraging, he/she is just as likely to be food as to find food. Hominoid apes, in contrast, occupy a very different position in the food chain, and have a different feeding behavior. For mice, the instinct to forage must be under tight control, with over 90% of any mouse's offspring not surviving (on average) to themselves reproduce. Foraging mice take greater risks in the autumn than in the spring, balance opportunity with cost, and the corresponding behavioral instinct must be under strong selective pressure. In contrast, hominoid apes have more opportunity to learn.

The next step in the cycle of hypothesis generation asks: What did the ancestor of hominoid apes and rodents look like? Here, we must turn to the paleontological record.

The first lesson taught to paleontologists is that no fossil corresponds to an ancestor at the node from which two taxa branch. But as the paleontological record becomes more complete, it constrains with narrower and narrower bands the date that two taxa diverged. Further, a fossil from the paleontological and historical vicinity of the taxa that represents a last common ancestor can define very well the physiology of the true ancestor.

For example, the ancestor of hominoid apes and rodents lived in the mid Cretaceous (Table 1). In this particular case, the fossil record has improved dramatically in its ability to describe the animal that was near the divergence of mouse and humans. A complete skeleton of Eomaia (“dawn mother”) is preserved as a pressing, complete with fur imprint (we know how long the animal's hair was) from the very early Cretaceous in China.

Eomaia was more similar in many features of its behavioral physiology to mouse than hominoid apes. The implication is that it was not at the top of the food chain, like mouse, but not like human. Indeed, the episodes of rapid sequence evolution that is found on the leptin tree is associated with the increase in size of hominoid apes, a change that presumably is associated with a change in position in the food chain, which led to a change in its behavioral physiology. It is, in retrospect, perhaps not surprising that a protein like leptin, presumed to be involved in managing feeding behavior, would have an episode of sequence evolution at the time.

It is important to recognize that many of these discussions do not address the details that are of hot debate among people who specialize in these questions. For example, we do not know the relative sequence in which the mammal orders containing rodents (Rodentia), rabbits (Lagomorpha) and humans (Primata) diverged. The issue has been contentious in the past, is unresolved at present, and is likely to be both until the rabbit genome is completely sequenced, and perhaps even after that.

But the reason for the uncertainty in the tree is because the short lengths of the branches around which alternative trees differ.

We do not wish to deny the importance of determining the precise order of branching of phylogenetic trees around short branches. The fact remains, however, that alternative branchings do not, as a rule, alter the biomedically relevant conclusions that are drawn from an evolutionary analysis. Therefore, those interested in practical applications of genome sequences using evolutionary models need not concern themselves with controversies of this type. These alternatives are of interest to specialists in the field. But, as outlined above, they interest us only if the biological conclusions that we draw are not drawn robustly with respect to small changes. Therefore, in constructing a evolution-based biological hypothesis, it is worth re-running the analysis with all possible tree topologies swapped around short branches, just to see if the biological hypothesis survives these swappings.

The examples with yeast alcohol dehydrogenase, leptin, ribonuclease, and aromatase all illustrate a general approach to functionally link a family with a new anatomical structure, behavior, life history, survival strategy or other physiological feature of an organism, or a change in these. Here, one begins by estimating the date (generally from the paleontological and geological records) in Earth's history where this physiology arose, or changed. One then searches in the lineage of the organism that created the physiology (or suffered its change) for events in the molecular record that occurred at the same time. The duplication of aromatase genes at the time that pig litter size expanded suggests that aromatase is important for the changing survival strategy: Increased litter size. The duplication of genes in yeast at the time when fermentable fruits arose suggests that the duplicated genes are important to fermentation. An episode of rapid sequence evolution in the ribonuclease gene at the time when ruminant digestion arose suggests that ribonuclease is important for ruminant digestion.

In many of these examples, the logic operated in reverse. We knew, for example, that ribonuclease arose in response to ruminant digestion, therefore we sought rapid evolution in its molecular history. With the emergence of large genome databases, especially those that are naturally organized, especially those whose trees and alignments have been improved, it should be possible to go in the reverse direction. For example, identifying the genes that duplicated in primates during the Oligocene cooling identifies genes that enhanced neurological capabilities. Identifying the genes that duplicated, or suffered episodes with high Kₐ/Kₛ ratios, or changed pattern of homoplasy, patterns of amino acid replacement, or frequency of mutation at individual sites, in grasses during the Oligocene cooling identifies genes, as hypotheses, that enhanced cold and drought tolerance.

Testing Hypotheses with Experimental Paleobiochemistry.

As we have noted elsewhere, the hypothesis, generated in silico using these tools, can be tested by an experiment in resurrective paleobiochemistry. In this experiment, the proteins at the nodes on each end of the branch suspected of holding a discontinuity in functional behavior are resurrected and studied in the laboratory.

The FIREBIRD Recipe (Functional Inference from Reconstructed Evolutionary Biology Involving Rectified Databases)

We summarize here, not in the same order as above, a typical application of a process to analyze functional change within a typical protein family.

1. Find in the useful NOD the families of modules from which the target protein is built.

1.1 Download these

1.2 Assemble full length sequences from these

2. Complete the inventory of homologs (optional)

2.1 Add sequences of your own

2.2 Identify genes that have been entered since the last useful NOD was built.

2.3 Go to the current whole genomes, and get a complete inventory of the homologs in these.

3. Rectify the multiple sequence alignment and tree

3.1 Apply alternative tools to construct the multiple sequence alignment and tree

3.2 Apply alternative non-classical strategies to build the tree

3.2.1 DNA instead protein-based analysis

3.2.2 Distance-based tool using gamma models, or other refined distance metrics

3.2.3 Incorporate paleontological information to constrain trees

3.2.4 Use TREx distances to construct trees

3.2.5 Hybrid constructions, applying different tools to different branches of the tree

3.2.6 Build trees with alternative sampling of the database (robustness to sample size)

3.3 Refine gap placement

2.3.1 Identify gaps introduced by gene finding mistakes

2.3.2 Place indel events on specific branches of the tree

2.3.3 Refine MSA if crystal structures available

3.4 Retain alternative alignments and trees for use to test robustness of biological conclusions

4. Correlate the tree with the paleontological and geological record

4.1 Assigning TREx ƒ₂ values to nodes in the tree

4.2 Assign TREx distances to the tree

4.3 Placing the root on the tree.

4.4 Obtain a rate constant for silent transitions on branches of the tree

4.4.1 Using datable orthologs from the tree itself

4.4.2 From whole genome analysis (see below)

5. Perform a FIREBIRD analysis

5.1 Determine typical global characteristics of the tree

5.1.1 PAM width

5.1.2 Typical Kₐ/Kₛ ratio for a typical branch

5.1.3 Calculate parameters of the gamma model for the tree overall

5.2 Dissect the tree into subtrees

5.2.1 PAM width of subtree

5.2.2 Typical Kₐ/Kₛ ratio for a typical branch in subtree

5.2.3 Calculate parameters of the gamma model for subtree

5.3 Identify branches where function might be changing

5.3.1 Identify all branches that have high rate of amino acid replacement per unit time

5.3.2 Identify all branches that have high Kₐ/Kₛ ratios

5.3.3 Identify all branches that have high Kₐ/Kₛ ratio relative to the typical ratio in the subfamily

5.3.4 Identify all branches that have high Kₐ/Kₛ ratio relative to the typical ratio in the family

5.3.5 Identify subtrees with different gamma model parameters

5.4 Identify branches where function might be conserved

5.4.1 Identify all branches that have low rate of amino acid replacement per unit time

5.4.2 Identify all branches that have low Kₐ/Kₛ ratios

5.4.3 Identify all branches that have low Kₐ/Kₛ ratio relative to the typical ratio in the subfamily

5.4.4 Identify all branches that have low Kₐ/Kₛ ratio relative to the typical ratio in the family

5.4.5 Identify subtrees with uniform gamma model parameters

5.4.6 Identify branches with large amounts of compensatory covariation

5.4.7 Identify subfamilies large amounts of homoplasy

6. Residue by residue analysis

6.1 Establish a correlation between the MSA and a representative crystal structure

6.2 Identify sites potentially involved in adaptive change

6.2.1 Sites changing along branches with high rates of replacement

6.2.2 Sites changing in episodes with high Kₐ/Kₛ ratio

6.2.3 Sites causing non-stationary gamma behavior

6.2.4 Sites that suffer replacements repeatedly

6.3 Map sites potentially involved in adaptive change on the crystal structure

6.3.1 Identify such sites that are on the surface

6.3.2 Identify such sites that are near the active site

6.3.3 Identify such sites that are interior to the fold.

6.3.4 Analyze spatial relation of multiple sites.

6.4 Identify sites potentially involved in adaptive stasis

6.4.1 Sites that display homoplasy

6.4.2 Sites that are highly conserved

6.4.3 Sites that display compensatory replacement

6.5 Map sites potentially involved in adaptive stasis on the crystal structure

6.3.1 Identify such sites that are on the surface

6.3.2 Identify such sites that are near the active site

6.3.3 Identify such sites that are interior to the fold.

6.3.4 Analyze spatial relation of multiple sites.

7. Consider correlations outside of the family

7.1 With other protein families

7.2 With non-sequence records, including records from paleontology, geology, ecology, ontogeny, phylogeny, or systematics (collectively known as the “non-genomic record”).

Exhaustive Database Analyses

The exhaustive matching of the genome sequence database in 1991 made it possible, for the first time with a large dataset, to ask questions about how protein sequences, in general, change during divergent evolution. In the 1990's a series of papers emerged that analyzed how amino acids were replaced, and how sections of protein sequence were inserted and deleted, during the course of evolution.

We are now able to repeat this type of analysis, asking more subtle questions, including those directed towards specific species (there is no reason a priori to expect that the process of mutation will be the same in all species), towards specific classes of proteins, and with better tools for dating than were available previously. In doing so, we hope to achieve an improved description of the basic processes of evolution. This description can then be used to build better evolutionary models in general, including better multiple sequence alignments and better trees. This, in turn, can only improve our ability to date events, reconstruct ancestral events, and interpret genomic sequences in terms of function.

The basic element of an analysis of the divergence of protein sequences is the aligned sequence pair. These are collected from the database as a whole (with issues of sampling bias to be addressed later). They do not require family structure, except to address issues of sampling bias. Therefore, the NOD architecture is not necessarily needed. However, the pairwise alignments used to generate the NOD are suitable as the starting point for such analyses, and it makes sense to use these if the results are to be turned around and used to enhance the NOD.

As proteins are encoded by genes, a pairwise alignment of the gene sequences follows from the protein sequence alignment. We begin any analysis of the process of sequence evolution from this pair of alignment (recognizing, of course, that either can be gotten from the other).

The act of constructing an alignment is to make a statement about the historical past. First, constructing an alignment means that one believes (or at least suspects) that the two proteins are homologous, that is, related by common ancestry. More precisely, since the DNA molecules are the units of inheritance, we are stating that we believe (or suspect) that the genes are descendants of a single ancestral gene, that was found in some organism at some (as yet) unspecified time in the past.

The historical statement embodied in an alignment is stronger, however, and applies to individual residues in the protein, and individual nucleotides in the gene. By definition, the correct alignment is one where the codons matched in the gene alignment are descendants of a single codon in the ancestral gene.

### EXAMPLES

### Example 1

### Alcohol Dehydrogenase

Mammalian alcohol dehydrogenase (E.C.1.1.1.1) have undergone a rapid episode of sequence evolution in and around the active site as substrate specificity has divergently evolved to handle xenobiotic substances in the liver. In contrast, over a comparable span of evolutionary distance, the active site of yeast alcohol dehydrogenase has changed very little, corresponding to an apparently constant role of the enzyme to act on the ethanol-acetaldehyde redox couple. Indeed, by identifying positions in mammalian dehydrogenases where amino acid variation was observed over a span of evolution where the same residues were conserved in the yeast dehydrogenases provided a clear map of the active site of the protein.

### Example 2

### Notch Protein

A set of Notch homologs were obtained, and used to build a multiple sequence alignment, and evolutionary tree (Drawing 6) and reconstructed intermediates throughout the evolutionary tree.

The functional interpretation based on these tools proceeded as follows. First, the ƒ₂ values showed that the silent substitutions were not equilibrated over much of the tree. However, the ƒ₂ value becomes close to 0.5 at points where the phyla diverge, suggesting near equilibration in the silent values. This defines the root of the tree near node 13. Kₐ/Kₛ values are given on the branches (numbers in italics). They suggest at the level of hypothesis that notch 1, notch 3 and notch are proteins with derived functions, while notch 4 is the paralog in mammals with the ancestral function. The rate constant for silent substitution is calculated to be ca. 23×10⁻⁹ changes/base per year. This suggests that the notch paralogs diverged ca. 400 Ma. This is at the time of the development of advanced organs in vertebrates, suggesting that the Notch paralogs with derived function in the vertebrates are important for this level of organogenesis.

### Example 3

### The Yeast Genome

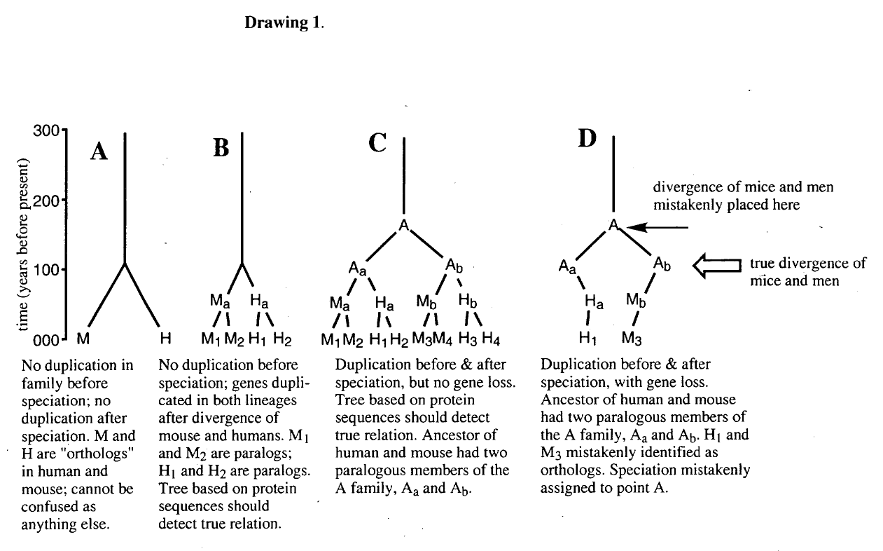

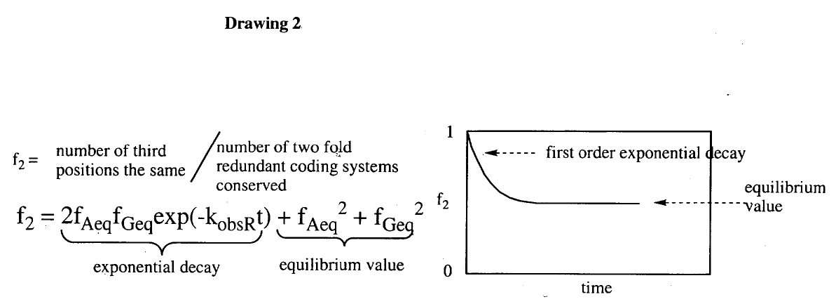

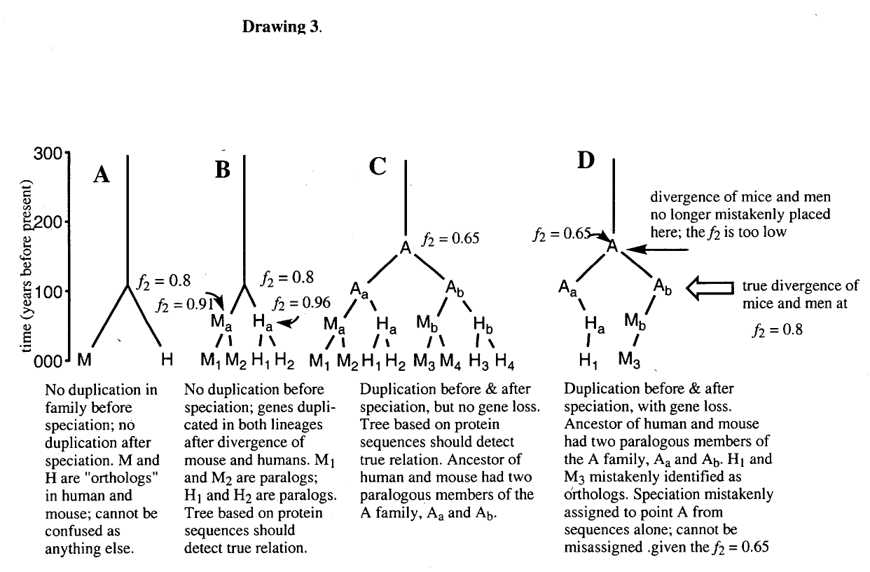

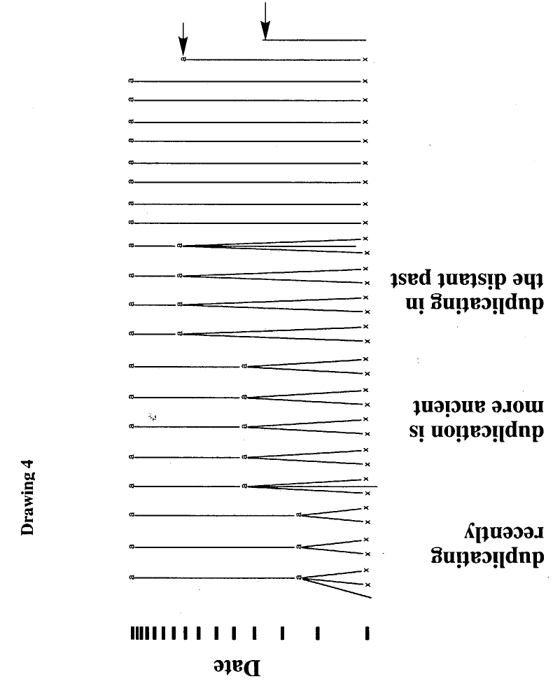

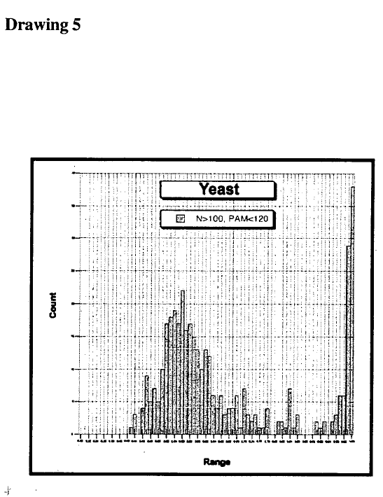

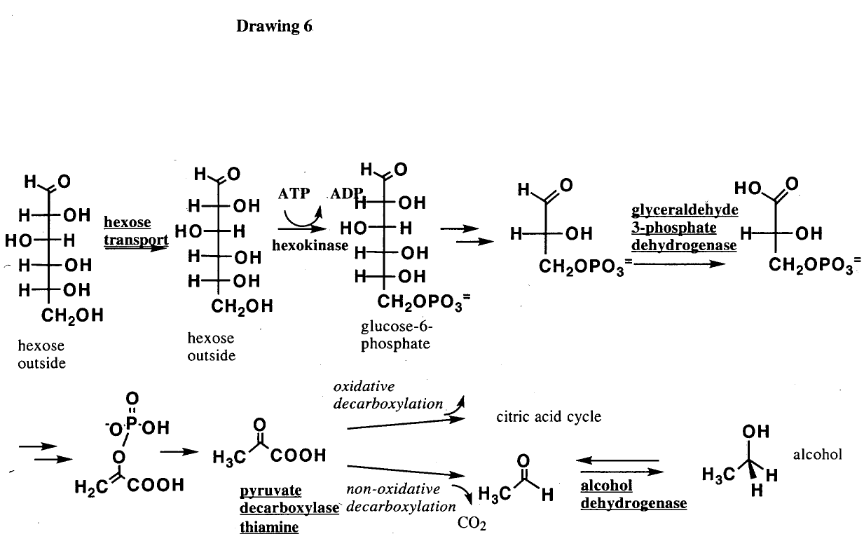

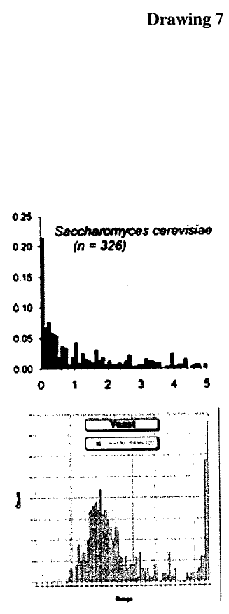

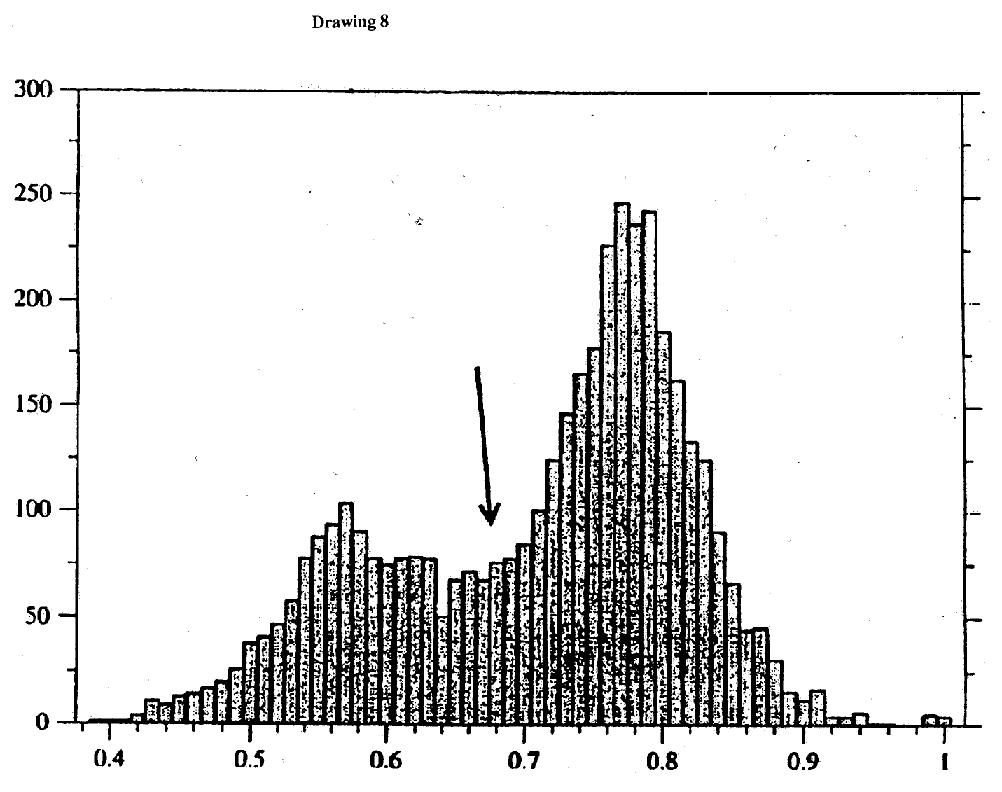

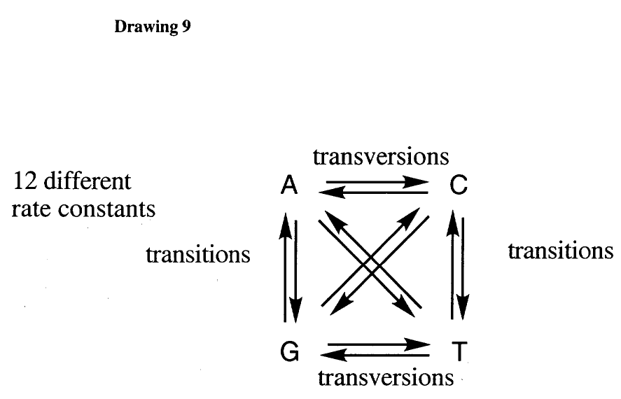

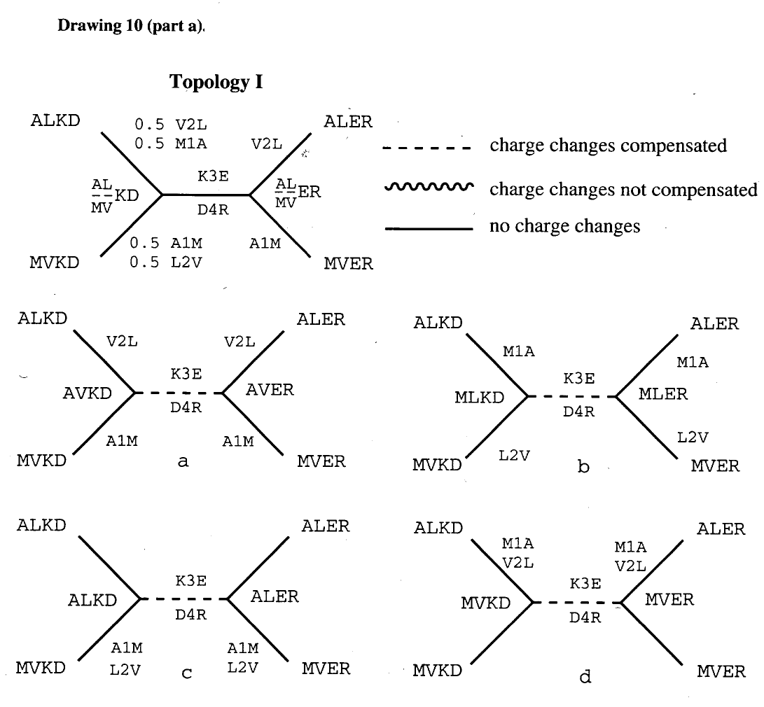

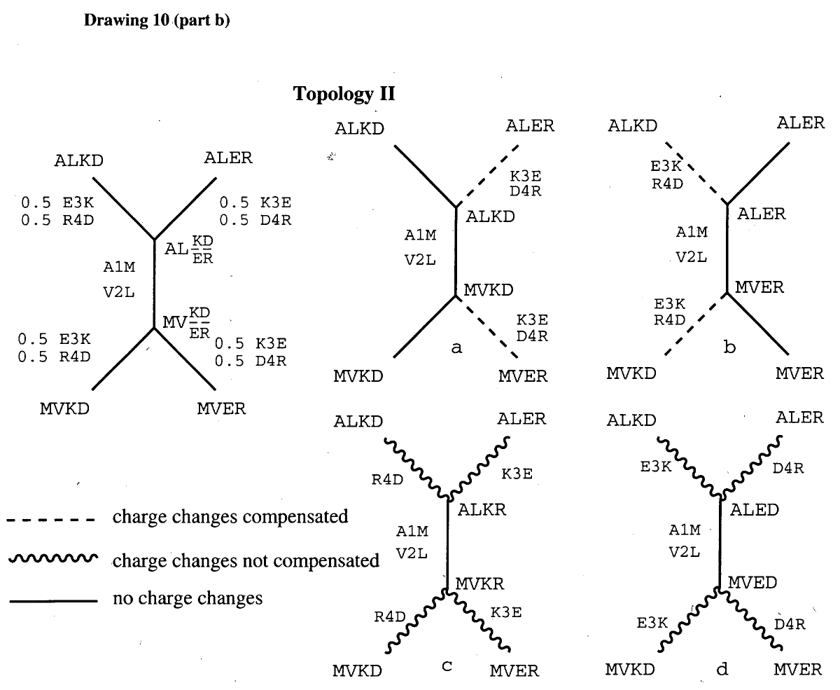

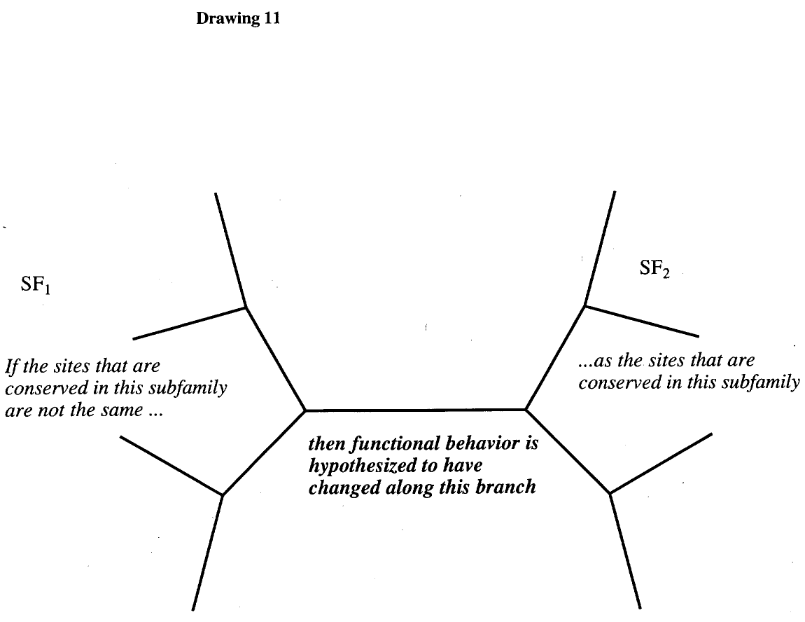

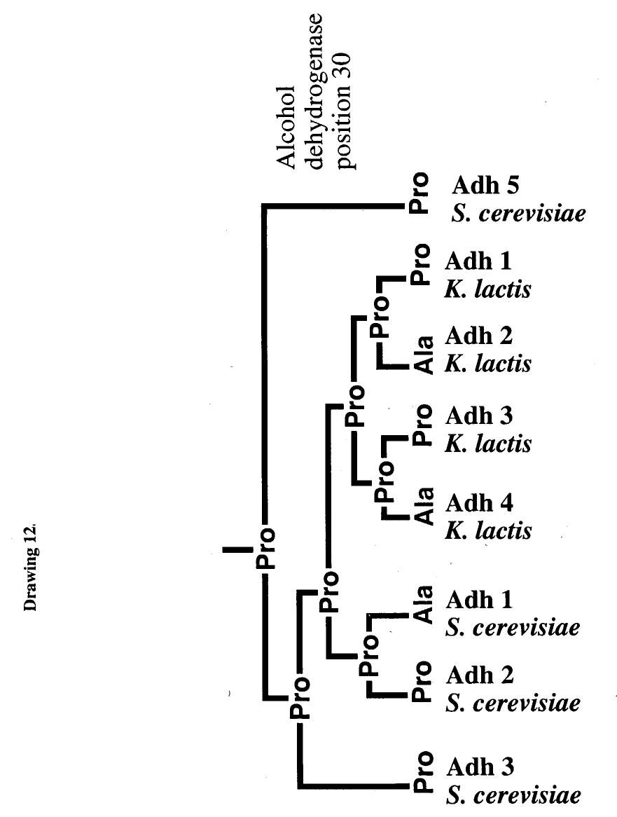

To yeast genome contains other illustration of the power of second generation strategies, especially when compared with conventional approaches. Consider the conventional histogram in FIG. 16b (from (Lynch & Conery, 2000)). Here, duplications in the yeast genome were dated using the conventional Kₛ metric (Li et al., 1985)(Li, 1993). The conventional metric is adequate only to note that duplications do indeed occur, and that many are recent, and to suggest a rate for duplicate loss. Lynch and Conery (Lynch & Conery, 2000) interpreted this as random duplications that created redundancies that had not yet been removed by random loss. These conclusions remain controversial, in part because of criticism of the silent substitution metric to rank-order events in the genome (Long & Thornton, 2001)(Zhang et al., 2001).

Second generation analyses suggested an alternative interpretation. All of the recent duplication events in the yeast genome fall into three metabolic categories: (a) genes that allow yeast to divide more rapidly, (b) genes that allow yeast to synthesize proteins more rapidly, and (c) genes that allow yeast to ferment malt [Ben02]. This is not a signature of random gene duplication, with the randomly created duplicates present in the yeast genome only because insufficient time has passed since they were created for them to be lost as functionless redundancies.

More plausible is the hypothesis that contact with humans has offered yeast a relatively rich environment to grow, far richer than the environment encountered by yeast in the wild (where few feasts are interspersed with long famines). The hypothesis is therefore more compelling that we are observing in the genome of yeast the record of its interaction with humans in the most recent episode of gene duplication, just as we are observing the record of yeast's acquaintance with angiosperms in the episode of gene duplication where ƒ₂=0.84.

### Example 4

### Identifying Pathways and Regulatory Networks within Mammalian Genomes

These results show how second generation dating tools, evolutionary models, and interpretive strategies address problems that are not addressed with first generation tools. Within yeast, so much is known that hypotheses are rapidly validated.

Within mammalian genomes, hypotheses drawn using a FIREBIRD analysis can remain hypotheses longer, guiding biomedical researchers in the selection of Targets. For example, inspection of the STAT family within the MASTERCATALOG resource identifies a gene duplication in the mouse genome occurring since the divergence of mouse and rat. Because of the power of the MASTERCATALOG as a second generation naturally organized database, this inspection is possible by a browser with one click of a mouse button; the biologist need not to first make a commitment to investigate the STAT family, suffer through BLAST searches, and build his/her own evolutionary models before the first biological information returns as feedback.

This approach is useful for non-directed discovery. For example, once one notices the duplication in the STAT family, one can search the mouse genome for duplications occurring near the same time. This is in fact the case in the JAK family. As JAK and STAT interact in a regulatory networks generally, one generates the hypothesis that this particular JAK and this particular STAT are involved in the same regulatory pathway.

But which JAK is involved with which STAT? Again, the FIREBIRD strategy generates a working hypothesis. Inspection of the pre-computed trees within the MasterCatalog for each of the branches leading from the ancestral JAKs and STATs, one notices that one JAK and one STAT in mouse lie at the ends of branches with particularly high Kₐ/Kₛ ratios. The working hypothesis is that this particular JAK and this particular STAT work together in a new pathway that emerged in the last 10 million years. This hypothesis is exactly the type of hypothesis that biological scientists would like to extract from a contemporary genome database.

### Example 5

### Identifying Pathways and Networks within Mammalian Genomes; Higher Order Neurological Function

Jermann et al. [Jer95] disclosed to the art an example where events in the molecular record from oxen were dated from a set of sequences that assumed orthology, and events in the record were then temporally correlated with events known from paleontology, including the origin of ruminant digestion in the lineage leading to oxen, the emergence of grasses that made ruminant digestion desirable, and the global climate change during the Oligocene that drove the emergence of grasses. The duplications were found in proteins that today serve roles in the digestive tracts of ruminants.

How did primates respond to the global cooling? This question is the reverse of the question that Jermann asked, in that we are seeking genes based solely on a geological date, rather than knowing a gene before hand. Paralog analysis done by the method of the instant invention was applied to the human genome. Paralogs were identified, and their ƒ₂ values were calculated. Based on the transition rate constant of 3×10⁻⁹ exchanges/site/year, a collection of paralog pairs were collected that duplicated approximately during the time of the Oligocene cooling. Many of them had no known function, meaning that they were not associated with any cultural annotation:

| | |
|---|---|
| gp.21951 | unnamed product |
| gp.25294 | unnamed product |
| gp.25492 | unnamed product |
| gp.21951 | unnamed product |

Those having of them that were associated with cultural annotation appeared to be involved, hypothetically, with the higher nervous system, including:

| | |
|---|---|
| gp.28010 | desmolase, neurosteroid biosynthesis |
| gp.21865 | butyrophilin, neurosteroid receptor (?) |
| gp.24532 | protocadherin 68; these are involved in genetic |
| gp.24532 | protocadherin 68; predetermination in the brain |
| gp.24558 | protocadherin 43; [Hil01][Bla00] |
| gp.13983 | serine/threonine kinase PAK homolog; X-lined |
| | mental retardation [All98] |
| gp.16242 | MNB protein kinase, Down syndrome [Ken00] |

Interestingly, chromosome 3 and 21 split ca. 40 MYA. This suggests, as a hypothesis, that primates responded to the Oligocene cooling by becoming more “intelligent”. This illustrates the use of the TREx dating approach to generate hypotheses in a very complex system, the human genome.

### Example 6

### Functional Analysis of Aromatase

Aromatase is a cytochrome P450-dependent enzyme that catalyzes a multi-step reaction that creates an estrogen from an androgen, with well-known physiological consequences. Estrogen is also synthesized in primitive chordates such as Amphioxus (Callard et al., 1984), but not in other metazoans. Therefore, estrogen appears to have been invented as a hormone early in the divergent evolution of chordates.

Aromatase belongs to the cytochrome P450 superfamily of enzymes (Nebert et al., 1991). Members of the superfamily use a common chemical mechanism (Akhtar et al, 1997) to assimilate carbon, detoxify organic substances, and synthesize regulatory molecules. In biomedicine, variants of P450 oxidases can determine whether individuals have side effects to a therapeutic agent (Gonzalez & Nebert, 1990), and aromatase itself plays a significant role in the progression of some cancers. A list of aromatase sequences used in this analysis follows.

1. Tilapia nilotica (rainbow trout), GenBank g1613859, mRNA (Chang et al., 1997)

2. Oryzias latipes (medaka), GenBank g1786171, ovarian follicle mRNA (Tanaka et al., 1995)

3. Danio rerio (zebrafish), GenBank g2306966 aromatase mRNA

4. Carassius auratus (goldfish) ovary, GenBank g2662330, ovarian mRNA

5. Ictalurus punctatus (channel catfish), GenBank g912802 (Trant, 1994)

6. Carassius auratus (goldfish) brain, GenBank g2662328, brain mRNA

7. Sus scrofa (pig) placental, isoform 2, GenBank g1762232, mRNA (Choi et al., 1997a)

8. Sus scrofa (pig) embryo, isoform 3, GenBank g1244543, mRNA (Choi et al., 1996)

9. Sus scrofa (pig) ovary, isoform 1, GenBank g1928957, mRNA (Conley et al., 1997)

10. Bos taurus (ox), GenBank g665546, mRNA (Hinshelwood et al., 1993)

11. Equus caballus (horse), GenBank g2921277, mRNA (Boerboom et al. 1997)

12. Mus musculus (mouse), GenBank g3046857, mRNA (Terashima et al. 1991)

13. Rattus norvegicus (rat), GenBank g203804, mRNA (Hickey et al., 1990)

14. Oryctolagus cuniculus (rabbit), GenBank g1240042, mRNA (Delarue et al, 1996)

15. Homo sapiens (human), GenBank g28846, mRNA (Harada, 1988)

16. Gallus gallus (chicken), GenBank g211703 (McPhaul et al., 1988)

17. Poephila guttata (zebra finch), GenBank g926845, ovary mRNA (Shen et al., 1994)

| | |
|---|---|
| | 010 020 030 040 050 060 070 080 |
| | \| \| \| \| \| \| \| \| |
| 1 | MVLEMLNPMHYKVTSMVSEVVPFASIAVLLLTGFLLLVWNYKNTS-SIPGPGYFLGIGPLISYLRFLWMGIGSACNYYNK |
| 2 | MFLEMLNPMQYNVTIMVPETVTVSAMPLLLIMGLLLLIWNCESSS-SIPGPGYCLGIGPLISHGRFLWMGIGSACNYYNK |
| 3 | MILEMLNPMHYNLTSMVPEVMPVATLPILLLTGFLFFVWNHEETS-SIPGPGYCMGIGPLISHLRFLWMGLGSACNYYNK |
| 4 | VLELLMQGAHNSSYGAQDNVCGAMATLLLLLLCLLLAIRHHWTEKDHVPGPCFLLGLGPLLSYCRLIWSGIGTASNYYNS |
| 5 | -MEEVLKGTVNFAATVQVTLMALTGTLLLILLHRIFTAKNWRNQS-GVPGPGWLLGLGPIMSYSRFLWMGIGSACNYYNE |
| 6 | VVDLLIQRAHNGTERAQDNACGATATILLLLLCLLLAIRHHRPHKSHIPGPSFFFGLGPVVSYCRFIWSGIGTASNYYNS |
| 7 | MVLEMLNPMYYKITSMVSEVVPFASIAVLLLTGFLLLLWNYENTS-SIPSPGYFLGIGPLISHFRFLWMGIGSACNYYNE |
| 8 | ----LVSIAPNTTVGLP-SGIPMATRSLILLVCLLLMVWSHSEKK-TIPGPSFCLGLGPLMSYLRFIWTGIGTASNYYNN |
| 9 | MVLEMLNPMN--ISSMVSEAVLFGSIAILLLIGLLLWVWNYEDTS-SIPGPGYFLGIGPLISHFRFLWMGIGSACNYYNK |
| 10 | MVLEMLNPMHFNITTMVPAAMPAATMPILLLTCLLLLIWNYEGTS-SIPGPGYCMGIGPLISYARFLWMGIGSACNYYNK |
| 11 | VMEILLREARNGTDPRYENPRG-ITLLLLLCLVLLLTVWNRHEKKCSIPGPSFCLGLGPLMSYCRFIWMGIGTASNYYNE |
| 12 | MVLETLNPLHYNITSLVPDTMPVATVPILILMCFLFLIWNHEETS-SIPGPGYCMGIGPLISHGRFLWMGVGNACNYYNK |
| 13 | ----VVARSLCDLKCHPIDGISMATRTLILLVCLLLVAWSHTDKK-IVPGPSFCLGLGPLLSYLRFIWTGIGTASNYYNN |
| 14 | MLLEVLNPRHYNVTSMVSEVVPIASIAILLLTGFLLLVWNYEDTS-SIPGPSYFLGIGPLISHCRFLWMGIGSACNYYNK |
| 15 | MVLEMLNPIHYNITSIVPEAMPAATMPVLLLTGLFLLVWNYEGTS-SIPGPGYCMGIGPLISHGRFLWMGIGSACNYYNR |
| 16 | --------------------MPVATVPIIILICFLFLIWNHEETS-SIPGPGYCMGIGPLISHGRFLWMGVGNACNYYNK |
| 17 | MFLEMLNPMHYNVTIMVPETVPVSAMPLLLIMGLLLLIRNCESSS-SIPGPGYCLGIGPLISHGRFLWMGIGSACNYYNK |
| | 090 100 110 120 130 140 150 160 |
| | \| \| \| \| \| \| \| \| |
| 1 | TYGEFIRVWIGGEETLIISKSSSVFHVMKHSHYTSRFGSKPGLQFIGMHEKGIIFNNNPVLWKAVRTYFMKALSGPGLVR |
| 2 | MYGEFMRVWISGEETLIISKSSSMFHVMKHSHYISRFGSKRGLQCIGMHENGIIFNNNPSLWRTIRPFFMKALTGPGLVR |
| 3 | MYGEFVRVWISGEETLVISKSSSTFHIMKHDHYSSRFGSTFGLQYMGMHENGVIFNNNPAVWKALRPFFVKALSGPSLAR |
| 4 | KYGDIVRVWINGEETLILSRSSAVYHVLRKSLYTSRFGSKLGLQCIGMHEQGIIFNSNVALWKKVRTFYAKALTGPGLQR |
| 5 | KYGSIARVWISGEETFILSKSSAVYHVLKSNNYTGRFASKKGLQCIGMFEQGIIFNSNMALWKKVRTYFTKALTGPGLQK |
| 6 | KYGDIVRVWINGEETLILSRSSAVYHVYRKSLYTSRFGSKLGLQCIGMHEQGIIFNSNVALWKKVRAFYAKALTGPGLQR |
| 7 | MYGEFMRVWIGGEETLIISKSSSVFHVMKHSHYTSRFGSKPGLECIGMYEKGIIFNNDPALWKAVRTYFMKALSGPGLVR |
| 8 | KYGDIVRVWINGEETLILSRASAVHHVLKNRKYTSRFGSKQGLSCIGMNEKGIIFNNNVALWKKIRTYFTKALTGPNLQQ |
| 9 | MYGEFMRVWIGGEETLIISKSSSIFHIMKHNHYTCRFGSKLGLECIGMHEKGIMFNNNPALWKAVRPFFTKALSGPGLVR |
| 10 | MYGEFIRVWICGEETLIISKSSSMFHVMKHSHYVSRFGSKPGLQCIGMHENGIIFNNNPALWKVVRPFFMKALTGPGLVQ |
| 11 | KYGDMVRVWISGEETLVLSRPSAVYHVLKHSQYTSRFGSKLGLQCIGMHEQGIIFNSNVTLWRKVRTYFAKALTGPGLQR |
| 12 | TYGDFVRVWISGEETFIISKSSSVSHVMKHWHYVSRFGSKLGLQCIGMYENGIIFNNNPAHWKEIRPFFTKALSGPGLVR |
| 13 | KYGDIVRVWINGEETLILSRSSAVHHVLKNGNYTSRFGSIQGLSYLGMNERGIIFNNNVTLWKKIRTYFAKALTGPNLQQ |
| 14 | MYGEFMRVWVCGEETLIISKSSSMFHVMKHSHYISRFGSKLGLQFIGMHEKGIIFNNNPALWKAVRPFFTKALSGPGLVR |
| 15 | VYGEFMRVWISGEETLIISKSSSMFHIMKHNHYSSRFGSKLGLQCIGMHEKGIIFNNNPELWKTTRPFFMKALSGPGLVR |
| 16 | TYGEFVRVWISGEETFIISKSSSVFHVMKHWNYVSRFGSKLGLQCIGMYENGIIFNNNPAHWKEIRPFFTKALSGPGLVR |
| 17 | MYGEFMRVWISGEETLIISKSSSMVHVMKHSNYISRFGSKRGLQCIGMHENGIIFNNNPSLWRTVRPFFMKALTGPGLIR |
| | 170 180 190 200 210 220 230 240 |
| | \| \| \| \| \| \| \| \| |
| 1 | MVTVCADSITKHLDKLEEVRNDLGYVDVLTLMRRIMLDTSNNLFLGIPLDEKAIVCKIQGYFDAWQALLLKPDIFFKIP- |
| 2 | MVEVCVESIKQHLDRLGEVTDTSGYVDVLTLMRHIMLDTSNMLFLGIPLDESAIVKKIQGYFNAWQALLIKPNIFFKIS- |
| 3 | MVTVCVESVNNHLDRLDEVTNALGHVNVLTLMRRTMLDASNTLFLRIPLDEKNIVLKIQGYFDAWQALLIKPNIFFKIS- |
| 4 | TLEICITSTNTHLDNLSHLMDARGQVDILNLLRCIVVDISNRLFLGVPLNEHDLLQKIHKYFDTWQTVLIKPDVYFRLAW |
| 5 | SVDVCVSATNKQLNVLQEFTDHSGHVDVLNLLRCIVVDVSNRLFLRIPLNEKDLLIKIHRYFSTWQAVLIQPDVFFRLN- |
| 6 | TMEICTTSTNSHLDDLSQLTDAQGQLDILNLLRCIVVDVSNRLFLGVPLNEHDLLQKIHKYFDTWQTVLIKPDVYFRLD- |
| 7 | MVTVCADSITKHLDKLEEVRNDLGYVDVLTLMRRIMLDTSNNLFIGIPLDEKAIVCKIQGYFDAWQALLLKPEFFFKFS- |
| 8 | TVEVCVTSTQTHLDNLSSL----SYVDVLGFLRCTVVDISNRLFLGVPVDEKELLQKIHKYFDTWQTVLIKPDIYFKFS- |
| 9 | MVTVCADSITKHLDKLEEVRNDLGYVDVLTLMRRIMLDTSNNLFLGIPLDESALVHKVQGYFDAWQALLLKPDIFFKIS- |
| 10 | MVAICVGSIGRHLDKLEEVTTRSGCVDVLTLMRRIMLDTSNTLFLGIPMDESAIVVKIQGYFDAWQALLLKPNIFFKIS- |
| 11 | TLEICTMSTNTHLDGLSRLTDAQGHVDVLNLLRCIVVDISNRLFLDVPLNEQNLLFKIHRYFETWQTVLIKPDFYFRLK- |
| 12 | MIAICVESTTEHLDRLQEVTTELGNINALNLMRRIMLDTSNKLFLGVPLDENAIVLKIQNYFDAWQALLLKPDIFFKIS- |
| 13 | TVDVCVSSIQAHLDHLDSL----GHVDVLNLLRCTVLDISNRLFLNVPLNEKELMLKIQKYFHTWQDVLIKPDIYFKFR- |
| 14 | MVTICADSITKHLDRLEEVCNDLGYVDVLTLMRRIMLDTSNMLFLGIPLDESAIVVNIQGYFDAWQALLLKPDIFFKIS- |
| 15 | MVTVCAESLKTHLDRLEEVTNESGYVDVLTLLRRVMLDTSNTLFLRIPLDESAIVVKIQGYFDAWQALLIKPDIFFKIS- |
| 16 | MIAICVESTIVHLDKLEEVTTEVGNVNVLNLMRRIMLDTSNKLFLGVPLDESAIVLKIQNYFDAWQALLLKPDIFFKIS- |
| 17 | MVEVCVESIKQHLDRLGDVTDNSGYVDVVTLMRHIMLDTSNTLFLGIPLDESSIVKKIQGYFNAWQALLIKPNIFFKIS- |
| | 250 260 270 280 290 300 310 320 |
| | \| \| \| \| \| \| \| \| |
| 1 | WLYRKYEKSVKDLKEDMEILIEKKRRRIFTAEKLEDCMDFATELILAEKRGELTKENVNQCILEMLIAAPDTMSVTVFFM |
| 2 | WLYRKYERSVKDLKDEIAVLVEKKRHKVSTAEKLEDCMDFATDLIFAERRGDLTKENVNQCILEMLIAAPDTMSVTLYFM |
| 3 | WLSRKHQKSIKELRDAVGILAEEKRHRIFTAEKLEDHVDFATDLILAEKRGELTKENVNQCILEMMIAAPDTLSVTVFFM |
| 4 | WLHGKHKRDAQELQDAIAALIEQKRVQLTRAEKFDQ-LDFTGELIFAQSHGELSTENVRQCVLEMIIAAPDTLSISLFFM |
| 5 | FVYKKYHLAAKELQDEMGKLVEQKRQAINNMEKLDE-TDFATELIFAQNHDELSVDDVRQCVLEMVIAAPDTLSISLFFM |
| 6 | WLHRKHKRDAQELQDAITALIEQKKVQLAHAEKLDH-LDFTAELIFAQSHGELSAENVRQCVLEMVIAAPDTLSISLFFM |
| 7 | WLYKKHKESVKDLKENMEILIEKKRCSIITAEKLEDCMDFATELILAEKRGELTKENVNQCILEMLIAAPDTLSVTVFFM |
| 8 | WIHQRHKTAAQELQDAIESLVERKRKEMEQAEKLDN-INFTAELIFAQGHGELSAENVRQCVLEMVIAAPDTLSISLFFM |
| 9 | WLYRKYEKSVKDLKDAMEILIEEKRHRISTAEKLEDSMDFTTQLIFAEKRGELTKENVNQCVLEMMIAAPDTMSITVFFM |
| 10 | WLYKKYEKSVKDLKDAIDILVEKKRRRISTAEKLEDHMDFATNLIFAEKRGDLTRENVNQCVLEMLIAAPDTMSVSVFFM |
| 11 | WLHDKHRNAAQELHDAIEDLIEQKRTELQQAEKLDN-LNFTEELIFAQSHGELTAENVRQCVLEMVIAAPDTLSISVFFM |
| 12 | WLCKKYKDAVKDLKGAMEILIEQKRQKLSTVEKLDEHMDFASQLIFAQNRGDLTAENVNQCVLEMMIAAPDTLSVTLFFM |
| 13 | WIHHRHKTATQELQDAIKRLVDQKRKNMEQADKLDN-INFTAELIFAQNHGELSAENVTQCVLEMVIAAPDTLSLSLFFM |
| 14 | WLCRKYEKSVKDLKDAMEILIAEKRHRISTAEKLEDSIDFATELIFAEKRGELTRENVNQCILEMLIAAPDTMSVSVFFM |
| 15 | WLYKKYEKSVKDLKDAIEVLIAEKRRRISTEEKLEECMDFATELILAEKRGDLTRENVNQCILEMLIAAPDTMSVSLFFM |
| 16 | WLCKKYEEAAKDLKGAMEILIEQKRQKLSTVEKLDEHMDFASQLIFAQNRGDLTAENVNQCVLEMMIAAPDTLSVTLFIM |
| 17 | WLYRKYERSVKDLKDEIEILVEKKRQKVSSAEKLEDCMDFATDLIFAERRGDLTKENVNQCILEMLIAAPDTMSVTLYVM |
| | 330 340 350 360 370 380 390 400 |
| | \| \| \| \| \| \| \| \| |
| 1 | LFLIAKHPQVEEELMKEIQTVVGERDIRNDDMQKLEVVENFIYESMRYQPVVDLVMRKALEDDVIDGYPVKKGTNIILNI |
| 2 | LLLVAEYPEVEAAILKEIHTVVGDRDIKIEDIQNLKVVENFINESMRYQPVVDLVMRRALEDDVIDGYPVKKGTNIILNI |
| 3 | LCLIAQHPKVEEALMKEIQTVLGERDLKNDDMQKLKVMEMFINESMRYQPVVDIVMRKALEDDVIDGYPVKKGTNIILNI |
| 4 | LLLLKQNPDVELKILQEMNAVLAGRSLQHSHLSGLHILESFINESLRFHPVVDFTMRRALDDDVIEGYEVKKGTNIILNV |
| 5 | LLLLKQNSVVEEQIVQEIQSQIGERDVESADLQKLNVLERFIKESLRFHPVVDFIMRRALEDDEIDGYRVAKGTNLILNI |
| 6 | LLLLKQNPDVELKILQEMDSVLAGQSLQHSHLSKLQILESFINESLRFHPVVDFTMRRALDDDVIEGYNVKKGTNIILNV |
| 7 | LFLIAKHPQVEEAIVKEIQTVIGERDIRNDDMQKLKVVENFIYESMRYQPVVDLVMRKALEDDVIDGYPVKKGTNIILNI |
| 8 | LLLLKQNPHVELQLLQEIDTIVGDSQLQNQDLQKLQVLESFINECLRFHPVVDFTMRRALFDDIIDGHRVQKGTNIILNT |
| 9 | LFLIANHPQVEEELMKEIYTVVGERDIRNDDMQKLKVVENFIYESMRYQPVVDFVMRKALEDDVIDGYPVKKGTNIILNI |
| 10 | LFLIAKHPSVEEAIMEEIQTVVGERDIRIDDIQKLKVVENFIYESMRYQPVVDLVMRKALEDDVIDGYPVKKGTNIILNI |
| 11 | LLLLKQNAEVERRILTEIHTVLGDTELQHSHLSQLHVLECFINEALRFHPVVDFSYRRALDDDVIEGFRVPRGTNIILNV |
| 12 | LILIAEHPTVEEEMMREIETVVGDRDIQSDDMPNLKIVENFIYESMRYQPVVDLIMRKALQDDVIDGYPVKKGTNIILNI |
| 13 | LLLLKQNPHVEPQLLQEIDAVVGERQLQNQDLHKLQVMESFIYECLSFHPVVDFTMRRALSDDIIEGYRISKGTNIILNT |
| 14 | LFLIAKHPQVEEAIIREIQTVVGERDIRIDDMQKLKVVENFINESMRYQPVVDLVMRKALEDDVIDGYPVKKGTNIILNL |
| 15 | LFLIAKHPNVEEAIIKEIQTVIGERDIKIDDIQKLKVMENFIYESMRYQPVVDLVMRKALEDDVIDGYPVKKGTNIILNI |
| 16 | LILIADDPTVEEKMMREIETVMGDREVQSDDMPNLKIVENFIYESMRYQPVVDLIMRKALQDDVIDGYPVKKGTNIILNI |
| 17 | LLLIAEYPEVETAILKEIHTVVGDRDIRIGDVQNLKVVENFINESLRYQPVVDLVMRRALEDDVIDGYPVKKGTNIILNI |
| | 410 420 430 440 450 460 470 480 |
| | \| \| \| \| \| \| \| \| |
| 1 | GRMHRLEFFPKPNEFTLENFAKNVPYR-YFQPFGFGPRACAGKYIAMVMMKVTLVILLRRFQVQTPQDRCVEKMQKKNDL |
| 2 | GRMHRLEYFPKPNEFTLENFEKNVPYR-YFQPFGFGPRGCAGKYIAMVMMKVVLVTLLRRFQVKTLQKRCIENIPKKNDL |
| 3 | GRMHKLEFFPKPNEFTLENFEKNVPYR-YFQPFGFGPRSCAGKFIAMVMMKVMLVSLLRRFHVKTLQGNCLENMQKTNDL |
| 4 | GRMHRSEFFPKPNEFSLDNFQKNVPSR-FFQPFGSGPRSCVGKHIAMVMMKSILVTLLSRFSVCPVKGCTVDSIPQTNDL |
| 5 | GRMHKSEFFQKPNEFNLENFENTVPSR-YFQPFGCGPRACVGKHIAMVMTKAILVTLLSRFTVCPRHGCTVSTIKQTNNL |
| 6 | GRMHRSEFFSKPNQFSLDNFHKNVPSR-FFQPFGSGPRSCVGKHIAMVMMKSILVALLSRFSVCPMKACTVENIPQTNNL |
| 7 | GRMHRLEFFPKPNEFTLENFAKNVPYR-YFQPFGFGPRACAGKYIAMVMMKVTLVILLRRFQVQTPQDRCVEKMQKKNDL |
| 8 | GRMHRTEFFHKANEFSLENFQKNTPRR-YFQPFGSGPRACVGRHIAMVMMKSILVTLLSQYSVCPHEGLTLDCLPQTNNL |
| 9 | GRMHRLEFFPKPNEFTLENFAKNVPYR-YFQPFGFGPRACAGKYIAMVMMKVILVTLLRRFQVQTQQGQCVEKMQKKNDL |
| 10 | GRMHRLEFFPKPNEFTLENFAKNVPYR-YFQPFGFGPRGCAGKYIAMVMMKVILVTLLRRFQVKALQGRSVENIQKKNDL |
| 11 | GRMHRSEFYPKPADFSLDNFNKPVPSR-FFQPFGSGPRSCVGKHIAMVMMKAVLLMVLSRFSVCPEESCTVENIAHTNDL |
| 12 | GRMHKLEFFPKPNEFSLENFEKNVPSR-YFQPFGFGPRSCVGKFIAMVMMKAILVTLLRRCRVQTMKGRGLNNIQKNNDL |
| 13 | GRMHRTEFFLKGNQFNLEHFENNVPRPPTFQPFGSGPRACIGKHMAMVMMKSILVTLLSQYSVCTHEGPILDCLPQTNNL |
| 14 | GRMHRLEFFPKPNEFTLENFAKNVPYR-YFQPFGFGPRGCAGKYIAMVMMKVVLVTLLRRFHVQTLQGRCVEKMQKKNDL |
| 15 | GRMHRLEFFPKPNEFTLENFAKNVPYR-YFQPFGFGPRGCAGKYIAMVMMKAILVTLLRRFHVKTLQGQCVESIQKIHDL |
| 16 | GRMHKLEFFPKPNEFSLENFEKNVPSR-YFQPFGFGPRGCVGKFIAMVMMKAILVTLLRRCRVQTMKGRGLNNIQKNNDL |
| 17 | GRMHRLEYFPKPNEFTLENFEKNVPYR-YFQPFGFGPRSCAGKYIAMVMMKVVLVTLLKRFHVKTLQKRCIENMPKNNDL |
| | 490 |
| | \| |
| 1 | SLHPDETSG |
| 2 | SLHPNEDRH |
| 3 | ALHPDESRS |
| 4 | SQQPVEEPS |
| 5 | SMQPVEEDP |
| 6 | SQQPVEEPS |
| 7 | SLHPDETSG |
| 8 | SQQPVEHHQ |
| 9 | SLHPHETSG |
| 10 | SLHPDETSD |
| 11 | SQQPVEDKH |
| 12 | SMHPIERQP |
| 13 | SQQPVEHQQ |
| 14 | SLHPDETRD |
| 15 | SLHPDETKN |
| 16 | SMHPIERQP |
| 17 | SLHLDEDSP |

The aromatase gene family is complex. Two aromatase genes are known in goldfish (Callard and Tchoudakova, 1997). In contrast, only a single gene is known in the horse (Boerboom et al., 1997), the rat (Hickey et al., 1990), the mouse (Terashima et al., 1991), the human (Harada, 1988), and the rabbit (Delarue et al, 1996). Both a functional gene and a pseudogene are found in oxen. The pseudogene is built from homologs of exons 2, 3, 5, 8, and 9 interspersed with a bovine repeat element (Fürbaβ & Vanselow, 1995); it is transcribed but not translated. In several mammalian species, a single gene yields multiple forms of the MRNA for aromatase in different tissues via alternative splicing mechanisms. This is the case in humans (Simpson et al., 1997) and rabbits (Delarue et al. 1998).

A still different phenomenology is observed in the pig (Sus scrofa). Preliminary studies found three distinct mRNA molecules in different tissues with differences in their coding regions (Conley et al. 1996; Conley et al. 1997; Choi et al., 1996; Choi et al., 1997a; Choi et al., 1997b). It was suggested that these might have arisen from a single gene, possibly via RNA editing or alternative splicing (Conley et al. 1997).

The paralogous genes were then placed within their historical context using the TREx process. Standard tools were used to construct pairwise alignments for the 136 pairs of proteins. An evolutionary distance (in PAM units) was calculated for each pair. From this, an evolutionary tree was built for the mammalian sequences. The tree was adjusted to make the human and equine branchings consistent with paleontological records to obtain a “best consensus” tree. The sequences of the ancestral genes and proteins at branch points in the tree were then reconstructed. From there, mutations (including fractional mutations) at both the DNA level and protein level were assigned to individual branches in the tree using the method of Fitch (1971).

Based on the tree and the reconstructed evolutionary intermediates, Kₐ/Kₛ values were assigned to individual branches using the method of Li et al. (1985). The average branch in the aromatase tree was found to have a value of Kₐ/Kₛ of 0.348. Inspection of the tree shows that the highest Kₐ/Kₛ values anywhere in the mammalian aromatase family (0.85 and 0.66) are found within the divergent evolution of the pig aromatases. These suggest that adaptive changes occurred during the triplication of the aromatase gene in pigs, even though these values were less than unity.

While it would be most preferred to separate transition processes that interconvert T from C from transition processes that interconvert A and G, and while this is certainly done when determining lineage specific rates from multiple gene families, when considering only a single gene family, it is frequently preferable to prefer approximations that increase the number of characters at the expense of the homogeneity of the rate processes sampled. That is, the preferred metric with a large sample size begins with an analysis of ƒ_{2R} or ƒ_{2Y}, simply because those metrics concern G-A and C-T interconversions. With a single family, however, the number of characters that are useful is generally less than half of the number of amino acids in the protein. If the proteins being compared have diverged substantially, the number of characters are fewer. As the variance in f₂ₓ values is larger as the number of characters used to calculate it becomes smaller, at some point, the variance becomes more of a concern than the possible heterogeneity of the rate processes. As the rate constant for purine-purine transitions is within 50% of the rate constant for pyrimidine-pyrimidine transitions, the tradeoff occurs approximately (and somewhat arbitrarily; it depends in reality on how different the discrimination dates are) at 100 characters. In the aromatase case, the most different pairs generate about 80 characters, and the most similar pairs generate 150 characters when purine and pyrimidine transitions are combined. Hence, these were combined.

To determine the end point, we consulted the Kazusa codon table. These are reproduced below for Homo sapiens (human), Danio rerio (fish), and Sus scrofa (pig).

Data for Homo sapiens
Homo sapiens [gbpri]: 43287 CDS's (19312280
codons)

| | | | | | |
|---|---|---|---|---|---|
| AMAcid | Codon | Number | /1000 | Fraction | . . |

| | | | | | |
|---|---|---|---|---|---|
| A | Gln | CAA | 227742.00 | 11.79 | 0.25 |
| A | Glu | GAA | 561277.00 | 29.06 | 0.42 |
| A | Lys | AAA | 462660.00 | 23.96 | 0.42 |

Total A 1251679 percent 37.44

| | | | | | |
|---|---|---|---|---|---|
| G | Gln | CAG | 668391.00 | 34.61 | 0.75 |
| G | Glu | GAG | 787712.00 | 40.79 | 0.58 |
| G | Lys | AAG | 635755.00 | 32.92 | 0.58 |

Total G 2091858 percent 62.56
Total A + G = 3343537

| | | | | | |
|---|---|---|---|---|---|
| U | Asn | AAT | 322271.00 | 16.69 | 0.46 |
| U | Asp | GAT | 430744.00 | 22.30 | 0.46 |
| U | Cys | TGT | 190962.00 | 9.89 | 0.45 |
| U | His | CAT | 201389.00 | 10.43 | 0.41 |
| U | Phe | TTT | 326146.00 | 16.89 | 0.45 |
| U | Tyr | TAT | 232240.00 | 12.03 | 0.43 |

Total T 1703752 percent 44.787

| | | | | | |
|---|---|---|---|---|---|
| C | Asn | AAC | 376210.00 | 19.48 | 0.54 |
| C | Asp | GAC | 502940.00 | 26.04 | 0.54 |
| C | Cys | TGC | 236400.00 | 12.24 | 0.55 |
| C | His | CAC | 288200.00 | 14.92 | 0.59 |
| C | Phe | TTC | 394680.00 | 20.44 | 0.55 |
| C | Tyr | TAC | 301978.00 | 15.64 | 0.57 |

Total C 2100408.00 percent 55.213
Total C + T = 1703752 + 2100408 = 3804160
3343537 + 3804160 = 7147697.00 A T G C
take the larger of each category
2100408 2091858 = 4192266
4192266/7147697 = 0.587

Data for Sus scrofa

| | | | |
|---|---|---|---|
| A | AAA | 21.3 | (8640) |
| A | CAA | 10.1 | (4096) |
| A | GAA | 24.6 | (10012) |

Sum = 22748/67667 = 33.6%

| | | | |
|---|---|---|---|
| G | AAG | 35.1 | (14249) |
| G | CAG | 34.3 | (13935) |
| G | GAG | 41.2 | (16735) |

Sum = 44919/67667 = 66.4%
Total purine-ending 2 fold redundant =
22748 + 44919 = 67667

| | | | |
|---|---|---|---|
| C | AAC | 23.2 | (9438) |
| C | CAC | 15.2 | (6160) |
| C | GAC | 28.6 | (11634) |
| C | UAC | 19.7 | (7994) |
| C | UGC | 14.9 | (6042) |
| C | UUC | 24.6 | (9989) |

Sum = 51257/83939 = 61.1%

| | | | |
|---|---|---|---|
| U | AAU | 15.2 | (6179) |
| U | CAU | 8.2 | (3344) |
| U | GAU | 19.4 | (7898) |
| U | UAU | 11.0 | (4483) |
| U | UGU | 10.0 | (4074) |
| U | UUU | 16.5 | (6704) |

Sum = 32682/83939 = 38.9%
Total pyrimidine-ending 2 fold
redundant = 32682 + 51257 = 83939

take the larger of each category
44919 + 51257 = 96176/151606 = 0.634
take the smaller of each category
22748 + 32682 = 55430/151606 = 0.366

Data for Danio rerio
Danio rerio [gbvrt]: 1528 CDS's (696043 codons)
Coding GC 51.24% 1st letter GC 53.63% 2nd letter GC
42.32% 3rd letter GC 57.77%

| | | | | |
|---|---|---|---|---|
| A | AAA | 26.4 | (18383) | A |
| A | CAA | 12.2 | (8524) | A |
| A | GAA | 21.9 | (15275) | A |

42182
42182/113599 = 0.371

| | | | | |
|---|---|---|---|---|
| G | AAG | 28.8 | (20053) | G |
| G | CAG | 33.9 | (23603) | G |
| G | GAG | 39.9 | (27761) | G |

71417
71417 + 42182 = 113599
71417/113599 = 0.629

| | | | | |
|---|---|---|---|---|
| C | AAC | 26.4 | (18365) | C |
| C | CAC | 16.6 | (11553) | C |
| C | GAC | 28.4 | (19762) | C |
| C | UAC | 18.6 | (12961) | C |
| C | UGC | 13.1 | (9101) | C |
| C UUC | 21.3 | (14848) C | | |

86590
86590
86590/149175 = 0.580

| | | | | |
|---|---|---|---|---|
| U | AAU | 16.0 | (11144) | U |
| U | CAU | 10.6 | (7392) | U |
| U | GAU | 22.7 | (15788) | U |
| U | UAU | 12.4 | (8627) | U |
| U | UGU | 11.4 | (7956) | U |
| U | UUU | 16.8 | (11678) | U |

62585
62585 + 86590 = 149175
62585/149175 = 0.420

Summing the larger
71417 + 86590 = 158007/262774 = 0.601
Summing the smaller
42182 + 62585 = 104767/262774 = 0.399

To aggregate transitions involving both purines and the pyrimidines in the analysis of codons from the three genomes, we first note that these two are about equally represented at the silent sites of two-fold redundant codon systems (3343537 cases of C and T, 3804160 cases of A and G, for a total of 7147697, in humans, for example). While in the most preferred embodiment as we combine them, we would weight them, the similarity in the two numbers makes the error arising from a failure to weight less than the variance, so we do not do so for this example.

We then take the larger of each category (purine versus pyrimidine, which is G and C respectively) and sum them (in human, 2100408+2091858.00=4192266.00) to get f_{eq}=0.59 (4192266.0000/7147697=0.587). This makes 1−f_{eq}=0.41. Thus, the end point for the exchange reaction as it approaches equilibrium=0.52 (0.35+0.17). This is the value used to convert the f₂ values to TREx kt distances. The primary data are found in Table 10.

The Kazusa database is derived from fewer Sus scrofa sequences. Nevertheless, a similar bias in codons favoring those that end in C (for pyrimidines) and those that end in G (for purines) were found. A similar bias was found in the fish. Therefore, a preliminary reconstruction of ancestral genes, given the limited data, suggests that the bias (and therefore the endpoint), remained essentially the same over the period of evolution being considered.

An estimate based on fossil records suggested a fixed single lineage first order rate constant of 3×10⁻⁹ changes per base per year (Carroll, 1988). The TREx-based dating was used to assess two alternative models to explain the triplication of aromatase gene family in pigs. The first, advanced by Callard and Tchoudakova (1997), holds that the physiological specialization of aromatases through the formation of paralogs occurred early in vertebrate divergence, perhaps 400 MYA, before fish and mammals diverged. If this were the case, then a functional explanation for the aromatase genes must be sought in fundamental features of vertebrate developmental biology, those that emerged early in vertebrate evolution. Conversely, the triplication of aromatase may occur in response to the domestication of pigs. In this case, a functional explanation for the aromatase genes would be found in the selective pressures applied by breeding programs.

The TRExs separating the three pig isoforms range from 0.15 (corresponding to a distance of 50 million years between the proteins) to 0.20 (corresponding to a distance of 65 million years). Recognizing that the total distances between two proteins are twice the distance along a single lineage from the point of divergence to the modern protein (half of the distance occurs along one lineage after divergence, and half of the distance occurs along the other lineage), the TRExs suggest that the first duplication led to the three porcine aromatase genes occurred ca. 33 MYA, and the second occurred ca. 25 MYA. An evolutionary tree constructed from these TRExs is consistent with these conclusions, showing that the porcine aromatases branched after the lineage leading to pig diverged from the lineage leading to ox. This tree shows a different branching order for the three porcine paralogs than the tree based on amino acid sequences, something not uncommon in the presence of substantial adaptive evolution. Nevertheless, the data are consistent with an evolutionary model that holds that the ancestor of pig and oxen (approximated in the fossil record most closely by the now extinct Diacodexis which lived perhaps 55 MYA) contained a single aromatase gene, and that the paralogous genes in pig arose ca. 25 million years later. Thus, the paralogs in pig can be explained neither in terms of the fundamentals of vertebrate development, nor as a consequence of swine domestication.

Instead, an understanding of why pigs have three genes for aromatase must lie in the environment of (and events that occurred during) a time on Earth 25-33 MYA. For this we turn to the paleontological, paleogeographical, and paleoclimatological records of that period, which is near the boundary between the Oligocene (38-25 MYA) and the Miocene (25-5 MYA), two epochs in the Cenozoic “Age of Mammals” (Prothero, 1994). This period is an unusual one in the history of the Earth. When characterized globally, the Earth during the Eocene (54-38 MYA) was warm and tropical, evidently free of ice over the entire planet. By the end of the Eocene, however, the Earth had begun to suffer a dramatic cooling that was to lower the mean annual temperature by as much as 15° C. (Wolfe, 1978). Areas of the planet became covered with ice. And the impact of the cooling on the biosphere was dramatic. For example, perhaps 80% of the North American faunal genera became extinct (Prothero pp 113-114; Stucky, 1990). By the end of the Oligocene and into the Miocene 25 MYA, however, the global cooling abated, the climate turned warmer, and the biosphere became more tropical.

Did this climate change occur in the environment where the ancestors of modern pigs were living just before the Oligocene-Miocene boundary? At this time, the North American and Eurasian fauna were geographically isolated. Modern peccaries (Tayassuidae), not pigs, emerged in the New World from ancestral suids that immigrated from Asia. North America cannot be the site for the triplication of the aromatase genes in pig, therefore, and its climate 25-33 MYA is irrelevant to an explanation for the triplication of the aromatase genes in pigs.

Instead, modern pigs most likely emerged in Europe near the end of the Oligocene (Cooke & Wilkinson, 1978, but see also Pilgrim, 1941) from more primitive entelodonts such as Archaeotherium. During the Oligocene, the Dichobunids (the most probable ancestral stock) were most abundant in Europe. Likewise, the first true pig, Propalaeochoerus, from the late Oligocene, was common only in Europe (Cooke and Wilkinson, 1978; Carroll, 1988). This makes the paleoenvironment of Europe near the Oligocene-Miocene boundary relevant to the functional implications of the aromatase gene triplication in pigs.

Various paleobiological evidence suggests that the climate in Europe also deteriorated in the Oligocene and warmed in the Miocene. A study of amphibian distribution in the Oligocene of Europe, for example, is consistent with a significant drop of mean annual temperatures in the European Oligocene. In the Miocene, amphibians populations rebounded, corresponding to an improvement in the climate (Rocek, 1996). Likewise, analysis of the deer population suggested a subtropical climate returning to Europe in the early Miocene (Anzanza, 1993). The Iberian peninsula in the early Miocene had an intertropical to subtropical climate (Murelaga et al., 1999). Crocodiles also returned to Europe at the Oligocene-Miocene boundary (Antunes & Cahuzac, 1999). The presence of arboreal primates in the European Miocene also suggests a forested environment (Qi & Beard 1998). Each of these facts (and many others) suggests that the second duplication of the aromatase gene in pigs occurred at the same time as the return of subtropical and warm temperate forests and woodlands to Europe, the type of environment for which suids are best adapted (Fortelius et al., 1996).

Immediately thereafter, the suids underwent a significant radiative divergence, and came to occupy all of the Old World. By the early Miocene, the two basal members that were to lead to all modern pigs, Hyotherium and Xenochoerus, were widespread in Europe, Asia, and Africa. The amelioration of the climate evidently assisted in this spread. For example, the pigs now in Africa apparently came from southwest Asia in the Early Miocene. A fossil of this date of a tetraconodontine pig has been reported from the Levant (van der Made & Tuna, 1999), through which the pigs would have migrated to get from Eurasia to Africa, and which was a tropical environment at the beginning of the Miocene (Tchernov, 1992). In the middle and late Miocene, modern suids had diversified in Europe in further response to the change in the paleoclimate (Fortelius et al., 1996).

Why might a change in climate with a return of forested (and perhaps tropical) ecosystems have led to a selection of pigs that had three different aromatase genes? We turned to porcine reproductive physiology for insight. We recently found that the type III aromatase was expressed by the embryo between day 11 and day 13 following fertilization, during the late pre-implantation period (Choi et al., 1997a,b). The estrogen generated by the type III isoform causes uterine undulation. This undulation, in turn, is expected to cause the spacing of the ca. 30 eggs that are fertilized in a typical conception, which eventually yield the 8-12 piglets that are normally birthed. In pigs, if the litter does not contain at least 5 individuals, the entire conception is aborted. Thus, the embryonic form of aromatase may have a role in spacing the embryos uniformly around the uterus, and preventing abortion. These are useful adaptations if one wants to have an increased litter size.

Evidence in the paleontological record suggests that the size of the litter in pigs increased dramatically recently, at the same time as isoform III of aromatase was generated by triplication, the local paleoclimate warmed, and the pigs began a major radiative divergence. The ancestral suid Archaeotherium, disappearing from the fossil record at the end of the Oligocene, may have given birth to a single pup. All of the contemporary forms of pigs arising from the divergence of Hyotherium and Xenochoerus, known from the Early Miocene, have large litter sizes. Further, Archaeomeryx, the early Eocene artiodactyl that is presumed to be the ancestral ruminant, resembles the contemporary chevrotain, which also births a single pup.

The biogeography of the suids was again consulted to test the hypothesis that litter size increased in the suids near the time that the climate changed and the aromatase gene triplicated. As noted above, peccaries were isolated in the New World in the Early Oligocene, before the TREx-derived date for the triplication of the aromatase gene in the Old World pigs. Consistent with the model, the peccary has only one offspring. The model predicts as well that the peccary should have only a single aromatase gene.

The molecular biological, fossil, paleoecological, and physiological evidence are all consistent with a model that proposes that climate changes in Europe at the end of the Oligocene selected for pigs that had larger litter sizes. The successful lineage generated a new embryo aromatase by gene duplication, and expressed it at the time of implantation, forming the molecular basis of the physiology that enabled large litter sizes. It is possible to speculate on why a conversion from an open, savanna like environment to a forested environment might enable larger litter sizes. Contemporary Savannah babies are large and born with the ability to run, presumably because hiding is no alternative. In contrast, in a forested environment, pups are easier to hide, permitting them to be smaller and less precocious at birth, permitting in turn a larger number of pups for the same total birth weight. Indeed, the contemporary Sus scrofa sow hides her piglets in earthen hollows covered with leaves (Eisenberg, 1981).

Implantation is one of the least well understood steps in mammalian reproductive biology, including human reproductive biology. Implantation is, of course, found only in mammal reproductive physiology, and is itself therefore a relatively recent innovation in physiology, emerging perhaps 200 million years ago. This analysis emphasizes the degree of innovation and experimentation that is continuing in mammalian reproductive physiology. Further, the analysis is a combination of computational informatics, geology, paleontology, physiology, molecular biology and chemistry. Analogous analyses should be applicable in functional genomics throughout the biological, biomedical and biochemical sciences, especially as genome projects are completed and as new tools become available to analyze genomic databases.

TABLE 10
Exchange reactions in aromatases. (a) f2 values; (b) number of characters; (c) kt TREx distances with an
equilibrium value of 0.53 UD = undetermined
(a)

| | | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| 1 | trout | 1.000 | 0.757 | 0.625 | 0.635 | 0.652 | 0.640 | 0.489 | 0.568 | 0.540 | 0.619 | 0.560 | 0.671 | 0.582 | 0.598 | 0.643 | 0.533 | 0.538 |
| 2 | medaka | 0.757 | 1.000 | 0.685 | 0.602 | 0.647 | 0.583 | 0.556 | 0.546 | 0.586 | 0.573 | 0.562 | 0.674 | 0.663 | 0.688 | 0.642 | 0.500 | 0.480 |
| 3 | zebrafish | 0.625 | 0.685 | 1.000 | 0.810 | 0.674 | 0.602 | 0.580 | 0.604 | 0.598 | 0.559 | 0.570 | 0.511 | 0.489 | 0.613 | 0.607 | 0.630 | 0.611 |
| 4 | goldfish | 0.635 | 0.602 | 0.810 | 1.000 | 0.677 | 0.649 | 0.535 | 0.629 | 0.600 | 0.571 | 0.554 | 0.483 | 0.517 | 0.538 | 0.545 | 0.581 | 0.583 |
| | ov | | | | | | | | | | | | | | | | | |
| 5 | catfish | 0.652 | 0.647 | 0.674 | 0.677 | 1.000 | 0.598 | 0.518 | 0.565 | 0.581 | 0.558 | 0.500 | 0.615 | 0.644 | 0.621 | 0.565 | 0.556 | 0.582 |
| 6 | goldfish br | 0.640 | 0.583 | 0.602 | 0.649 | 0.598 | 1.000 | 0.525 | 0.573 | 0.564 | 0.520 | 0.550 | 0.532 | 0.521 | 0.530 | 0.530 | 0.550 | 0.539 |
| 7 | pig | 0.489 | 0.556 | 0.580 | 0.535 | 0.518 | 0.525 | 1.000 | 0.920 | 0.910 | 0.848 | 0.819 | 0.706 | 0.727 | 0.765 | 0.810 | 0.603 | 0.643 |
| | placenta | | | | | | | | | | | | | | | | | |
| 8 | pig fetal | 0.568 | 0.546 | 0.604 | 0.629 | 0.565 | 0.573 | 0.920 | 1.000 | 0.929 | 0.842 | 0.837 | 0.703 | 0.689 | 0.727 | 0.808 | 0.608 | 0.643 |
| 9 | pig ovary | 0.540 | 0.586 | 0.598 | 0.600 | 0.581 | 0.564 | 0.910 | 0.929 | 1.000 | 0.843 | 0.837 | 0.706 | 0.715 | 0.753 | 0.861 | 0.623 | 0.654 |
| 10 | ox | 0.619 | 0.573 | 0.559 | 0.571 | 0.558 | 0.520 | 0.848 | 0.842 | 0.843 | 1.000 | 0.813 | 0.719 | 0.715 | 0.760 | 0.824 | 0.638 | 0.659 |
| 11 | horse | 0.560 | 0.562 | 0.570 | 0.554 | 0.500 | 0.550 | 0.819 | 0.837 | 0.837 | 0.813 | 1.000 | 0.739 | 0.741 | 0.748 | 0.819 | 0.646 | 0.620 |
| 12 | mouse | 0.671 | 0.674 | 0.511 | 0.483 | 0.615 | 0.532 | 0.706 | 0.703 | 0.706 | 0.719 | 0.739 | 1.000 | 0.871 | 0.736 | 0.748 | 0.584 | 0.569 |
| 13 | rat | 0.582 | 0.663 | 0.489 | 0.517 | 0.644 | 0.521 | 0.727 | 0.689 | 0.715 | 0.715 | 0.741 | 0.871 | 1.000 | 0.764 | 0.754 | 0.591 | 0.580 |
| 14 | rabbit | 0.598 | 0.688 | 0.613 | 0.538 | 0.621 | 0.530 | 0.765 | 0.727 | 0.753 | 0.760 | 0.748 | 0.736 | 0.764 | 1.000 | 0.813 | 0.579 | 0.610 |
| 15 | human | 0.643 | 0.642 | 0.607 | 0.545 | 0.565 | 0.530 | 0.810 | 0.808 | 0.861 | 0.824 | 0.819 | 0.748 | 0.754 | 0.813 | 1.000 | 0.600 | 0.615 |
| 16 | chicken | 0.533 | 0.500 | 0.630 | 0.581 | 0.556 | 0.550 | 0.603 | 0.608 | 0.623 | 0.638 | 0.646 | 0.584 | 0.591 | 0.579 | 0.600 | 1.000 | 0.771 |
| 17 | finch | 0.538 | 0.480 | 0.611 | 0.583 | 0.582 | 0.539 | 0.643 | 0.643 | 0.654 | 0.659 | 0.620 | 0.569 | 0.580 | 0.610 | 0.615 | 0.771 | 1.000 |

(b)

| | | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| 1 | trout | 190 | 152 | 120 | 115 | 112 | 111 | 88 | 88 | 87 | 84 | 91 | 79 | 79 | 87 | 84 | 90 | 93 |
| 2 | medaka | 152 | 185 | 124 | 123 | 119 | 108 | 99 | 97 | 99 | 96 | 96 | 92 | 92 | 96 | 95 | 94 | 98 |
| 3 | zebrafish | 120 | 124 | 186 | 163 | 129 | 113 | 88 | 91 | 92 | 93 | 93 | 88 | 88 | 93 | 89 | 92 | 95 |
| 4 | goldfish | 115 | 123 | 163 | 179 | 127 | 111 | 86 | 89 | 90 | 91 | 92 | 87 | 87 | 91 | 88 | 93 | 96 |
| | ov | | | | | | | | | | | | | | | | | |
| 5 | catfish | 112 | 119 | 129 | 127 | 186 | 107 | 85 | 85 | 86 | 86 | 90 | 91 | 90 | 87 | 85 | 90 | 91 |
| 6 | goldfish br | 111 | 108 | 113 | 111 | 107 | 192 | 101 | 103 | 101 | 98 | 100 | 94 | 94 | 100 | 100 | 100 | 102 |
| 7 | pig | 88 | 99 | 88 | 86 | 85 | 101 | 194 | 175 | 166 | 158 | 144 | 136 | 132 | 149 | 153 | 126 | 129 |
| | placenta | | | | | | | | | | | | | | | | | |
| 8 | pig fetal | 88 | 97 | 91 | 89 | 85 | 103 | 175 | 191 | 168 | 165 | 147 | 138 | 135 | 154 | 156 | 125 | 129 |
| 9 | pig ovary | 87 | 99 | 92 | 90 | 86 | 101 | 166 | 168 | 191 | 166 | 147 | 143 | 137 | 154 | 158 | 130 | 133 |
| 10 | ox | 84 | 96 | 93 | 91 | 86 | 98 | 158 | 165 | 166 | 183 | 150 | 139 | 137 | 154 | 159 | 127 | 132 |
| 11 | horse | 91 | 96 | 93 | 92 | 90 | 100 | 144 | 147 | 147 | 150 | 189 | 142 | 139 | 147 | 149 | 130 | 137 |
| 12 | mouse | 79 | 92 | 88 | 87 | 91 | 94 | 136 | 138 | 143 | 139 | 142 | 183 | 171 | 144 | 143 | 125 | 130 |
| 13 | rat | 79 | 92 | 88 | 87 | 90 | 94 | 132 | 135 | 137 | 137 | 139 | 171 | 181 | 140 | 142 | 127 | 131 |
| 14 | rabbit | 87 | 96 | 93 | 91 | 87 | 100 | 149 | 154 | 154 | 154 | 147 | 144 | 140 | 178 | 155 | 133 | 136 |
| 15 | human | 84 | 95 | 89 | 88 | 85 | 100 | 153 | 156 | 158 | 159 | 149 | 143 | 142 | 155 | 183 | 130 | 135 |
| 16 | chicken | 90 | 94 | 92 | 93 | 90 | 100 | 126 | 125 | 130 | 127 | 130 | 125 | 127 | 133 | 130 | 181 | 170 |
| 17 | finch | 93 | 98 | 95 | 96 | 91 | 102 | 129 | 129 | 133 | 132 | 137 | 130 | 131 | 136 | 135 | 170 | 188 |

(c)

| | | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| 1 | trout | 0.00 | 0.73 | 1.60 | 1.50 | 1.35 | 1.45 | U.D | 2.51 | 3.85 | 1.66 | 2.75 | 1.20 | 2.20 | 1.93 | 1.42 | 5.05 | 4.07 |
| 2 | medaka | 0.73 | 0.00 | 1.11 | 1.88 | 1.39 | 2.18 | 2.89 | 3.38 | 2.13 | 2.39 | 2.69 | 1.18 | 1.26 | 1.09 | 1.43 | U.D | U.D |
| 3 | zebrafish | 1.60 | 1.11 | 0.00 | 0.52 | 1.18 | 1.88 | 2.24 | 1.85 | 1.93 | 2.78 | 2.46 | U.D | U.D | 1.73 | 1.81 | 1.55 | 1.76 |
| 4 | goldfish | 1.50 | 1.88 | 0.52 | 0.000 | 1.16 | 1.37 | 4.54 | 1.56 | 1.90 | 2.44 | 2.97 | U.D | U.D | 4.07 | 3.44 | 2.22 | 2.18 |
| | ov | | | | | | | | | | | | | | | | | |
| 5 | catfish | 1.35 | 1.39 | 1.18 | 1.16 | 0.00 | 1.93 | U.D | 2.60 | 2.22 | 2.82 | U.D | 1.71 | 1.42 | 1.64 | 2.60 | 2.89 | 2.20 |
| 6 | goldfish br | 1.45 | 2.18 | 1.88 | 1.37 | 1.93 | 0.00 | U.D | 2.39 | 2.63 | U.D | 3.16 | 5.46 | U.D | U.D | U.D | 3.16 | 3.95 |
| 7 | pig | U.D | 2.89 | 2.24 | 4.54 | U.D | U.D | 0.00 | 0.19 | 0.21 | 0.39 | 0.49 | 0.98 | 0.87 | 0.69 | 0.52 | 1.86 | 1.42 |
| | placenta | | | | | | | | | | | | | | | | | |
| 8 | pig fetal | 2.51 | 3.38 | 1.85 | 1.56 | 2.60 | 2.39 | 0.19 | 0.00 | 0.16 | 0.41 | 0.42 | 1.00 | 1.08 | 0.87 | 0.52 | 1.80 | 1.42 |
| 9 | pig ovary | 3.85 | 2.13 | 1.93 | 1.90 | 2.22 | 2.63 | 0.21 | 0.16 | 0.00 | 0.41 | 0.42 | 0.98 | 0.93 | 0.74 | 0.35 | 1.62 | 1.33 |
| 10 | ox | 1.66 | 2.39 | 2.78 | 2.44 | 2.82 | U.D | 0.39 | 0.41 | 0.41 | 0.000 | 0.51 | 0.91 | 0.93 | 0.71 | 0.47 | 1.47 | 1.29 |
| 11 | horse | 2.75 | 2.69 | 2.46 | 2.97 | U.D | 3.16 | 0.49 | 0.42 | 0.42 | 0.51 | 0.00 | 0.81 | 0.80 | 0.77 | 0.49 | 1.40 | 1.65 |
| 12 | mouse | 1.20 | 1.18 | U.D | U.D | 1.71 | 5.46 | 0.98 | 1.00 | 0.98 | 0.91 | 0.81 | 0.00 | 0.32 | 0.82 | 0.77 | 2.16 | 2.49 |
| 13 | rat | 2.20 | 1.26 | U.D | U.D | 1.42 | U.D | 0.87 | 1.08 | 0.93 | 0.93 | 0.80 | 0.32 | 0.00 | 0.70 | 0.74 | 2.04 | 2.24 |
| 14 | rabbit | 1.93 | 1.09 | 1.73 | 4.07 | 1.64 | U.D | 0.69 | 0.87 | 0.74 | 0.71 | 0.77 | 0.82 | 0.70 | 0.00 | 0.51 | 2.26 | 1.77 |
| 15 | human | 1.42 | 1.43 | 1.81 | 3.44 | 2.60 | U.D | 0.52 | 0.52 | 0.35 | 0.47 | 0.49 | 0.77 | 0.74 | 0.51 | 0.00 | 1.90 | 1.71 |
| 16 | chicken | 5.05 | U.D | 1.55 | 2.22 | 2.89 | 3.16 | 1.86 | 1.80 | 1.62 | 1.47 | 1.40 | 2.16 | 2.04 | 2.26 | 1.90 | 0.00 | 0.67 |
| 17 | finch | 4.07 | U.D | 1.76 | 2.18 | 2.20 | 3.95 | 1.42 | 1.42 | 1.33 | 1.29 | 1.65 | 2.49 | 2.24 | 1.77 | 1.71 | 0.67 | 0.00 |

Fish versus birds 6.683/12 = 0.557
Fish versus mammals 30.875/54 = 0.572
Fish versus mammmals and birds. 1-6 versus 7-17 = 37.558/66 = 0.569
Birds versus mammals: 16 and 17 versus 7-15 11.065/18 = 0.615
Rodents from ox versus horse 10 and 11 versus 12 and 13: 2.914/4 = 0.729

References for Example 6

Akhtar, M., LeeRobichaud, P., Akhtar, M. E., Wright, J. N. (1997) The impact of aromatase mechanism on other P450s. J. Steroid Biochem. Mol. Biol. 61, 127-132.

Antunes, M. T., Cahuzac, B. (1999) Crocodilian faunal renewal in the Upper Oligocene of Western Europe. Comptes Rend. L'Acad. Sci. Serie II Fascicule A-Sci. Terre Planetes. 328, 67-72.

Azanza, B. (1993) Systematics and evolution of the genus Procervulus (Cervidae, Artiodactyla, Mammalia) of the lower Miocene of Europe. Comptes Rend. L'Acad. Sci. Serie II. 316, 717-723.

Benner, S. A., Cannarozzi, G., Chelvanayagam, G., Turcotte, M. (1997) Bona fide predictions of protein secondary structure using transparent analyses of multiple sequence alignments. Chem. Rev. 97, 2725-2843.

Benner, S. A., Trabesinger-Ruef, N., Schreiber, D. R. (1998) Exobiology and post-genomic science. Converting primary structure into physiological function. Adv. Enzyme Regul. 38, 155-180.

Boerboom, D., Kerban, A., Sirois, J. (1997) Molecular characterization of the equine cytochrome P450 aromatase cDNA and its regulation in preovulatory follicles. Biol. Reprod. 56, 479-479, Suppl. 1.

Buck, C. D. (1988) A Dictionary of Selected Synonyms in the Principal European Languages. Chicago, University of Chicago Press, Paperback ed., p. 160.

Callard, G. V., Tchoudakova, A. (1997) Evolutionary and functional significance of two CYP19 genes differentially expressed in brain and ovary of goldfish. J. Steroid Biochem. Mol. Biol. 61, 387-392.

Callard, G. V., Pudney, J. A., Kendall, S. L., Reinboth, R. (1984) In vitro conversion of androgen to estrogen in Amphioxus gonadal tissues. Gen. Comp. Endocrinol. 56, 53-58.

Carroll, R. L. (1988) Vertebrate Paleontology and Evolution. N.Y., Freeman.

Chang, X. T., Kobayashi, T., Kajiura, H., Nakamura, M., Nagahama, Y. (1997) Isolation and characterization of the cDNA encoding the tilapia (Oreochromis niloticus) cytochrome P450 aromatase (P450arom), Changes in P450arom mRNA, protein and enzyme activity in ovarian follicles during oogenesis. J. Mol. Endocrinol. 18, 57-66.

Choi, I., Collante, W. R., Simmen, R. C. M., Simmen, F. A. (1997a) A developmental switch in expression from blastocyst to endometrial/placental-type cytochrome p450 aromatase genes in the pig and horse. Biol. Reprod. 56, 688-696.

Choi, I. H., Troyer, D. L., Cornwell, D. L., Kirby-Dobbels, K. R., Collante, W. R., Simmen, F. A. (1997b) Closely related genes encode developmental and tissue isoforms of porcine cytochrome P450 aromatase. DNA Cell. Biol. 16,769-777.

Choi, I., Simmen, R. C. M., Simmen, F. A. (1996) Molecular cloning of cytochrome P450 aromatase complementary deoxyribonucleic acid from periimplantation porcine and equine blastocysts identifies multiple novel 5′-untranslated exons expressed in embryos, endometrium, and placenta. Endocrinol. 137, 1457-1467.

Colbert, E. H. (1941) The osteology and relationships of Archaeomeryx, an ancestral ruminant. Amer. Mus. Novit. 1135, 1-24.

Conley, A., Corbin, J., Smith, T., Hinshelwood, M., Liu, Z., Simpson, E. (1997) Porcine aromatases, studies on tissue-specific functionally distinct isozymes from a single gene? J. Steroid Biochem. Mol. Biol. 61, 407-413.

Conley, A. J., Corbin, C. J., Hinshelwood, M. M., Liu, Z., Simpson, E. R., Ford, J. J., Harada, N. (1996) Functional aromatase expression in porcine adrenal gland and testis. Biol Reprod. 54,497-505.

Cooke, H. B. S., Wilkinson, A. F. (1978) Suidae and Tayassuidae, in Evolution of African Mammals, V. J. Maglio and H. B. S. Cooke, eds. Cambridge, Harvard University Press, 438-482.

Delarue, B., Breard, E., Mittre, H., Leymarie, P. (1998) Expression of two aromatase cDNAs in various rabbit tissues. J. Steroid Biochem. Mol. Biol. 64, 113-119.

Delarue, B., Mittre, H., Feral, C., Benhaim, A., Leymarie, P. (1996) Rapid sequencing of rabbit aromatase cDNA using RACE PCR. Comptes Rend. L'Acad. Sci. Serie III Sciences De La Vie-Life Sciences 319,663-670.

Eisenberg, J. F. (1981) The Mammalian Radiations. An Analysis of Trends in Evolution, Adaptation, and Behavior. Chicago, Univ. Chicago Press, p 196.

Fitch, W. (1971) Towards defining the course of evolution. Minimum change for a specific tree topology. Syst. Zoology 20, 406-416.

Fortelius, M., van der Made, J., Bernor, R. L. (1996) Middle and Late Miocene Suoidea of Central Europe and the Eastern Mediterranea, Evolution, Biogeography and Paleoecology. in The Evolution of Western Eurasian Neogene Mammal Fanas. R. L. Bernor, V. Fahlbusch, and H.-W. Mittmann eds. Columbia Univ. Press, 348-377.

Fürbaβ R, Vanselow J. (1995) An aromatase pseudogene is transcribed in the bovine placenta. Gene 154,287-291.

Gonnet, G. H., Benner, S. A. (1991) Computational Biochemistry Research at ETH. Technical Report 154, Departement Informatik, March, 1991.

Gonzalez, F. J., Nebert, D. W. (1990) Evolution of the P450-gene superfamily. Animal plant warfare, molecular drive and human genetic-differences in drug oxidation. Trends Genet. 6, 182-186.

Harada, N. (1988) Cloning of a complete cDNA encoding human aromatase, immunochemical identification and sequence analysis. Biochem. Biophys. Res. Comm. 156, 725-732.

Hickey, G. J., Krasnow, J. S., Beattie, W. G., Richards, J. S. (1990) Aromatase cytochrome P450 in rat ovarian granulosa cells before and after luteinization. Adenosine 3′,5′-monophosphate-dependent and independent regulation. Cloning and sequencing of rat aromatase cDNA and 5′ genomic DNA. Mol. Endocrinol. 4, 3-12.

Hinshelwood, M. M., Corbin, C. J., Tsang, P. C. and Simpson, E. R. (1993) Isolation and characterization of a complementary deoxyribonucleic acid insert encoding bovine aromatase cytochrome P450. Endocrinology 133, 1971-1977.

Jukes, T. H., Cantor, C. R. (1969) Evolution of proteins molecules. in Mammalian Protein Metabolism, H. N. Munro, ed. N.Y. Academic Press, pp. 21-123.

Kimura, M. (1980) A simple method for estimating evolutionary rates of base substitution through comparative studies of nucleotide sequences. J. Mol. Evol. 16, 111-120.

Li, W.-H., Wu, C.-I., Luo, C.-C. (1985) A new method for estimating synonymous and non-synonymous rates of nucleotide substitution considering the relative likelihood of nucleotide and codon changes. Mol. Biol. Evol. 2, 150-174.

Liberles, D. A., Caraco, M. D., Benner, S. A. (1999) Using neutral evolutionary distances to estimate the dates of divergence of proteins. in preparation.

McPhaul, M. J., Noble, J. F., Simpson, E. R., Mendelson, C. R., Wilson, J. D. (1988) The expression of a functional cDNA encoding the chicken cytochrome P-450-arom (aromatase) that catalyzes the formation of estrogen from androgen. J. Biol. Chem. 263, 16358-16363.

Messier, W., Stewart, C. B. (1997) Episodic adaptive evolution of primate lysozymes (1997) Nature 385,151-154.

Murelaga, X., de Broin, F. D., Suberbiola, X. P., Astibia, H. (1999) Two new chelonian species from the Lower Miocene of the Ebro Basin (Bardenas Reales of Navarre). Comptes Rend. L'Acad. Sci. Serie II Fascicule A-Sci. Terre Planetes. 328, 423-429.

Nebert, D. W., Nelson, D. R., Coon, M. J., Estabrook, R. W., Feyereisen, R., Fujiikuriyama, Y., Gonzalez, F. J., Guengerich, F. P., Gunsalus, I. C., Johnson, E. F., Loper, J. C., Sato, R., Waterman, M. R., Waxman, D. J. (1991) The P450 superfamily. Update on new sequences, gene-mapping, and recommended nomenclature. DNA Cell Biol. 10,1-14.

Pilgrim, G. E. (1941) The dispersal of the Artiodactyla, Biol. Rev., 16, 134-163.

Prothero, D. R. (1994) The Eocene-Oligocene Transition, Paradise Lost NY, Columbia Univ. Press.

Qi, T., Beard, K. C. (1998) Late Eocene sivaladapid primate from Guangxi Zhuang Autonomous Region, People's Republic of China. J. Human Evol. 35, 211-220.

Rocek, Z. (1996) The salamander Brachycormus noachicus from the Oligocene of Europe, and the role of neoteny in the evolution of salamanders. Palaeontology 39, 477-495.

Rose, K. D. (1982) Skeleton of Diacodexis, oldest known artiodactyl. Science 236, 621-623.

Savage, R. J. G., Long M. R. (1986) Mammal Evolution. An Illustrated Guide. N.Y., Facts on File Publ., p 213.

Scott, W. B. (1937) A History of Land Mammals in the Western Hemisphere. N.Y. McMillan.

Shen, P., Campagnoni, C. W., Kampf, K., Schlinger, B. A., Arnold, A. P., Campagnoni, A. T. (1994) Isolation and characterization of a zebra finch aromatase cDNA. In situ hybridization reveals high aromatase expression in brain. Brain Res. Mol. Brain Res. 24, 227-237.

Simpson, E. R., Michael, M. D., Agarwal, V. R., Hinshelwood, M. M., Bulun, S. E., Zhao, Y. (1997) Expression of the CYP19 (aromatase) gene. An unusual case of alternative promoter usage. FASEB J., 11, 29-36.

Stewart, C. B., Schilling, J. W., Wilson, A. C. (1987) Adaptive evolution in the stomach lysozymes of foregut fermenters. Nature 330, 401-404.

Stucky, R. K. (1990) Evolution of land mammal diversity in North America during the Cenozoic. Curr. Mammalogy 2, 375-432.

Tanaka, M., Fukada, S., Matsuyama, M., Nagahama, Y. (1995) Structure and promoter analysis of the cytochrome P-450 aromatase gene of the teleost fish, medaka (Oryzias latipes). J. Biochem. 117, 719-725.

Tchernov, E. (1992) The Afro-Arabian component in the levantine mammalian fauna. A short biogeographical review. Israel J. Zoology 38, (3-4) 155-192.

Terashima, M., Toda, K., Kawamoto, T., Kuribayashi, I., Ogawa, Y., Maeda, T., Shizuta, Y. (1991) Isolation of a full-length cDNA encoding mouse aromatase P450. Arch. Biochem. Biophys. 285, 231-237.

Trabesinger-Ruef, N., Jermann, T. M., Zankel, T. R., Durrant, B., Frank, G., Benner, S. A. (1996) Pseudogenes in ribonuclease evolution. A source of new biomacromolecular function? FEBS Lett. 382, 319-322.

Trant, J. M. (1994) Isolation and characterization of the cDNA encoding the channel catfish (Ictalurus punctatus) form of cytochrome P450arom. Gen. Comp. Endocrinol. 95, 155-168.

van der Made J, Tuna V. (1999) A tetraconodontine pig from the Upper Miocene of Turkey. Trans. Royal Soc. Edinburgh. Earth Sci. 89, 227-230.

Wolfe, J. A. (1978) A paleobotanical interpretation of Tertiary climates in the Northern Hemisphere. American Sci. 66, 694-703.

### Example 7

### C. elegans paralogs

TREx distances are especially useful when comparing paralogs. Here, we need not worry so much about codon bias (it has at least been uniform among paralogs at any instant in evolutionary history). For example, we used the Master Catalog to identify all families of paralogs in the genome of C. elegans. Ca. 1250 families of paralogs with four or more members is found. We separated the families into in various classes using TREx dates.

(a) Families where duplications all occurred>400 MYA

(b) Families where duplications all occurred<100 MYA

(c) Families where duplications have been ongoing throughout the past 400 MY.

(d) Families with duplications in specific episodes.

(e) Families showing a history of duplication>400 MYA, but also having more recent episodes of recruitment.

TABLE 11
Some families paralogs from C. elegans
recording when divergence occured.

| | Number of nodes generating | | | | |
|---|---|---|---|---|---|
| | paralogs in indicated time | | | | |
| MYA | 0-100 | 100-200 | 200-300 | 300-400 | >400 |
| gprod_19987 | 39 | 1 | 4 | 0 | 5 |
| Mariner transposase | | | | | |
| gprod_31705 | 6 | 0 | 0 | 0 | 0 |
| similar to reverse | | | | | |
| transcriptase | | | | | |
| gprod_32709 | 11 | 3 | 0 | 0 | 1 |
| Histone H2A | | | | | |
| gprod_7894 | 5 | 2 | 0 | 0 | 2 |
| No definition line | | | | | |
| gprod_19811 | 5 | 2 | 3 | 5 | 39 |
| Serine-threonine | | | | | |
| kinase. | | | | | |

If the reviewer is a biomedical scientist, the Table immediately suggests ideas. Consider the family annotated as a serine-threonine kinase. It has 145 members in the Master Catalog; 55 or these are from elegans. The kinases generated by the recent duplications cannot part of the basic developmental plan of elegans; this was established 500 MYA. This raises questions: What is it about the serine-threonine kinases that recently diverged that might have something to do with recently evolved physiology? We then examine the Kₐ/Kₛ value within the Master Catalog trees, all with a click of a mouse button. We hypothesize which descendants of recent duplications performing the derived function, and which perform the primitive function. Dating the divergence, we try to make statements about changes in nematode biology that might be associated with the duplication. These hypotheses can now be tested by experiment (knock-outs, in particular). Table 11 collects these

TABLE 12
Some more families paralogs from C. elegans recording when divergence occured.

| | A | B | C | D | E | F | average | |
|---|---|---|---|---|---|---|---|---|
| family | 0-0.5 | 0.5-1.0 | 1.0-1.5 | 1.5-2.0 | 2.0-2.5 | sum | #char | description |
| gprod_1025 | 0 | 0 | 0 | 0 | 5 | 5 | 143.4 | |
| gprod_1063 | 0 | 0 | 1 | 0 | 2 | 3 | 46 | |
| gprod_1069 | 0 | 0 | 1 | 0 | 2 | 3 | 3 | |
| gprod_10729 | 1 | 0 | 0 | 0 | 3 | 4 | 143.5 | |
| gprod_10751 | 0 | 0 | 1 | 0 | 5 | 6 | 204.667 | |
| gprod_1090 | 0 | 0 | 0 | 0 | 3 | 3 | 35.3333 | |
| gprod_1110 | 0 | 0 | 1 | 2 | 1 | 4 | 151.75 | |
| gprod_1129 | 0 | 0 | 0 | 0 | 3 | 3 | 89.6667 | |
| gprod_11679 | 0 | 0 | 0 | 0 | 3 | 3 | 48.3333 | |
| gprod_1240 | 0 | 0 | 0 | 0 | 4 | 4 | 146 | |
| gprod_12669 | 1 | 0 | 0 | 0 | 2 | 3 | 35 | |
| gprod_1273 | 1 | 0 | 0 | 0 | 3 | 4 | 153 | |
| gprod_12815 | 0 | 0 | 0 | 0 | 3 | 3 | 36 | |
| gprod_1318 | 0 | 0 | 1 | 1 | 1 | 3 | 59.6667 | |
| gprod_13259 | 0 | 0 | 1 | 1 | 6 | 8 | 55.875 | |
| gprod_1354 | 0 | 0 | 0 | 0 | 3 | 3 | 152 | |
| gprod_13591 | 0 | 0 | 0 | 0 | 5 | 5 | 116.8 | |
| gprod_1405 | 0 | 0 | 0 | 1 | 1 | 2 | 222 | |
| gprod_14189 | 0 | 0 | 2 | 0 | 14 | 16 | 601.625 | similar to tubulin alpha-2 chain |
| gprod_1468 | 0 | 0 | 0 | 0 | 2 | 2 | 18 | |
| gprod_1471 | 0 | 0 | 0 | 0 | 2 | 2 | 95 | |
| gprod_15094 | 0 | 0 | 0 | 0 | 4 | 4 | 56 | adenylate kinase |
| gprod_15198 | 0 | 0 | 1 | 0 | 2 | 3 | 41.6667 | 4-nitrophenylphosphatases |
| gprod_15375 | 0 | 0 | 0 | 0 | 5 | 5 | 42.8 | Ce mostly, similar to triacylgycerol |
| | | | | | | | | lipases |
| gprod_15390 | 1 | 0 | 0 | 3 | 13 | 17 | 916.529 | guanylate cyclases, cat. domain |
| | | | | | | | | protein kinases |
| gprod_15452 | 0 | 0 | 0 | 1 | 11 | 12 | 616.75 | weak similarity to nodulation |
| | | | | | | | | protein X |
| gprod_15464 | 2 | 0 | 0 | 0 | 5 | 7 | 242.429 | serine protease inhibitor |
| gprod_15559 | 0 | 0 | 0 | 0 | 2 | 2 | 272 | clathrin coat assembly like protein |
| gprod_15565 | 0 | 0 | 1 | 0 | 5 | 6 | 68 | |
| gprod_15577 | 0 | 0 | 0 | 0 | 7 | 7 | 37 | |
| gprod_15586 | 1 | 0 | 0 | 0 | 2 | 3 | 35.3333 | |
| gprod_15588 | 0 | 0 | 1 | 0 | 4 | 5 | 135.2 | |
| gprod_15724 | 1 | 0 | 0 | 0 | 2 | 3 | 60.3333 | |
| gprod_15801 | 0 | 0 | 0 | 1 | 2 | 3 | 157.667 | elongation factor EF |
| gprod_15805 | 0 | 0 | 0 | 2 | 3 | 5 | 330.4 | |
| gprod_15819 | 0 | 0 | 2 | 0 | 5 | 7 | 169 | putative integral membrane |
| | | | | | | | | transport protein |
| gprod_15877 | 0 | 0 | 1 | 1 | 1 | 3 | 11.6667 | |
| gprod_15878 | 2 | 0 | 0 | 1 | 0 | 3 | 1032 | glyceraldehyde 3-phosphate |
| | | | | | | | | dehydrogenase |
| gprod_15899 | 0 | 0 | 0 | 0 | 3 | 3 | 61 | |
| gprod_15929 | 0 | 0 | 3 | 2 | 5 | 10 | 108.5 | |
| gprod_15937 | 0 | 0 | 0 | 1 | 2 | 3 | 31 | |
| gprod_15971 | 0 | 0 | 1 | 0 | 0 | 1 | 216 | |
| gprod_15974 | 1 | 0 | 1 | 0 | 2 | 4 | 29.5 | |
| gprod_16058 | 2 | 0 | 0 | 0 | 0 | 2 | 651.5 | |
| gprod_16059 | 0 | 0 | 0 | 1 | 1 | 2 | 121 | |
| gprod_16306 | 4 | 0 | 0 | 0 | 0 | 4 | 1220 | |
| gprod_16402 | 1 | 0 | 0 | 0 | 4 | 5 | 81.4 | |
| gprod_16477 | 0 | 0 | 0 | 0 | 0 | 0 | 0 | |
| gprod_16653 | 0 | 0 | 0 | 1 | 2 | 3 | 73.6667 | |
| gprod_16715 | 0 | 0 | 0 | 0 | 3 | 3 | 81 | |
| gprod_1689 | 0 | 0 | 1 | 0 | 3 | 4 | 102.25 | |
| gprod_16897 | 0 | 0 | 0 | 0 | 4 | 4 | 80.25 | |
| gprod_16898 | 0 | 0 | 1 | 1 | 3 | 5 | 40.2 | |
| gprod_17379 | 2 | 0 | 1 | 0 | 0 | 3 | 502 | |
| gprod_1740 | 0 | 0 | 0 | 1 | 3 | 4 | 91.75 | |
| gprod_17677 | 0 | 0 | 0 | 0 | 4 | 4 | 72.5 | |
| gprod_1825 | 0 | 0 | 0 | 0 | 4 | 4 | 162.5 | |
| gprod_19415 | 0 | 0 | 0 | 0 | 4 | 4 | 342 | |
| gprod_19478 | 0 | 0 | 0 | 1 | 3 | 4 | 34.25 | |
| gprod_19775 | 0 | 0 | 0 | 0 | 1 | 1 | 460 | |
| gprod_19789 | 0 | 0 | 0 | 1 | 3 | 4 | 205.5 | |
| gprod_19814 | 2 | 0 | 1 | 0 | 3 | 6 | 183.833 | |
| gprod_19828 | 0 | 0 | 1 | 0 | 8 | 9 | 115.222 | |
| gprod_19849 | 0 | 0 | 0 | 0 | 3 | 3 | 80.3333 | |
| gprod_19867 | 2 | 0 | 1 | 1 | 12 | 16 | 227.625 | |
| gprod_19899 | 0 | 0 | 1 | 2 | 4 | 7 | 100.143 | |
| gprod_19925 | 0 | 0 | 0 | 0 | 3 | 3 | 20.3333 | |
| gprod_19926 | 0 | 0 | 1 | 1 | 7 | 9 | 121.556 | |
| gprod_19931 | 0 | 0 | 0 | 0 | 0 | 0 | 0 | |
| gprod_19938 | 1 | 0 | 2 | 0 | 0 | 3 | 1151.33 | |
| gprod_19967 | 0 | 0 | 0 | 0 | 1 | 1 | 276 | |
| gprod_19971 | 4 | 0 | 0 | 0 | 3 | 7 | 418.571 | |
| gprod_19979 | 0 | 0 | 0 | 0 | 1 | 1 | 200 | |
| gprod_19983 | 0 | 0 | 0 | 0 | 7 | 7 | 116.429 | |
| gprod_20015 | 4 | 0 | 0 | 1 | 7 | 12 | 989.333 | |
| gprod_20024 | 0 | 0 | 1 | 0 | 2 | 3 | 61.3333 | |
| gprod_20031 | 1 | 0 | 2 | 0 | 2 | 5 | 39.6 | |
| gprod_20077 | 2 | 0 | 0 | 0 | 1 | 3 | 1050.67 | |
| gprod_20083 | 3 | 0 | 0 | 0 | 0 | 3 | 438 | |
| gprod_20110 | 0 | 0 | 0 | 0 | 1 | 1 | 212 | |
| gprod_20113 | 0 | 0 | 1 | 2 | 4 | 7 | 227.286 | |
| gprod_20115 | 0 | 0 | 0 | 0 | 6 | 6 | 213.833 | |
| gprod_20122 | 0 | 0 | 0 | 0 | 6 | 6 | 108.5 | |
| gprod_20124 | 1 | 0 | 3 | 0 | 9 | 13 | 95.3846 | |
| gprod_20125 | 0 | 0 | 1 | 0 | 2 | 3 | 79.3333 | |
| gprod_20126 | 0 | 0 | 4 | 0 | 7 | 11 | 62.8182 | |
| gprod_20154 | 0 | 0 | 0 | 1 | 5 | 6 | 138 | |
| gprod_20156 | 0 | 0 | 1 | 2 | 3 | 6 | 91 | |
| gprod_20169 | 0 | 0 | 4 | 4 | 11 | 19 | 939.842 | |
| gprod_20173 | 1 | 0 | 2 | 0 | 0 | 3 | 491.667 | |
| gprod_20188 | 0 | 0 | 1 | 1 | 7 | 9 | 95.8889 | |
| gprod_20196 | 0 | 0 | 1 | 0 | 7 | 8 | 197.5 | |
| gprod_20238 | 0 | 0 | 0 | 0 | 5 | 5 | 118.8 | |
| gprod_20244 | 0 | 0 | 0 | 0 | 3 | 3 | 82 | |
| gprod_20245 | 0 | 0 | 1 | 0 | 2 | 3 | 25.3333 | |
| gprod_20270 | 0 | 0 | 0 | 0 | 2 | 2 | 77 | |
| gprod_20295 | 1 | 0 | 1 | 0 | 7 | 9 | 274.111 | |
| gprod_20307 | 1 | 0 | 1 | 0 | 1 | 3 | 22 | |
| gprod_20367 | 0 | 0 | 0 | 0 | 2 | 2 | 97 | |
| gprod_20414 | 0 | 0 | 0 | 2 | 1 | 3 | 125.333 | |
| gprod_20418 | 0 | 0 | 1 | 0 | 2 | 3 | 154.333 | |
| gprod_20535 | 0 | 0 | 0 | 0 | 2 | 2 | 399 | |
| gprod_20557 | 0 | 0 | 0 | 0 | 1 | 1 | 140 | |
| gprod_20558 | 0 | 0 | 0 | 0 | 4 | 4 | 68.25 | |
| gprod_20569 | 1 | 0 | 0 | 1 | 1 | 3 | 110.333 | |
| gprod_20570 | 2 | 0 | 1 | 0 | 0 | 3 | 796.667 | |
| gprod_20576 | 0 | 0 | 2 | 0 | 4 | 6 | 294.667 | |
| gprod_20591 | 3 | 0 | 2 | 4 | 21 | 30 | 606.967 | |
| gprod_20624 | 0 | 0 | 0 | 0 | 1 | 1 | 210 | |
| gprod_20628 | 0 | 0 | 1 | 0 | 4 | 5 | 99.2 | |
| gprod_20641 | 0 | 0 | 2 | 3 | 6 | 11 | 533.091 | |
| gprod_20662 | 0 | 0 | 0 | 0 | 1 | 1 | 72 | |
| gprod_20664 | 0 | 0 | 1 | 2 | 2 | 5 | 30.4 | |
| gprod_20680 | 0 | 0 | 0 | 0 | 1 | 1 | 156 | |
| gprod_20700 | 2 | 0 | 0 | 0 | 1 | 3 | 73.3333 | |
| gprod_20727 | 4 | 0 | 0 | 1 | 3 | 8 | 399.125 | |
| gprod_20734 | 0 | 0 | 1 | 1 | 5 | 7 | 24.2857 | |
| gprod_20741 | 0 | 0 | 0 | 1 | 1 | 2 | 86 | |
| gprod_20765 | 0 | 0 | 1 | 0 | 7 | 8 | 70.375 | |
| gprod_20828 | 1 | 0 | 2 | 0 | 1 | 4 | 11 | |
| gprod_20829 | 0 | 0 | 0 | 1 | 1 | 2 | 132.5 | |
| gprod_20837 | 1 | 0 | 0 | 1 | 2 | 4 | 172.75 | |
| gprod_20852 | 0 | 0 | 0 | 1 | 2 | 3 | 151.333 | |
| gprod_20893 | 0 | 0 | 0 | 0 | 3 | 3 | 70.3333 | |
| gprod_20927 | 1 | 0 | 0 | 0 | 0 | 1 | 108 | |
| gprod_20938 | 0 | 0 | 3 | 0 | 0 | 3 | 85 | |
| gprod_21018 | 1 | 0 | 0 | 0 | 2 | 3 | 73.6667 | |
| gprod_21201 | 0 | 0 | 0 | 0 | 0 | 0 | 0 | |
| gprod_21246 | 0 | 0 | 0 | 0 | 3 | 3 | 62 | |
| gprod_21297 | 2 | 0 | 1 | 0 | 6 | 9 | 208.222 | |
| gprod_21313 | 0 | 0 | 0 | 0 | 1 | 1 | 260 | |
| gprod_21349 | 1 | 0 | 0 | 0 | 4 | 5 | 164.6 | |
| gprod_21518 | 0 | 0 | 0 | 0 | 5 | 5 | 128.4 | |
| gprod_21540 | 1 | 0 | 2 | 0 | 1 | 4 | 107.5 | |
| gprod_21543 | 2 | 0 | 0 | 0 | 3 | 5 | 232.6 | |
| gprod_21544 | 0 | 0 | 0 | 1 | 5 | 6 | 76.5 | |
| gprod_21553 | 1 | 0 | 0 | 0 | 0 | 1 | 678 | |
| gprod_21571 | 0 | 0 | 0 | 0 | 0 | 0 | 0 | |
| gprod_21635 | 1 | 0 | 0 | 0 | 0 | 1 | 1096 | |
| gprod_21693 | 1 | 0 | 0 | 0 | 1 | 2 | 88.5 | |
| gprod_2346 | 0 | 0 | 1 | 0 | 6 | 7 | 195.143 | |
| gprod_23932 | 3 | 0 | 1 | 0 | 4 | 8 | 170.25 | |
| gprod_24489 | 0 | 0 | 1 | 1 | 7 | 9 | 162.667 | |
| gprod_257 | 0 | 0 | 2 | 0 | 2 | 4 | 27.75 | |
| gprod_26542 | 0 | 0 | 0 | 0 | 0 | 0 | 0 | |
| gprod_26688 | 0 | 0 | 0 | 0 | 8 | 8 | 60.375 | |
| gprod_26772 | 0 | 0 | 1 | 2 | 10 | 13 | 262.615 | |
| gprod_26800 | 0 | 0 | 0 | 0 | 2 | 2 | 103 | |
| gprod_26933 | 0 | 0 | 0 | 0 | 1 | 1 | 62 | |
| gprod_26941 | 1 | 0 | 2 | 1 | 8 | 12 | 76.4167 | |
| gprod_27008 | 0 | 0 | 1 | 0 | 3 | 4 | 83.5 | |
| gprod_2725 | 0 | 0 | 2 | 0 | 0 | 2 | 338 | |
| gprod_27253 | 0 | 0 | 0 | 1 | 8 | 9 | 227 | |
| gprod_27327 | 1 | 0 | 1 | 0 | 1 | 3 | 81.3333 | |
| gprod_27505 | 0 | 0 | 0 | 0 | 1 | 1 | 60 | |
| gprod_27610 | 1 | 0 | 1 | 0 | 2 | 4 | 109.5 | |
| gprod_277 | 0 | 0 | 1 | 0 | 2 | 3 | 74.6667 | |
| gprod_27746 | 0 | 0 | 0 | 1 | 10 | 11 | 72.5455 | |
| gprod_279 | 0 | 0 | 0 | 0 | 1 | 1 | 129 | |
| gprod_28008 | 1 | 0 | 2 | 0 | 0 | 3 | 230.333 | |
| gprod_28099 | 0 | 0 | 1 | 0 | 4 | 5 | 66.6 | |
| gprod_28109 | 0 | 0 | 6 | 9 | 26 | 41 | 920.585 | |
| gprod_28114 | 0 | 0 | 0 | 0 | 2 | 2 | 102 | |
| gprod_28126 | 0 | 0 | 0 | 0 | 3 | 3 | 65.6667 | |
| gprod_28128 | 0 | 0 | 0 | 1 | 5 | 6 | 88.8333 | |
| gprod_28207 | 0 | 0 | 1 | 0 | 2 | 3 | 211.333 | |
| gprod_2836 | 0 | 0 | 0 | 1 | 10 | 11 | 161.909 | |
| gprod_29240 | 1 | 0 | 0 | 0 | 3 | 4 | 196.5 | |
| gprod_3136 | 0 | 0 | 0 | 0 | 4 | 4 | 70.5 | |
| gprod_31705 | 6 | 0 | 0 | 0 | 0 | 6 | 691.667 | |
| gprod_32138 | 0 | 0 | 0 | 0 | 6 | 6 | 42.5 | |
| gprod_32155 | 0 | 0 | 0 | 0 | 3 | 3 | 15.6667 | |
| gprod_32223 | 0 | 0 | 0 | 0 | 4 | 4 | 34.75 | |
| gprod_32385 | 0 | 0 | 0 | 0 | 2 | 2 | 29.5 | |
| gprod_32424 | 0 | 0 | 1 | 0 | 2 | 3 | 31 | |
| gprod_32450 | 0 | 0 | 0 | 0 | 5 | 5 | 24.8 | |
| gprod_3252 | 0 | 0 | 0 | 0 | 7 | 7 | 49.4286 | |
| gprod_32524 | 2 | 0 | 6 | 1 | 13 | 22 | 103.318 | |
| gprod_32586 | 0 | 0 | 0 | 1 | 0 | 1 | 304 | |
| gprod_32611 | 0 | 0 | 0 | 0 | 1 | 1 | 351 | |
| gprod_32623 | 0 | 0 | 0 | 0 | 5 | 5 | 49.8 | |
| gprod_32687 | 0 | 0 | 0 | 1 | 2 | 3 | 191.333 | |
| gprod_32711 | 0 | 0 | 0 | 2 | 7 | 9 | 260.889 | |
| gprod_32728 | 0 | 0 | 0 | 0 | 0 | 0 | 0 | |
| gprod_32739 | 0 | 0 | 0 | 0 | 4 | 4 | 465 | |
| gprod_32763 | 1 | 0 | 0 | 0 | 5 | 6 | 187 | |
| gprod_32765 | 0 | 0 | 1 | 0 | 3 | 4 | 53.25 | |
| gprod_32787 | 0 | 0 | 0 | 0 | 1 | 1 | 534 | |
| gprod_32798 | 0 | 0 | 0 | 1 | 5 | 6 | 172.667 | |
| gprod_32803 | 0 | 0 | 0 | 1 | 1 | 2 | 61 | |
| gprod_32817 | 1 | 0 | 0 | 0 | 2 | 3 | 129.667 | |
| gprod_32831 | 0 | 0 | 0 | 0 | 3 | 3 | 59.6667 | |
| gprod_32853 | 0 | 0 | 0 | 0 | 0 | 0 | 0 | |
| gprod_32854 | 0 | 0 | 1 | 2 | 6 | 9 | 115.778 | |
| gprod_3917 | 0 | 0 | 1 | 0 | 9 | 10 | 28.9 | |
| gprod_474 | 0 | 0 | 0 | 0 | 4 | 4 | 129.75 | |
| gprod_5001 | 0 | 0 | 0 | 1 | 3 | 4 | 39 | |
| gprod_5270 | 0 | 0 | 0 | 1 | 9 | 10 | 176.7 | |
| gprod_5276 | 0 | 0 | 1 | 0 | 2 | 3 | 17.6667 | |
| gprod_53 | 0 | 0 | 0 | 0 | 4 | 4 | 67.25 | |
| gprod_5760 | 0 | 0 | 0 | 2 | 3 | 5 | 71.6 | |
| gprod_5851 | 0 | 0 | 1 | 0 | 5 | 6 | 50 | |
| gprod_5932 | 0 | 0 | 1 | 0 | 1 | 2 | 61 | |
| gprod_5942 | 0 | 0 | 1 | 1 | 13 | 15 | 110 | |
| gprod_6132 | 0 | 0 | 0 | 2 | 5 | 7 | 135.857 | |
| gprod_6992 | 0 | 0 | 0 | 0 | 3 | 3 | 41.6667 | |
| gprod_7278 | 0 | 0 | 0 | 0 | 8 | 8 | 190.75 | |
| gprod_746 | 2 | 0 | 1 | 1 | 0 | 4 | 116 | |
| gprod_747 | 0 | 0 | 0 | 0 | 6 | 6 | 129.167 | |
| gprod_7647 | 0 | 0 | 0 | 0 | 2 | 2 | 175.5 | |
| gprod_7650 | 0 | 0 | 0 | 1 | 3 | 4 | 425.75 | |
| gprod_7655 | 0 | 0 | 2 | 3 | 1 | 6 | 68 | |
| gprod_7658 | 0 | 0 | 0 | 1 | 2 | 3 | 29.6667 | |
| gprod_7670 | 3 | 0 | 0 | 3 | 10 | 16 | 241.188 | |
| gprod_7675 | 3 | 0 | 0 | 0 | 0 | 3 | 175.667 | |
| gprod_7683 | 0 | 0 | 0 | 1 | 2 | 3 | 57.3333 | |
| gprod_7688 | 0 | 0 | 1 | 1 | 2 | 4 | 87 | |
| gprod_7696 | 0 | 0 | 0 | 1 | 3 | 4 | 35.25 | |
| gprod_7701 | 2 | 0 | 0 | 0 | 5 | 7 | 465.571 | |
| gprod_7706 | 1 | 0 | 0 | 3 | 1 | 5 | 117.6 | |
| gprod_7714 | 0 | 0 | 0 | 0 | 5 | 5 | 188.8 | |
| gprod_7715 | 0 | 0 | 0 | 0 | 2 | 2 | 91 | |
| gprod_7731 | 2 | 0 | 3 | 0 | 0 | 5 | 1163.8 | |
| gprod_7733 | 0 | 0 | 1 | 4 | 29 | 34 | 339.382 | |
| gprod_7735 | 0 | 0 | 0 | 0 | 3 | 3 | 54.6667 | |
| gprod_7739 | 0 | 0 | 1 | 2 | 3 | 6 | 57.3333 | |
| gprod_7743 | 1 | 0 | 0 | 0 | 3 | 4 | 97.75 | |
| gprod_7744 | 0 | 0 | 3 | 0 | 10 | 13 | 166.462 | |
| gprod_7764 | 0 | 0 | 0 | 0 | 11 | 11 | 157.182 | |
| gprod_7766 | 0 | 0 | 0 | 1 | 5 | 6 | 101.167 | |
| gprod_7770 | 0 | 0 | 0 | 0 | 4 | 4 | 74.5 | |
| gprod_7773 | 0 | 0 | 1 | 0 | 3 | 4 | 38.75 | |
| gprod_7778 | 0 | 0 | 0 | 0 | 1 | 1 | 88 | |
| gprod_7779 | 0 | 0 | 0 | 0 | 1 | 1 | 184 | |
| gprod_7783 | 0 | 0 | 1 | 0 | 3 | 4 | 87.25 | |
| gprod_7800 | 2 | 0 | 0 | 0 | 3 | 5 | 129.2 | |
| gprod_7809 | 0 | 0 | 0 | 0 | 3 | 3 | 95.3333 | |
| gprod_7816 | 0 | 0 | 1 | 0 | 1 | 2 | 60.5 | |
| gprod_7818 | 1 | 0 | 0 | 0 | 3 | 4 | 71 | |
| gprod_7838 | 0 | 0 | 0 | 0 | 5 | 5 | 40.4 | |
| gprod_7852 | 0 | 0 | 0 | 0 | 4 | 4 | 78 | |
| gprod_7853 | 0 | 0 | 0 | 1 | 6 | 7 | 58.4286 | |
| gprod_7856 | 3 | 0 | 0 | 0 | 0 | 3 | 334 | |
| gprod_7863 | 0 | 0 | 0 | 0 | 3 | 3 | 48.6667 | |
| gprod_7866 | 0 | 0 | 1 | 0 | 3 | 4 | 143.5 | |
| gprod_7880 | 0 | 0 | 0 | 0 | 3 | 3 | 29.3333 | |
| gprod_7882 | 0 | 0 | 2 | 0 | 2 | 4 | 48.5 | |
| gprod_7890 | 0 | 0 | 0 | 1 | 11 | 12 | 87.0833 | |
| gprod_7891 | 0 | 0 | 0 | 3 | 13 | 16 | 137.25 | |
| gprod_7909 | 0 | 0 | 0 | 0 | 5 | 5 | 35.4 | |
| gprod_7932 | 1 | 0 | 1 | 0 | 1 | 3 | 129.667 | |
| gprod_7938 | 0 | 0 | 0 | 1 | 2 | 3 | 18 | |
| gprod_7955 | 1 | 0 | 0 | 1 | 5 | 7 | 379.286 | |
| gprod_7956 | 0 | 0 | 0 | 0 | 9 | 9 | 576.667 | |
| gprod_7964 | 0 | 0 | 1 | 1 | 2 | 4 | 85 | |
| gprod_7970 | 3 | 0 | 2 | 1 | 3 | 9 | 127.111 | |
| gprod_7978 | 0 | 0 | 1 | 0 | 3 | 4 | 40.5 | |
| gprod_7980 | 0 | 0 | 0 | 0 | 6 | 6 | 59.6667 | |
| gprod_7989 | 1 | 0 | 0 | 0 | 4 | 5 | 703.2 | |
| gprod_7997 | 0 | 0 | 0 | 1 | 7 | 8 | 81.5 | |
| gprod_8011 | 0 | 0 | 1 | 0 | 2 | 3 | 41 | |
| gprod_8019 | 0 | 0 | 0 | 1 | 3 | 4 | 102.25 | |
| gprod_8021 | 1 | 0 | 2 | 0 | 4 | 7 | 200.286 | |
| gprod_8023 | 0 | 0 | 2 | 2 | 9 | 13 | 236.615 | |
| gprod_8032 | 0 | 0 | 0 | 0 | 2 | 2 | 78 | |
| gprod_8035 | 2 | 0 | 0 | 1 | 0 | 3 | 308.667 | |
| gprod_8046 | 0 | 0 | 0 | 1 | 2 | 3 | 31 | |
| gprod_8048 | 0 | 0 | 2 | 2 | 22 | 26 | 648.5 | |
| gprod_8069 | 0 | 0 | 1 | 1 | 1 | 3 | 85.6667 | |
| gprod_8072 | 0 | 0 | 0 | 0 | 3 | 3 | 123.667 | |
| gprod_8073 | 0 | 0 | 1 | 1 | 9 | 11 | 174.636 | |
| gprod_8080 | 0 | 0 | 1 | 1 | 3 | 5 | 152 | |
| gprod_8083 | 0 | 0 | 0 | 0 | 3 | 3 | 96.6667 | |
| gprod_8094 | 1 | 0 | 0 | 0 | 3 | 4 | 72.75 | |
| gprod_8095 | 0 | 0 | 0 | 0 | 3 | 3 | 125.667 | |
| gprod_8096 | 0 | 0 | 0 | 0 | 3 | 3 | 126.667 | |
| gprod_8097 | 0 | 0 | 0 | 0 | 6 | 6 | 173.167 | |
| gprod_8106 | 0 | 0 | 1 | 0 | 4 | 5 | 186 | |
| gprod_8114 | 1 | 0 | 0 | 0 | 2 | 3 | 35.6667 | |
| gprod_8115 | 0 | 0 | 0 | 0 | 10 | 10 | 161.1 | |
| gprod_8116 | 1 | 0 | 1 | 0 | 2 | 4 | 182 | |
| gprod_8119 | 0 | 0 | 1 | 0 | 3 | 4 | 101.5 | |
| gprod_8132 | 0 | 0 | 0 | 0 | 4 | 4 | 152.25 | |
| gprod_8138 | 0 | 0 | 1 | 1 | 1 | 3 | 96.6667 | |
| gprod_814 | 0 | 0 | 0 | 0 | 3 | 3 | 74 | |
| gprod_8140 | 1 | 0 | 1 | 1 | 9 | 12 | 299.083 | |
| gprod_815 | 0 | 0 | 0 | 1 | 2 | 3 | 88 | |
| gprod_8170 | 1 | 0 | 0 | 0 | 2 | 3 | 251 | |
| gprod_8188 | 1 | 0 | 0 | 0 | 4 | 5 | 81.2 | |
| gprod_8199 | 1 | 0 | 1 | 0 | 8 | 10 | 294.7 | |
| gprod_8245 | 0 | 0 | 1 | 0 | 5 | 6 | 85.3333 | |
| gprod_8270 | 0 | 0 | 1 | 0 | 0 | 1 | 504 | |
| gprod_8288 | 0 | 0 | 0 | 0 | 2 | 2 | 41 | |
| gprod_8289 | 0 | 0 | 1 | 0 | 2 | 3 | 54 | |
| gprod_8300 | 0 | 0 | 2 | 0 | 2 | 4 | 116.25 | |
| gprod_8313 | 1 | 0 | 0 | 0 | 2 | 3 | 107.333 | |
| gprod_8335 | 1 | 0 | 2 | 0 | 0 | 3 | 236.667 | |
| gprod_8341 | 1 | 0 | 1 | 3 | 32 | 37 | 584.351 | |
| gprod_8355 | 0 | 0 | 0 | 0 | 2 | 2 | 128.5 | |
| gprod_8361 | 0 | 0 | 0 | 0 | 3 | 3 | 9 | |
| gprod_8384 | 0 | 0 | 1 | 0 | 2 | 3 | 64.6667 | |
| gprod_8424 | 0 | 0 | 0 | 0 | 5 | 5 | 102.2 | |
| gprod_8433 | 1 | 0 | 0 | 0 | 1 | 2 | 52.5 | |
| gprod_8439 | 0 | 0 | 0 | 1 | 7 | 8 | 270.875 | |
| gprod_8463 | 0 | 0 | 0 | 0 | 0 | 0 | 0 | |
| gprod_8465 | 1 | 0 | 0 | 0 | 3 | 4 | 45.25 | |
| gprod_8470 | 0 | 0 | 0 | 1 | 7 | 8 | 165.25 | |
| gprod_8485 | 0 | 0 | 0 | 0 | 2 | 2 | 56 | |
| gprod_8495 | 1 | 0 | 2 | 1 | 5 | 9 | 60.6667 | |
| gprod_8500 | 1 | 0 | 0 | 1 | 0 | 2 | 79.5 | |
| gprod_8511 | 2 | 0 | 1 | 0 | 0 | 3 | 178.333 | |
| gprod_8538 | 0 | 0 | 1 | 0 | 2 | 3 | 72 | |
| gprod_8568 | 0 | 0 | 1 | 0 | 2 | 3 | 65 | |
| gprod_8574 | 1 | 0 | 2 | 0 | 3 | 6 | 158.833 | |
| gprod_8576 | 0 | 0 | 0 | 0 | 3 | 3 | 69.6667 | |
| gprod_8585 | 0 | 0 | 1 | 0 | 11 | 12 | 187.333 | |
| gprod_8603 | 1 | 0 | 0 | 0 | 4 | 5 | 138.6 | |
| gprod_8610 | 0 | 0 | 0 | 2 | 10 | 12 | 80.9167 | |
| gprod_8614 | 0 | 0 | 0 | 0 | 4 | 4 | 121.5 | |
| gprod_8619 | 0 | 0 | 1 | 1 | 2 | 4 | 68.25 | |
| gprod_8620 | 0 | 0 | 0 | 0 | 3 | 3 | 122.667 | |
| gprod_8643 | 0 | 0 | 0 | 1 | 2 | 3 | 148.667 | |
| gprod_8650 | 0 | 0 | 1 | 0 | 2 | 3 | 402 | |
| gprod_8659 | 0 | 0 | 0 | 1 | 4 | 5 | 304.6 | |
| gprod_8669 | 0 | 0 | 1 | 0 | 1 | 2 | 67 | |
| gprod_8684 | 1 | 0 | 2 | 0 | 0 | 3 | 97 | |
| gprod_8690 | 0 | 0 | 0 | 0 | 3 | 3 | 76 | |
| gprod_8695 | 0 | 0 | 0 | 0 | 1 | 1 | 186 | |
| gprod_8711 | 2 | 0 | 0 | 0 | 2 | 4 | 281 | |
| gprod_8727 | 0 | 0 | 1 | 0 | 2 | 3 | 217.333 | |
| gprod_8737 | 1 | 0 | 1 | 0 | 1 | 3 | 104.333 | |
| gprod_8750 | 1 | 0 | 0 | 0 | 11 | 12 | 138.333 | |
| gprod_8758 | 0 | 0 | 0 | 0 | 3 | 3 | 26.6667 | |
| gprod_8768 | 0 | 0 | 1 | 1 | 4 | 6 | 537.167 | |
| gprod_8809 | 3 | 0 | 0 | 0 | 0 | 3 | 32.3333 | |
| gprod_8810 | 0 | 0 | 0 | 1 | 2 | 3 | 70.6667 | |
| gprod_8825 | 0 | 0 | 1 | 1 | 2 | 4 | 78.5 | |
| gprod_8829 | 1 | 0 | 2 | 0 | 0 | 3 | 707 | |
| gprod_8838 | 0 | 0 | 0 | 0 | 3 | 3 | 28.6667 | |
| gprod_885 | 0 | 0 | 0 | 0 | 3 | 3 | 54 | |
| gprod_8863 | 0 | 0 | 0 | 0 | 3 | 3 | 68.3333 | |
| gprod_8881 | 0 | 0 | 0 | 0 | 3 | 3 | 87.3333 | |
| gprod_8914 | 0 | 0 | 0 | 0 | 3 | 3 | 35.3333 | |
| gprod_8950 | 0 | 0 | 0 | 0 | 3 | 3 | 44 | |
| gprod_8984 | 0 | 0 | 0 | 0 | 0 | 0 | 0 | |
| gprod_9042 | 0 | 0 | 0 | 1 | 2 | 3 | 62 | |
| gprod_9052 | 0 | 0 | 0 | 0 | 3 | 3 | 86 | |
| gprod_9053 | 0 | 0 | 0 | 2 | 1 | 3 | 68 | |
| gprod_9086 | 0 | 0 | 1 | 0 | 9 | 10 | 78.6 | |
| gprod_9087 | 0 | 0 | 1 | 1 | 5 | 7 | 76.2857 | |
| gprod_909 | 0 | 0 | 2 | 1 | 14 | 17 | 177 | |
| gprod_9112 | 0 | 0 | 0 | 1 | 3 | 4 | 89.75 | |
| gprod_9125 | 0 | 0 | 0 | 0 | 1 | 1 | 96 | |
| gprod_9146 | 0 | 0 | 1 | 0 | 6 | 7 | 25.1429 | |
| gprod_9196 | 0 | 0 | 0 | 0 | 3 | 3 | 51.6667 | |
| gprod_9247 | 0 | 0 | 0 | 1 | 1 | 2 | 148.5 | |
| gprod_9291 | 0 | 0 | 0 | 0 | 1 | 1 | 60 | |
| gprod_9300 | 3 | 0 | 0 | 0 | 0 | 3 | 280.333 | |
| gprod_9337 | 0 | 0 | 0 | 0 | 3 | 3 | 47.6667 | |
| gprod_934 | 0 | 0 | 0 | 0 | 2 | 2 | 39.5 | |
| gprod_9365 | 2 | 0 | 0 | 0 | 0 | 2 | 62.5 | |
| gprod_9379 | 0 | 0 | 0 | 0 | 1 | 1 | 309 | |
| gprod_9506 | 0 | 0 | 1 | 2 | 1 | 4 | 168.75 | |
| gprod_9545 | 2 | 0 | 0 | 0 | 1 | 3 | 59.3333 | |
| gprod_9582 | 0 | 0 | 0 | 0 | 0 | 0 | 0 | |
| gprod_963 | 0 | 0 | 0 | 0 | 3 | 3 | 69 | |
| gprod_9814 | 0 | 0 | 0 | 0 | 2 | 2 | 121 | |
| gprod_12760 | 0 | 1 | 0 | 1 | 1 | 3 | 136.667 | |
| gprod_12786 | 6 | 1 | 1 | 0 | 11 | 19 | 264.053 | |
| gprod_13977 | 0 | 1 | 1 | 1 | 6 | 9 | 54.8889 | |
| gprod_14170 | 2 | 1 | 0 | 5 | 11 | 19 | 297.579 | |
| gprod_1425 | 0 | 1 | 0 | 1 | 4 | 6 | 123 | |
| gprod_14535 | 1 | 1 | 3 | 2 | 15 | 22 | 170.318 | |
| gprod_14642 | 0 | 1 | 1 | 0 | 12 | 14 | 1276.43 | |
| gprod_14919 | 0 | 1 | 1 | 2 | 5 | 9 | 337.444 | |
| gprod_16029 | 3 | 1 | 0 | 1 | 0 | 5 | 62.6 | |
| gprod_16115 | 0 | 1 | 0 | 1 | 3 | 5 | 80.4 | |
| gprod_16281 | 1 | 1 | 1 | 0 | 0 | 3 | 58.6667 | |
| gprod_1644 | 2 | 1 | 0 | 0 | 1 | 4 | 195.25 | |
| gprod_16975 | 0 | 1 | 0 | 0 | 3 | 4 | 70.75 | |
| gprod_1927 | 0 | 1 | 0 | 0 | 5 | 6 | 290.333 | |
| gprod_1934 | 0 | 1 | 3 | 0 | 8 | 12 | 184.417 | |
| gprod_19774 | 0 | 1 | 1 | 0 | 5 | 7 | 89 | |
| gprod_19796 | 1 | 1 | 1 | 2 | 14 | 19 | 467.368 | |
| gprod_19831 | 0 | 1 | 1 | 2 | 11 | 15 | 215.133 | |
| gprod_19846 | 3 | 1 | 2 | 0 | 25 | 31 | 700.161 | |
| gprod_19848 | 0 | 1 | 0 | 0 | 3 | 4 | 87 | |
| gprod_19877 | 0 | 1 | 0 | 0 | 2 | 3 | 48.6667 | |
| gprod_19893 | 3 | 1 | 1 | 1 | 14 | 20 | 812.95 | |
| gprod_19895 | 2 | 1 | 4 | 0 | 4 | 11 | 462.545 | |
| gprod_19900 | 0 | 1 | 2 | 1 | 7 | 11 | 61.5455 | |
| gprod_19903 | 0 | 1 | 1 | 0 | 7 | 9 | 246.556 | |
| gprod_19914 | 0 | 1 | 0 | 0 | 2 | 3 | 33.6667 | |
| gprod_19924 | 1 | 1 | 1 | 0 | 14 | 17 | 492.118 | |
| gprod_19930 | 0 | 1 | 0 | 1 | 3 | 5 | 114.8 | |
| gprod_19941 | 0 | 1 | 0 | 1 | 2 | 4 | 37.25 | |
| gprod_19981 | 1 | 1 | 6 | 6 | 35 | 49 | 1243.14 | |
| gprod_19986 | 1 | 1 | 4 | 5 | 14 | 25 | 543.2 | |
| gprod_20003 | 0 | 1 | 0 | 1 | 5 | 7 | 115 | |
| gprod_20020 | 0 | 1 | 0 | 0 | 0 | 1 | 126 | |
| gprod_20030 | 0 | 1 | 0 | 0 | 8 | 9 | 69.2222 | |
| gprod_20049 | 0 | 1 | 0 | 0 | 7 | 8 | 129.125 | |
| gprod_20149 | 0 | 1 | 1 | 0 | 1 | 3 | 53.3333 | |
| gprod_20159 | 0 | 1 | 0 | 1 | 7 | 9 | 252 | |
| gprod_20261 | 2 | 1 | 0 | 0 | 0 | 3 | 123 | |
| gprod_20304 | 0 | 1 | 0 | 0 | 3 | 4 | 219.75 | |
| gprod_20533 | 2 | 1 | 0 | 0 | 1 | 4 | 156.5 | |
| gprod_20554 | 0 | 1 | 1 | 1 | 0 | 3 | 251.667 | |
| gprod_20585 | 0 | 1 | 1 | 1 | 1 | 4 | 60 | |
| gprod_20633 | 0 | 1 | 0 | 2 | 3 | 6 | 177 | |
| gprod_2064 | 0 | 1 | 0 | 1 | 2 | 4 | 138 | |
| gprod_20642 | 0 | 1 | 0 | 0 | 3 | 4 | 188 | |
| gprod_20682 | 0 | 1 | 0 | 0 | 1 | 2 | 42 | |
| gprod_20753 | 0 | 1 | 0 | 0 | 2 | 3 | 1571.67 | |
| gprod_20784 | 0 | 1 | 0 | 2 | 1 | 4 | 192 | |
| gprod_20935 | 0 | 1 | 0 | 0 | 3 | 4 | 57 | |
| gprod_20995 | 0 | 1 | 1 | 1 | 1 | 4 | 33.5 | |
| gprod_21290 | 0 | 1 | 3 | 2 | 2 | 8 | 176.625 | |
| gprod_21305 | 0 | 1 | 0 | 0 | 1 | 2 | 58.5 | |
| gprod_21306 | 0 | 1 | 1 | 0 | 1 | 3 | 211.667 | |
| gprod_21527 | 0 | 1 | 2 | 0 | 7 | 10 | 374.4 | |
| gprod_21528 | 0 | 1 | 2 | 1 | 1 | 5 | 49.2 | |
| gprod_23639 | 4 | 1 | 1 | 0 | 7 | 13 | 341.462 | |
| gprod_23919 | 2 | 1 | 1 | 1 | 4 | 9 | 73.5556 | |
| gprod_2606 | 1 | 1 | 2 | 0 | 0 | 4 | 67.5 | |
| gprod_26860 | 0 | 1 | 0 | 0 | 10 | 11 | 115 | |
| gprod_26964 | 0 | 1 | 0 | 0 | 1 | 2 | 7.5 | |
| gprod_27333 | 2 | 1 | 0 | 0 | 3 | 6 | 313.333 | |
| gprod_27592 | 0 | 1 | 0 | 0 | 3 | 4 | 65 | |
| gprod_28106 | 0 | 1 | 1 | 0 | 4 | 6 | 37.3333 | |
| gprod_28112 | 1 | 1 | 0 | 0 | 7 | 9 | 210.778 | |
| gprod_28113 | 0 | 1 | 0 | 2 | 1 | 4 | 133.25 | |
| gprod_28129 | 0 | 1 | 0 | 0 | 1 | 2 | 38 | |
| gprod_2863 | 0 | 1 | 0 | 0 | 11 | 12 | 96.9167 | |
| gprod_31702 | 2 | 1 | 0 | 0 | 0 | 3 | 34 | |
| gprod_31741 | 2 | 1 | 0 | 0 | 1 | 4 | 23 | |
| gprod_31781 | 0 | 1 | 0 | 0 | 1 | 2 | 34 | |
| gprod_32030 | 2 | 1 | 2 | 2 | 10 | 17 | 419.588 | |
| gprod_32193 | 0 | 1 | 2 | 1 | 1 | 5 | 216 | |
| gprod_32422 | 0 | 1 | 1 | 0 | 3 | 5 | 42 | |
| gprod_32443 | 0 | 1 | 0 | 4 | 4 | 9 | 269.333 | |
| gprod_32714 | 1 | 1 | 3 | 1 | 3 | 9 | 81.5556 | |
| gprod_32721 | 2 | 1 | 0 | 0 | 14 | 17 | 510.059 | |
| gprod_32722 | 0 | 1 | 1 | 3 | 18 | 23 | 188 | |
| gprod_32723 | 1 | 1 | 0 | 0 | 1 | 3 | 118.333 | |
| gprod_32725 | 0 | 1 | 0 | 2 | 10 | 13 | 349.308 | |
| gprod_32741 | 1 | 1 | 2 | 0 | 3 | 7 | 31.7143 | |
| gprod_32752 | 0 | 1 | 0 | 0 | 3 | 4 | 83.5 | |
| gprod_32786 | 0 | 1 | 0 | 1 | 7 | 9 | 217.778 | |
| gprod_32809 | 0 | 1 | 1 | 2 | 4 | 8 | 44.75 | |
| gprod_32834 | 1 | 1 | 0 | 0 | 0 | 2 | 119 | |
| gprod_32855 | 0 | 1 | 1 | 1 | 6 | 9 | 103.333 | |
| gprod_4443 | 0 | 1 | 1 | 3 | 3 | 8 | 40.875 | |
| gprod_470 | 1 | 1 | 0 | 0 | 0 | 2 | 605.5 | |
| gprod_5522 | 1 | 1 | 1 | 1 | 1 | 5 | 54 | |
| gprod_564 | 0 | 1 | 0 | 0 | 3 | 4 | 68.25 | |
| gprod_5670 | 0 | 1 | 0 | 1 | 1 | 3 | 47.6667 | |
| gprod_6233 | 0 | 1 | 0 | 0 | 10 | 11 | 287.091 | |
| gprod_720 | 0 | 1 | 0 | 0 | 0 | 1 | 42 | |
| gprod_7653 | 0 | 1 | 1 | 1 | 1 | 4 | 168.5 | |
| gprod_7656 | 0 | 1 | 0 | 0 | 5 | 6 | 70.3333 | |
| gprod_7678 | 1 | 1 | 1 | 2 | 0 | 5 | 85.6 | |
| gprod_7681 | 0 | 1 | 1 | 0 | 5 | 7 | 229.286 | |
| gprod_7686 | 0 | 1 | 0 | 0 | 2 | 3 | 56 | |
| gprod_7697 | 0 | 1 | 1 | 0 | 7 | 9 | 249 | |
| gprod_7702 | 0 | 1 | 0 | 1 | 8 | 10 | 138.4 | |
| gprod_7749 | 0 | 1 | 0 | 1 | 4 | 6 | 263.333 | |
| gprod_7777 | 0 | 1 | 0 | 1 | 4 | 6 | 74.3333 | |
| gprod_7793 | 0 | 1 | 0 | 2 | 3 | 6 | 75.1667 | |
| gprod_7797 | 0 | 1 | 0 | 1 | 4 | 6 | 74.1667 | |
| gprod_7821 | 1 | 1 | 0 | 0 | 1 | 3 | 224 | |
| gprod_7825 | 0 | 1 | 0 | 0 | 3 | 4 | 114.25 | |
| gprod_7829 | 0 | 1 | 1 | 3 | 15 | 20 | 483.6 | |
| gprod_7841 | 0 | 1 | 1 | 0 | 1 | 3 | 148.333 | |
| gprod_7844 | 0 | 1 | 0 | 1 | 14 | 16 | 287.875 | |
| gprod_7848 | 1 | 1 | 0 | 1 | 5 | 8 | 124.375 | |
| gprod_7870 | 0 | 1 | 0 | 3 | 1 | 5 | 153.6 | |
| gprod_7878 | 0 | 1 | 0 | 0 | 2 | 3 | 14.3333 | |
| gprod_7906 | 0 | 1 | 2 | 0 | 10 | 13 | 301.538 | |
| gprod_7908 | 0 | 1 | 2 | 1 | 6 | 10 | 343.4 | |
| gprod_7933 | 0 | 1 | 3 | 0 | 9 | 13 | 310.462 | |
| gprod_7984 | 1 | 1 | 2 | 1 | 1 | 6 | 53.1667 | |
| gprod_7985 | 0 | 1 | 0 | 2 | 3 | 6 | 108 | |
| gprod_8005 | 0 | 1 | 0 | 0 | 2 | 3 | 25.6667 | |
| gprod_8010 | 1 | 1 | 0 | 0 | 1 | 3 | 82 | |
| gprod_8028 | 1 | 1 | 1 | 1 | 14 | 18 | 353.333 | |
| gprod_8038 | 1 | 1 | 0 | 2 | 1 | 5 | 60.8 | |
| gprod_8054 | 2 | 1 | 0 | 1 | 5 | 9 | 523.556 | |
| gprod_8055 | 3 | 1 | 2 | 0 | 9 | 15 | 294.267 | |
| gprod_8065 | 0 | 1 | 0 | 2 | 5 | 8 | 154.5 | |
| gprod_8074 | 0 | 1 | 0 | 1 | 1 | 3 | 81.3333 | |
| gprod_8092 | 0 | 1 | 1 | 1 | 2 | 5 | 132.8 | |
| gprod_8098 | 1 | 1 | 0 | 0 | 1 | 3 | 117.667 | |
| gprod_8113 | 0 | 1 | 2 | 0 | 1 | 4 | 50.75 | |
| gprod_8122 | 0 | 1 | 0 | 1 | 2 | 4 | 199.5 | |
| gprod_8301 | 1 | 1 | 1 | 1 | 3 | 7 | 136.714 | |
| gprod_8311 | 0 | 1 | 1 | 0 | 2 | 4 | 98.75 | |
| gprod_8316 | 0 | 1 | 0 | 0 | 2 | 3 | 28.6667 | |
| gprod_8321 | 3 | 1 | 0 | 1 | 2 | 7 | 103.571 | |
| gprod_8334 | 0 | 1 | 0 | 0 | 3 | 4 | 72.25 | |
| gprod_8359 | 3 | 1 | 1 | 0 | 6 | 11 | 87.2727 | |
| gprod_8438 | 0 | 1 | 1 | 0 | 4 | 6 | 215 | |
| gprod_8449 | 2 | 1 | 0 | 0 | 0 | 3 | 81.6667 | |
| gprod_8475 | 1 | 1 | 1 | 0 | 2 | 5 | 301.8 | |
| gprod_8499 | 0 | 1 | 0 | 0 | 2 | 3 | 107.667 | |
| gprod_8554 | 1 | 1 | 1 | 0 | 6 | 9 | 88.4444 | |
| gprod_8595 | 0 | 1 | 2 | 1 | 0 | 4 | 417.5 | |
| gprod_8599 | 0 | 1 | 1 | 2 | 7 | 11 | 142.273 | |
| gprod_8600 | 1 | 1 | 0 | 1 | 11 | 14 | 149.5 | |
| gprod_8608 | 0 | 1 | 1 | 0 | 3 | 5 | 41.6 | |
| gprod_8671 | 0 | 1 | 0 | 1 | 4 | 6 | 88.6667 | |
| gprod_8732 | 1 | 1 | 0 | 0 | 3 | 5 | 343.8 | |
| gprod_8733 | 0 | 1 | 0 | 0 | 2 | 3 | 33.3333 | |
| gprod_8742 | 0 | 1 | 0 | 0 | 4 | 5 | 104.8 | |
| gprod_8743 | 0 | 1 | 1 | 0 | 1 | 3 | 36.3333 | |
| gprod_8767 | 0 | 1 | 1 | 0 | 3 | 5 | 163.8 | |
| gprod_8780 | 0 | 1 | 4 | 2 | 12 | 19 | 359.263 | |
| gprod_8860 | 1 | 1 | 1 | 3 | 1 | 7 | 103.714 | |
| gprod_9011 | 0 | 1 | 1 | 0 | 14 | 16 | 826.312 | |
| gprod_9024 | 0 | 1 | 1 | 0 | 3 | 5 | 6.2 | |
| gprod_9160 | 0 | 1 | 0 | 1 | 4 | 6 | 55.6667 | |
| gprod_9271 | 1 | 1 | 2 | 0 | 2 | 6 | 81.3333 | |
| gprod_9377 | 0 | 1 | 0 | 0 | 5 | 6 | 66 | |
| gprod_9404 | 0 | 1 | 0 | 0 | 2 | 3 | 31.6667 | |
| gprod_1191 | 0 | 2 | 0 | 1 | 0 | 3 | 91.6667 | |
| gprod_182 | 1 | 2 | 1 | 0 | 15 | 19 | 336.789 | |
| gprod_18780 | 1 | 2 | 1 | 1 | 9 | 14 | 815 | |
| gprod_19811 | 4 | 2 | 1 | 2 | 45 | 54 | 833.111 | |
| gprod_19819 | 2 | 2 | 1 | 0 | 0 | 5 | 221.8 | |
| gprod_19837 | 0 | 2 | 0 | 1 | 4 | 7 | 430.429 | |
| gprod_19840 | 1 | 2 | 0 | 0 | 0 | 3 | 269.667 | |
| gprod_19891 | 1 | 2 | 1 | 1 | 7 | 12 | 251.5 | |
| gprod_19946 | 0 | 2 | 2 | 5 | 9 | 18 | 299.5 | |
| gprod_19952 | 1 | 2 | 4 | 2 | 18 | 27 | 520.037 | |
| gprod_19953 | 0 | 2 | 2 | 4 | 12 | 20 | 343.85 | |
| gprod_19969 | 0 | 2 | 0 | 1 | 6 | 9 | 251.556 | |
| gprod_19987 | 38 | 2 | 1 | 3 | 5 | 49 | 2589.8 | |
| gprod_20036 | 2 | 2 | 0 | 0 | 1 | 5 | 60.8 | |
| gprod_20062 | 1 | 2 | 1 | 0 | 7 | 11 | 168 | |
| gprod_20136 | 2 | 2 | 3 | 2 | 4 | 13 | 166.692 | |
| gprod_20175 | 0 | 2 | 4 | 2 | 7 | 15 | 320.867 | |
| gprod_20214 | 0 | 2 | 2 | 3 | 20 | 27 | 371.296 | |
| gprod_20555 | 1 | 2 | 0 | 0 | 0 | 3 | 930.333 | |
| gprod_20562 | 0 | 2 | 0 | 1 | 1 | 4 | 186.5 | |
| gprod_20716 | 1 | 2 | 0 | 0 | 1 | 4 | 2526.5 | |
| gprod_20718 | 0 | 2 | 1 | 1 | 2 | 6 | 54.6667 | |
| gprod_21454 | 2 | 2 | 2 | 0 | 8 | 14 | 217.643 | |
| gprod_21524 | 5 | 2 | 2 | 0 | 3 | 12 | 1030 | |
| gprod_23703 | 0 | 2 | 0 | 0 | 1 | 3 | 43.6667 | |
| gprod_26509 | 2 | 2 | 0 | 2 | 0 | 6 | 158.167 | |
| gprod_26822 | 1 | 2 | 0 | 0 | 5 | 8 | 157.375 | |
| gprod_28009 | 0 | 2 | 0 | 0 | 6 | 8 | 169.875 | |
| gprod_30860 | 0 | 2 | 1 | 1 | 13 | 17 | 540.706 | |
| gprod_32324 | 1 | 2 | 0 | 0 | 5 | 8 | 84.875 | |
| gprod_32353 | 1 | 2 | 2 | 1 | 4 | 10 | 92.3 | |
| gprod_32389 | 1 | 2 | 0 | 1 | 4 | 8 | 105.75 | |
| gprod_32514 | 3 | 2 | 5 | 3 | 17 | 30 | 78.1333 | |
| gprod_32663 | 2 | 2 | 1 | 2 | 24 | 31 | 653.065 | |
| gprod_32766 | 2 | 2 | 0 | 0 | 2 | 6 | 83.5 | |
| gprod_32802 | 3 | 2 | 0 | 0 | 1 | 6 | 156.667 | |
| gprod_32806 | 1 | 2 | 1 | 0 | 0 | 4 | 70.5 | |
| gprod_32878 | 0 | 2 | 0 | 0 | 8 | 10 | 76 | |
| gprod_7742 | 0 | 2 | 1 | 0 | 2 | 5 | 220 | |
| gprod_7745 | 0 | 2 | 3 | 0 | 11 | 16 | 167.688 | |
| gprod_7760 | 0 | 2 | 3 | 0 | 2 | 7 | 60.5714 | |
| gprod_7869 | 0 | 2 | 0 | 1 | 10 | 13 | 90 | |
| gprod_7884 | 1 | 2 | 4 | 0 | 5 | 12 | 225 | |
| gprod_8008 | 1 | 2 | 4 | 2 | 15 | 24 | 213.25 | |
| gprod_8064 | 0 | 2 | 1 | 3 | 11 | 17 | 356.176 | |
| gprod_8100 | 0 | 2 | 0 | 0 | 0 | 2 | 46 | |
| gprod_8130 | 0 | 2 | 1 | 0 | 0 | 3 | 70.6667 | |
| gprod_8131 | 1 | 2 | 0 | 0 | 2 | 5 | 298.4 | |
| gprod_8352 | 1 | 2 | 9 | 19 | 22 | 53 | 1635.38 | |
| gprod_8365 | 2 | 2 | 0 | 0 | 1 | 5 | 68.8 | |
| gprod_8440 | 0 | 2 | 3 | 1 | 3 | 9 | 131.556 | |
| gprod_8635 | 1 | 2 | 0 | 0 | 0 | 3 | 425.333 | |
| gprod_8876 | 1 | 2 | 1 | 0 | 1 | 5 | 41.2 | |
| gprod_9040 | 0 | 2 | 0 | 1 | 0 | 3 | 55 | |
| gprod_916 | 1 | 2 | 0 | 1 | 4 | 8 | 50.75 | |
| gprod_14386 | 4 | 3 | 6 | 2 | 29 | 44 | 577.295 | |
| gprod_19868 | 0 | 3 | 1 | 0 | 3 | 7 | 347.714 | |
| gprod_19999 | 1 | 3 | 3 | 0 | 4 | 11 | 241.364 | |
| gprod_20011 | 0 | 3 | 1 | 0 | 6 | 10 | 52.3 | |
| gprod_20260 | 0 | 3 | 0 | 1 | 0 | 4 | 96.5 | |
| gprod_20542 | 1 | 3 | 3 | 2 | 14 | 23 | 694.565 | |
| gprod_20669 | 3 | 3 | 4 | 2 | 9 | 21 | 307.286 | |
| gprod_28110 | 3 | 3 | 2 | 3 | 5 | 16 | 452.938 | |
| gprod_32423 | 2 | 3 | 0 | 1 | 11 | 17 | 194.941 | |
| gprod_32527 | 0 | 3 | 2 | 2 | 4 | 11 | 74.6364 | |
| gprod_32795 | 1 | 3 | 2 | 2 | 2 | 10 | 85.4 | |
| gprod_5572 | 1 | 3 | 0 | 0 | 1 | 5 | 27.8 | |
| gprod_7741 | 0 | 3 | 3 | 1 | 7 | 14 | 60.4286 | |
| gprod_7828 | 2 | 3 | 5 | 4 | 25 | 39 | 673.872 | |
| gprod_7894 | 3 | 3 | 1 | 0 | 2 | 9 | 169.889 | |
| gprod_15348 | 8 | 4 | 9 | 3 | 18 | 42 | 429.881 | Ce only weak sim to retrovirus- |
| | | | | | | | | related polyproteins |
| gprod_19947 | 4 | 4 | 6 | 4 | 19 | 37 | 444.676 | sim to C. elegans olfactory receptor |
| | | | | | | | | ODR-10 |
| gprod_20160 | 1 | 4 | 5 | 3 | 17 | 30 | 357.4 | similar to G-protein coupled |
| | | | | | | | | receptor |
| gprod_20201 | 4 | 4 | 4 | 3 | 13 | 28 | 397.5 | Ce only, LET-23 receptor protein- |
| | | | | | | | | tyrosine kinase |
| gprod_24016 | 4 | 4 | 4 | 3 | 22 | 37 | 264.73 | Ce olfactory receptor ODR-10 |
| gprod_26736 | 4 | 4 | 6 | 4 | 7 | 25 | 327.36 | chitinase, also ascomycetes |
| gprod_31697 | 3 | 4 | 9 | 8 | 47 | 71 | 734.211 | C with other Rhab collagen |
| gprod_32713 | 5 | 4 | 6 | 5 | 17 | 37 | 597.108 | Ce only |
| gprod_32730 | 6 | 4 | 4 | 3 | 13 | 30 | 205.633 | Ce only |
| gprod_7689 | 0 | 4 | 4 | 6 | 21 | 35 | 496.486 | Celegans only |
| gprod_7690 | 5 | 4 | 1 | 0 | 0 | 10 | 294 | Histone H2B |
| gprod_7868 | 1 | 4 | 4 | 3 | 11 | 23 | 279.043 | chitinase |
| gprod_8077 | 1 | 4 | 1 | 3 | 7 | 16 | 201.25 | Ce only |
| gprod_20981 | 5 | 5 | 5 | 4 | 18 | 37 | 486.946 | Ce only similar to collagen |
| gprod_32709 | 7 | 5 | 2 | 0 | 1 | 15 | 218.8 | Histone |
| gprod_7769 | 0 | 5 | 0 | 0 | 1 | 6 | 111.167 | Ce only |
| gprod_7836 | 2 | 5 | 5 | 5 | 25 | 42 | 295.452 | similar to Lectin C-type domain |
| gprod_9070 | 2 | 5 | 6 | 1 | 4 | 18 | 171.611 | CE only |
| gprod_15391 | 3 | 6 | 5 | 8 | 17 | 39 | 634.103 | Ce only weak sim mouse Zn finger |
| | | | | | | | | 5 protien |
| gprod_20153 | 2 | 6 | 10 | 4 | 26 | 48 | 728.292 | Ce only |
| gprod_21539 | 3 | 6 | 0 | 0 | 0 | 9 | 573.111 | Ce only |
| gprod_7758 | 4 | 6 | 2 | 1 | 7 | 20 | 284.45 | Histone H3 |
| gprod_8309 | 5 | 6 | 5 | 2 | 16 | 34 | 243.588 | mariner transposase |
| gprod_15294 | 4 | 7 | 3 | 0 | 19 | 33 | 1696.73 | Ce only |
| gprod_2547 | 1 | 7 | 0 | 1 | 0 | 9 | 189.111 | histone |
| gprod_7771 | 0 | 7 | 3 | 4 | 14 | 28 | 204.321 | Ce alone |
| gprod_8784 | 7 | 7 | 2 | 1 | 11 | 28 | 479.179 | Ce alone |
| gprod_19851 | 13 | 10 | 15 | 15 | 22 | 75 | 1031.37 | Ce only |
| gprod_19882 | 5 | 11 | 13 | 6 | 38 | 73 | 827.479 | Ce only similar to Transposase |
| gprod_14141 | 5 | 12 | 9 | 14 | 143 | 183 | 2326.21 | Ce only |
| gprod_19800 | 15 | 13 | 7 | 14 | 88 | 137 | 1154.35 | Ce only |
| gprod_26731 | 21 | 14 | 17 | 14 | 73 | 139 | 864.892 | Ce only olfactory receptor ODR-10 |
| gprod_32715 | 5 | 16 | 4 | 2 | 4 | 31 | 807.806 | major sperm protein |

One observation apparent from the Table is that genes that have multiple recent recruitments in C. elegans are unlikely to have clearly identifiable homologs in other phyla, while those that have few recent recruitments are more likely than average to have clearly identifiable homologs in other phyla.

Literature Cited

[All98] Allen, K. M., Gleeson, J. G., Bagrodia, S., Partington, M. W., MacMillan, J. C., Cerione, R. A., Mulley, J. C., Walsh, C. A. (1998) PAK3 mutation in nonsyndromic X-linked mental retardation. Nature Genetics 20, 25-30.

[Alt90] Altschul, S. F., Gish, W., Miller, W., et al. (1990) Basic local alignment search tool. J. Mol. Biol. 215, 403-410.

[Ash98] Ashburner, M. (1998) Bioessays 20, 949-954.

[Aya99] Ayala, F. J. (1999) Molecular clock mirages. Bioessays 21, 71-75.

[Bat00] Bateman, A., Birney, E., Durbin, R., Eddy, S. R., Howe, K. L., Sonnhammer, E. L. L. (2000) The Pfam protein families database. Nucl. Acids Res. 28, 263-266.

[Baz88] Bazan, J. F., Fletterick, R. J. (1988). Viral cysteine proteases are homologous to the trypsin-like family of serine proteases: structural and functional implications. Proc. Nat. Acad. Sci. USA 85, 7872-7876.

[Ben00] Benner, S. A., Chamberlin, S .G., Liberles, D. A., Govindarajan, S., Knecht, L. (2000) Functional inferences from reconstructed evolutionary biology involving rectified databases. An evolutionarily-grounded approach to functional genomics. Research Microbiol. 151, 97-106.

[Ben02] Benner, S. A., Caraco, M. D., Thomson, J. M., Gaucher, E. A. (2002) Planetary biology. Paleontological, geological, and molecular histories of life. Science 293, 864-868.

[Ben88] Benner, S. A. (1988) Reconstructing the evolution of proteins. in Redesigning the Molecules of Life, Benner, S. A., editor, Springer-Verlag, Heidelberg, 115-175.

[Ben89] Benner, S. A. (1989) Patterns of divergence in homologous proteins as indicators of tertiary and quaternary Structure. Adv. Enzym. Regulation 28, 219-236.

[Ben91] Benner, S. A., Gerloff, D. L. (1991) Patterns of divergence in homologous proteins as indicators of secondary and tertiary structure. The catalytic domain of protein kinases. Adv. Enzyme Regulat. 31, 121-181.

[Ben93] Benner, S. A., Cohen, M. A., Gonnet, G. H. (1993) Empirical and structural models for insertions and deletions in the divergent evolution of proteins. J. Mol. Biol. 229, 1065-1082.

[Ben93] Benner, S. A., Cohen, M. A., Gonnet, G. H. (1993) Empirical and structural models for insertions and deletions in the divergent evolution of proteins. J. Mol. Biol. 229, 1065-1082.

[Ben97] Benner, S. A., Turcotte, M., Cannarozzi, G., Gerloff, D. L., Chelvanayagan, G. (1997) Bona fide predictions of protein secondary structure using transparent analyses of multiple sequence alignments. Chem. Rev. 97, 2725-2843.

[Ben98] Benner, S. A., Trabesinger-Ruef, N., Schreiber, D. R. (1998) Post-genomic science. Converting primary structure into physiological function. Adv. Enzyme Regul. 38, 155-180.

[Ber93] Berbee, M. L., Taylor, J. W. (1993) Can. J. Bot. 71, 1114-1127.

[Bla00] Blanco P, Sargent C A, Boucher C A, et al. (2000) Conservation of PCDHX in mammals; expression of human X/Y genes predominantly in brain. Mamm. Genome 11, 906-914.

[Bow93] Bowring, S. A. et al., (1993) Science 261, 1293-1298.

[Bus99] Bush, R. M., Bender, C. A., Subbarao, K., Cox, N. J., Fitch, W. M. (1999) Predicting the evolution of human influenza A. Science 281, 1921-1925.

[Cho92] Chothia, C. (1992) One thousand families for the molecular biologist. Nature 357, 543-544.

[Cor00] Corpet, F., Servant, F., Gouzy, J., Kahn, D. (2000) ProDom and ProDom-CG: Tools for protein domain analysis and whole genome comparisons. Nucl. Acids Res. 28, 267-269.

[Day78] Dayhoff, M. O., Schwartz, R. M. & Orcott, B. C. (1978) Atlas of Protein Sequence and Structure (Dayhoff, M. O., ed.). Vol. 5, suppl. 3., 345, Nat. Biomed. Res. Found., Washington, D.C.

[Dil00] Dilcher, D. (2000) Toward a new synthesis: Major evolutionary trends in the angiosperm fossil record. Proc. Natl Acad Sci USA 97, 7030-7036.

[Doo87] Doolittle, R. F. (1986) Of Urfs and Orfs: A primer on how to analyze derived amino acid sequences. University Science Books: Mill Valley, 1986.

[Dor90] Dorit, R. L., Schoenbach, L, Gilbert, W. (1990) How big is the universe of exons? Science 250, 1377-1382.

[Dur94] Duret L, Mouchiroud D, Gouy M (1994) HOVERGEN. A database of homologous vertebrate genes Nucleic Acids Res 22, 2360-2365.

[Enr01] Enright, A. J., Iliopoulos, I., Kyrpides, Nikos C., Ouzounis, C. A. (2001) Protein interaction maps for complete genomes based on gene fusion events. Nature, 402, 6757-6762.

[Fet98] Fetrow J S, Skolnick J. (1998) Method for prediction of protein function from sequence using the sequence-to-structure-to-function paradigm with application to glutaredoxins/thioredoxins and T-1 ribonucleases. J. Mol. Biol. 281, 949-968.

[Fuk02] Fukami-Kobayashi, K., Benner, S. A. (2002) Joining structural biology with genomics using reconstructed ancestral sequences. The case for compensatory covariation. J. Mol. Biol. 319, 729-743.

[Gau01] Gaucher, E. A., Miyamoto, M. M., Benner, S. A. (2001) Function-structure analysis of proteins using covarion-based evolutionary approaches. Elongation factors. Proc. Natl. Acad. Sci. USA 98, 548-552.

[Ger97] Gerloff, D. L., Cohen, F. E., Korostensky, C., Turcotte, M., Gonnet, G. H., Benner, S. A. (1997) A predicted consensus structure for the N-terminal fragment of the heat shock protein HSP90 family. Proteins: Struct. Funct. Genet. 27, 450-458.

[Goh00] Goh, C.-S., Bogan, A. A., Joachimiak, M., Walther, D., Cohen, F. W. (2000) Co-evolution of proteins with their interaction partners. J. Mol. Biol. 299, 283-293].

[Goj82] Gojobori, T., Ishii, K., Nei, M. (1982) Estimation of average number of nucleotide substitutions when the rate of substitution varies with nucleotide. J. Mol. Evol. 18, 414-423.

[Gon92] Gonnet, G. H., Cohen, M. A., Benner, S. A. (1992) Exhaustive matching of the entire protein-sequence database. Science 256, 1443-1445.

[Gri87] Gribskov, M.; McLachlan, A. D.; Eisenberg, D. (1987) Profile analysis. Detection of distantly related proteins. Proc. Natl. Acad. Sci. USA 84, 4355-4358.

[Hen94] Henikoff, S., Henikoff, J. G. (1994) J. Mol. Biol., 243, 574-578.

[Hil01] Hilschmann N, Barnikol H U, Barnikol-Watanabe S, et al. (2001) The immunoglobulin-like genetic predetermination of the brain: The proto-cadherins, blueprint of the neuronal network. Naturwissenschaften 88, 2-12.

[Hil94] Hillis, D. M., Huelsenbeck, J. P. & Cunningham, C. W. (1994). Application and accuracy of molecular phylogenies. Science 264, 671-677.

[Hun92] Hunt, T., Purton, M. (1992) 200 issues of TIBS. Trends Biochem. Sci. 17, 273.

[Jac96] Jacob, U., Scheibel, T., Bose, S., Reinstein, J. (1996) Assessment of the ATP binding properties of Hsp90. J. Biol. Chem. 271, 10035-41.

[Jer95] Jermann, T. M., Opitz, J. G., Stackhouse, J., Benner, S. A. (1995) Reconstructing the evolutionary history of the artiodactyl ribonuclease superfamily. Nature 374, 57-59.

[Juk69] Jukes, T. H., Cantor, C. R. (1969) Evolution of proteins molecules. in Mammalian Protein Metabolism, H. N. Munro, ed. N.Y. Academic Press, pp. 21-123.

[Ken00] Kentrup H, Joost H G, Heimann G, et al. (2000) Minibrain/DYRK1A-gene: Candidate gene for mental retardation in Down syndrome? Klin Padiatr 212, 60-63.

[Kim83] Kimura, M. (1983). The Neutral Theory of Molecular Evolution. New York, Cambridge University Press.

[Kni91] [Knighton, D. R., Zheng, J., Ten Eyck, L., Ashford, F. V. A., Xuong, N. H. Taylor, S. S., Sowadski, J. M. (1991) Crystal structure of the catalytic subunit of cyclic adenosine-monophosphate dependent protein-kinase. Science 253, 407-414.

[Li85] Li, W. H., Wu, C. I., Luo, C. C. (1985) A new method for estimating synonymous and nonsynonymous rates of nucleotide substitution considering the relative likelihood of nucleotide and codon changes. Mol. Biol. Evol. 2, 150-174.

[Lib00] Liberles, D. A., Schreiber, D. R., Govindarajan, S, Chamberlin, S. G., Benner, S. A. (2001) The adaptive evolution database (TAED). Genome Biol. 2, 0003.1-0003.18.

[Lic96] Lichtarge, O., Bourne, H. R., Cohen, F. E. (1996) An evolutionary trace analysis defines binding surfaces common to protein families. J. Mol. Biol. 257, 342-358.

[Lip85] Lipman, D. J., Pearson, W. R. (1985) Rapid and sensitive protein similarity searches. Science 227, 1435-1441.

[LoC00] Lo Conte, L., Ailey, B., Hubbard, T. J. P., Brenner, S. E., Murzin, A. G., Chothia, C. (2000) SCOP: A structural classification of proteins database. Nucl. Acids Res. 28, 257-259.

[Lyn00] Lynch, M., Conery, J. S. (2000) The evolutionary fate and consequences of duplicate genes. Science 290, 1151-1155.

[Mad92] W. P. Maddison, D. R. Maddison, MacClade. Analysis of Phylogeny and Character Evolution. Sinauer Associates, Sunderland Mass. (1992).

[Mar99] Marcotte, E. M., Pellegrini, M., Ng, H. L., Rice, D. W., Yeates, T.O., Eisenberg, D. (1999) Detecting protein function and protein-protein interactions from genome sequences. Science 285: 751-753.

[May95] May, A. C. W., & Blundell, T. L. (1995). Automated comparative modeling of protein structures. Curr. Opin. Biotech 5, 355-360.

[McD91] McDonald, J. H., Kreitman, M. (1991) Adaptive protein evolution at the adh locus in Drosophila. Nature 351, 652-654.

[Mes01] Messier, et al. (2001) “Methods to identify polynucleotide and polypeptide sequences which may be associated with physiological and medical conditions”, Aug. 28, 2001, U.S. Pat. No. 6,280,953.

[Mes97] Messier, W., Stewart, C. B. (1997) Episodic adaptive evolution of primate lysozymes. Nature 385, 151-154.

[Neu97] Neuwald, A. F., Liu, J. S., Lipman, D. J., Lawrence, C. E. (1997) Extracting protein alignment models from the sequence database. Nucl. Acids Res. 25, 1665-1677.

[Pam93] Pamilo, P., Bianchi, N. O. (1993) Evolution of the zfx and zfy genes—rates and interdependence between the genes. Mol. Biol. Evol. 1, 271-281.

[Paz01] Pazos F, Valencia A. (2001) Similarity of phylogenetic trees as indicator of protein-protein interaction. Prot Engin. 14, 609-614.

[Pel99] Pellegrini, M., Marcotte, E. M., Thompson, M. J., Eisenberg, D., Yeates, T. O. (1999) Assigning protein functions by comparative genome analysis: Protein phylogenetic profiles Proc. Nat. Acad. Sci. 96, 4285-4288.

[Per87] Pearl, L. H., & Taylor, W. R. (1987). A structural model for the retroviral proteases. Nature 329, 351-4.

[Per95] H. S. Pereira, D. E. Macdonald, A. J. Hilliker, M. B. Sokolowski (1995) Genetics 141, 263-270.

[Pro97] Prodromou, C., Roe, S. M., O'Brien, R., Ladbury, J. E., Piper, P. W., Pearl, L. H. (1997) Identification and structural characterization of the ATP/ADP-binding site in the Hsp90 molecular chaperone. Cell 90, 65-75.

[Ril97] Riley, M., Labedan, B. (1997) Protein evolution viewed through Escherichia coli protein sequences: Introducing the notion of a structural segment of homology, the module J. Mol. Biol. 268, 857-868.

[Ros75] Rossman, M. G., Liljas, A., Branden, C. I., Banaszak, L. J. (1975) Dehydrogenases. in The Enzymes 11, 61-122.

[Rus96] Russell, R. B., Copley, R. R., Barton, G. J. (1996) Protein fold recognition by mapping predicted secondary structures. J. Mol. Biol. 259, 349-365.

[Sal95] Sali, A. (1995). Modeling mutations and homologous proteins. Curr. Opin. Biotech 6, 437-51.

[Sei00] Seilhamer, Akerblom; I. E., Altus, C. M., Kuingler, T. M., Russo; F., Au-Young; J., Hillman, J. L., Maslyn; T. J. (2000) “Database system employing protein function hierarchies for viewing biomolecular sequence data”, U.S. Pat. No. 6,023,659, Feb. 8, 2000.

[She85] Sheridan, R. P., Dixon, J. S., Venkataraghavan, R. (1985) Generating plausible protein folds by secondary structure similarity. Int. J. Pept. Prot. Res. 25, 132-143.

[Ste84] Sternberg, M. J. E., Taylor, W. R. (1984) Modeling the ATP binding site of oncogene products, the epidermal growth-factor receptor and related proteins FEBS Lett. 175, 387-392.

[Swo98] Swofford, D. L., Olsen, G. J., Waddell, P. J., & Hillis, D. M. (1996) Phylogenetic Inference in Molecular Systematics (eds. Hillis, D. M., Moritz, C. & Mable, B. K.) 407-514 (Sinauer Assc., Inc., Sunderland, Mass., 1996).

[Tak00] Takahashi, K., Nei, M. (2000). Efficiencies of fast algorithms of phylogenetic inference under the criteria of maximum parsimony, minimum evolution, and maximum likelihood when a large number of sequences are used. Mol. Biol. Evol. 17, 1251-1258.

[Tau97] Tauer, A., Benner, S. A. (1997) The B12-dependent ribonucleotide reductase from the archaebacterium Thermoplasma acidophila. An evolutionary conundrum. Proc. Nat. Acad. Sci. 94, 53-58.

[Tay84] Taylor, W. R., Thornton, J. M. (1984) J. Mol. Biol. 173, 487-514.

[Tay86] Taylor, W. R. (1986) J. Mol. Biol. 188, 233-258.

[Tho94] Thompson J. D., Higgins, D. G., Gibson, T. J. (1994). Clustal-W. Improving the sensitivity of progressive multiple sequence alignment through sequence weighting, position-specific gap penalties and weight matrix choice. Nucl. Acids Res. 22, 4673-4680.

[Tif02] Tiffin, P., Hahn, M. W. (2002) Coding sequence divergence between two closely related plant species: Arabidopsis thaliana and Brassica rapa ssp pekinensis. J. Mol. Evol. 54,746-753.

[Tra96] Trabesinger-Ruef, N., Jermann, T. M., Zankel, T. R., Durrant, B., Frank, G., Benner, S. A. (1996) Pseudogenes in ribonuclease evolution. A source of new biomacromolecular function? FEBS Lett. 382, 319-322.

[Tuf98] Tuffley, C., Steel, M. (1998) Modeling the covarion hypothesis of nucleotide substitution. Math. Biosci. 147, 62-91.

[Wier86] Wierenga, R. K., Terpstra, P., Hol, W. G. J., (1986) J. Mol. Biol. 187, 101-107.

[Yan97] Yang, Z. H. PAML: a program package for phylogenetic analysis by maximum likelihood. (1997) Comput. Appl. Biosci. 13, 555-556.

What is claimed is:

1. A process for identifying two pairs of paralogs as being functionally linked, said process comprising:
(a) estimating the date of divergence of the first pair,
(b) estimating the date of divergence of the second pair,
wherein the two pairs are hypothesized to be functionally linked in the event that the estimated dates of divergence are similar.

2. The process of claim 1 wherein TREx distances are used to estimate the dates of divergence of the paralogs, wherein the two pairs are hypothesized to be functionally linked in the event that the estimated TREx distances are similar.

3. An improvement over the process for identifying a pair of protein families as being functionally linked, said process comprising:
(a) constructing an evolutionary tree approximating the molecular history for each protein family,
(b) reconstructing models for the sequences of a plurality of ancestral genes represented by nodes in said trees,
(c) modeling features of the amino acid and nucleotide replacements during a plurality of the episodes of sequence evolution that are represented by branches in the trees,
(d) identifying a plurality of individual branches in one tree that correspond in geological time to individual branches in the other tree,
wherein identification of at least one pair of branches, one from one tree and the other from the second tree, that correspond in time, generates the hypothesis that members of the two families as being functionally linked to each other, if the features of said replacements in the separate families correlate significantly, wherein said improvement comprises using TREx distances to assist in identifying the correspondence in time between branches.

4. The improvement of claim 3, wherein said feature is a Kₐ/Kₛ value in excess of unity.

5. The improvement of claim 4, wherein said feature is a Kₐ/Kₛ value is significantly higher than the average Kₐ/Kₛ value for all branches on said tree where silent sites have not equilibrated, other than the branch being inspected.

6. The improvement of claim 3 wherein said calculation reflects lineage-specific parameters.

7. The improvement of claim 6 wherein said parameters comprise the codon bias in the organisms represented by nodes on the tree.

8. The improvement of claim 6 wherein said parameters comprise changes in codon bias during the episode.

9. The improvement of claim 3, wherein said feature comprises a change in the pattern and/or frequency of amino acid replacement in various subtrees within the family.

10. The process of claim 3, where said feature is a change in the sites that display homoplasy.

11. A computer system comprising a database of records pertaining to homologous protein sequences, wherein said records comprises a model for the evolutionary history of a plurality of said sequences, wherein said model comprises a multiple alignment of the sequences of a plurality of the proteins within the family, an evolutionary tree modeling the evolutionary relationship of said sequences, a multiple sequence alignment for the DNA sequences that encode said sequences, and a reconstructed sequence that represents the amino acid sequence of an ancestral protein within a region in the tree near its root. comprises ancestral sequences that have been reconstructed at a plurality of nodes of said tree, and comprises assignment of synonymous and non-synonymous mutations in the DNA sequence for a plurality of branches in said tree, wherein said family has at least five pairs of extant sequences where the product of the time separating the two sequences and the transition rate constant at silent sites is less than 2.8 and greater than 0.4.

12. The computer system of claim 11, wherein said family has at least five pairs of extant sequences where the product of the time separating the two sequences and the transition rate constant at silent sites is less than 1.4 and greater than 0.4. This ensures practical application of metrics involving transitions.

13. The computer system of claim 11, wherein said family has at least two subfamilies containing 10 or more sequences, wherein the pairwise relationship between sequences is in each subfamily is between 10 and 120 PAM units.

14. The computer system of claim 11, wherein said tree and multiple sequence alignment are constructed using different inputs to assemble connectivity in different parts of the tree.

15. The computer system of claim 11, wherein said multiple sequence alignment is rectified by a tool that identified misplaced introns.

16. The computer system of claim 11, wherein insertion and deletion events are placed on branches of the tree.

17. The computer system of claim 11, wherein said tree and multiple sequence alignments are constructed to include lineage specific information.

18. The computer system of claim 11, wherein the placement of gaps is adjusted to reflect empirical data showing preferred amino acids flanking and within gapped regions of a pairwise alignment.

19. The computer system of claim 11, wherein a root is placed on the tree using TREx distances.

20. The computer system of claim 11, wherein the evolutionary tree is adjusted to maximize the extent of compensatory covariation.

21. A process for functionally linking a protein family to a pre-selected physiology, the method comprising:
(a) identifying a date when said preselected physiological feature originated or underwent significant change,
(b) identifying an event within the molecular history of the family that occurred near said date that indicates a change in function within said family,
wherein identification of a significant event within the molecular history that occurs near the time of the origin or modification of said physiology, significant sequence similarity identifies the gene family as being functionally linked to the preselected physiology.

22. The process of claim 21, wherein said event comprises a gene duplication.

23. The process of claim 21, wherein said event comprises an episode associated with a high Kₐ/Kₛ value.

24. The process of claim 21, wherein said event comprises a change in the pattern of amino acid replacement frequency in various subtrees within the family.

25. The process of claim 21, where said event comprises a change in the sites that display homoplasy.

26. The process of claim 21, wherein said preselected physiology is the emergence of metabolic pathways.

27. The process of claim 21, wherein said preselected physiology is the emergence of advanced neurological function.

28. The process of claim 21, wherein the fossil record is used to establish the date of origin or change of the preselected feature.

29. The process of claim 21, wherein TREx dating is used to estimate dates for events in the molecular record.

30. The process of claim 21, wherein dates are estimated in the molecular record assuming that the sequences present on the leaves are orthologs, with that assumption being confirmed by TREx dating.

31. A process for generating a hypothesis that functional behavior has changed within a family of proteins during an episode of its evolution, wherein said episode is represented by a branch on an evolutionary tree that models the divergent evolution of proteins in the family, wherein said process comprises:
(a) calculating an estimate for the number of synonymous substitutions that have occurred during said episode,
(b) calculating an estimate of the number of non-synonymous substitutions that have occurred during said episode, and
(c) comparing the two estimates,
wherein the observation that the ratio of the two estimates is significantly higher than the average ratio, similarly calculated, for all branches on said tree where silent sites have not equilibrated, other than the branch being inspected, generates said hypothesis.

32. The process of claim 31 wherein said calculation reflects lineage-specific parameters.

33. The process of claim 32 wherein said parameters comprise the codon bias in the organisms represented by nodes on the tree.

34. The process of claim 32 wherein said parameters comprise changes in codon bias during the episode.

35. The process of claim 31 wherein only silent transitions are used to estimate the number of silent substitutions during the episode.

36. The process of claim 31 wherein an estimate of the time replaces an estimate the number of silent substitutions during the episode.

37. The process of claim 31 wherein the branch having a high ratio also joins two subtrees having different a patterns of amino acid replacement.

38. The process of claim 31 wherein the branch having a high ratio also joins two subtrees having different a sites displaying homoplasy.

39. The process of claim 31 wherein the branch having a high ratio also has low compensatory covariation.

40. The process of claim 31 wherein the amino acid replacements assigned to the branch having a high ratio are distributed within the three dimensional structure of the protein in a fashion consistent with functional change.

41. The process of claim 40 wherein the amino acid replacements assigned to the branch having a high ratio are near the active site.

42. The process of claim 40 wherein the amino acid replacements assigned to the branch having a high ratio are clustered on the surface of the folded structure.

43. A process for displaying a model for a protein comprising
(a) providing a computer graphics system that accepts coordinates of atoms in the protein molecule and displays a representation of these
(b) providing a model for the evolutionary history for a family of homologs of said protein molecule, wherein said model comprises a multiple alignment of the sequences of a plurality of the proteins within the family, an evolutionary tree modeling the evolutionary relationship of said sequences, a multiple sequence alignment for the DNA sequences that encode said sequences,
(c) reconstructing models for ancestral sequences at a plurality of nodes of said tree, and
(d) assigning replacements in the amino acid sequence, including fractional replacements, to a plurality of branches in said tree,
(c) identifying using the model one or more sites in the protein sequences whose evolutionary history is indicative of change in function and
(e) highlighting said sites on the displayed model of the protein.

44. The process of claim 43, wherein said sites to be displayed comprise sites where amino acids are replaced in a branch with a high Kₐ/Kₛ value.

45. The process of claim 44, wherein said sites to be displayed comprise sites where amino acids are replaced in branches with a low Kₐ/Kₛ value are first removed,

46. The process of claim 43 wherein said sites to be displayed comprise sites whose patterns and/or frequency of replacement are different in different subfamilies of the tree. Sites suffering changes along the branch that reverse hydrophilicity/hydrophobicity.

47. The process of claim 43 wherein said sites to be displayed comprise sites that display compensatory covariation along a branch.

48. The process of claim 43 wherein said sites to be displayed comprise sites that display homoplasy.

49. A process for identifying introns and intron-exon boundaries within a gene for a protein that comprises
(a) providing a model for the evolutionary history for a family of homologs of said protein, wherein said model comprises a multiple alignment of the sequences of a plurality of the proteins within the family, an evolutionary tree modeling the evolutionary relationship of said sequences, models for ancestral sequences at nodes within said tree, and multiple sequence alignment for the DNA sequences that encode said sequences,
(b) Adding, through alignment of the sequence of said gene, the gene to the multiple sequence alignment of the DNA,
(c) Placing on individual branches the tree insertions and deletion events that would be required to account for all of the gaps in the resulting multiple sequence alignment for the DNA sequences,
(d) assigning replacements in the amino acid sequence, including fractional replacements, to branches in said tree,
wherein any insertion or deletion event required to place a gap that is not associated with changes in the amino acid sequence that accompany insertions and deletions in a polypeptide chain is inferred to arise from an intron.

50. An improvement upon a computer system comprising a database of records pertaining to families of homologous protein sequences, wherein said records comprise a model for the evolutionary history of a plurality of said families, wherein said model comprises a multiple alignment of the sequences of a plurality of the proteins within the family, an evolutionary tree modeling the evolutionary relationship of said sequences, and a multiple sequence alignment for the DNA sequences that encode said sequences, wherein said improvement comprises using lineage-specific information to construct a plurality of said models.

51. The improvement of claim 50 wherein said database comprises a plurality of families that have at least five pairs of extant sequences where the product of the time separating the two sequences and the transition rate constant at silent sites is less than 2.8 and greater than 0.4.

52. The improvement of claim 50, wherein said database as delivered lacks DNA sequences.

53. The improvement of claim 50, wherein said records comprises ancestral sequences that have been reconstructed at a plurality of nodes of said trees.

54. The improvement of claim 50, wherein said records comprise assignment of synonymous and non-synonymous mutations in the DNA sequence for a plurality of branches in said tree.

55. The improvement of claim 50, wherein said records comprise information extracted from reconstructed ancestral sequences reconstructed at a plurality of nodes of said tree.

56. A computer system comprising a database containing records pertaining to pairs of paralogous gene sequences for a preselected taxon, wherein said records are ordered by the date in which they occurred in the historical past.

57. The database of claim 56 wherein said ordering is determined by the TREx distance separating the two sequences.

58. The database of claim 56, wherein said pairs of paralogs are clustered into groups based on the similarity of the TREx distance separating them.

59. A process for modeling the features of genomes within a lineage leading to a contemporary genome that comprises:
(a) Providing orthologous derived genes that encode proteins in two different taxa, one provided by the contemporary genome,
(b) Identifying a gene from a third taxon that serves as an orthologous outgroup for the first two,
(c) Modeling through reconstruction the sequence of the gene present at the node joining the three orthologs,
(d) Repeating this process for a plurality of orthologous derived genes,
(e) Collecting the reconstructed genes for the ancestral organism represented by said node.
(f) Generating a codon table for the genes within the organism represented by said node,
(g) Assigning synonymous and non-synonymous mutations that occurred during the evolution of the derived genes from their respective ancestral genes, and
(h) Estimating rate constants for mutation processes that occurred in the lineage that joins the ancestor to the derived taxa.

60. The process of claim 59 wherein the rate constant for mutation processes estimated for evolutionary episodes represented by one or more branches between nodes on a tree/

61. The process of claim 60 wherein rate constants for transitions is estimated.

62. A process for estimating the expected TREx distance between pairs of orthologs from two taxa, said process comprising
(a) Measuring the TREx distance between all intertaxa pairs
(b) For each family, selecting the pair with the smallest TREx distance
(c) Estimating the midpoint of the distribution of TREx distances for the phase of the distribution with the shortest TREx distance.

63. The process of claim 62, wherein f₂ values replace TREx distances, and the midpoint is obtained for the phase of the distribution of f₂ values with the largest f₂ values.

64. A process for identify within a set of homologous proteins, all members of a single family, from various taxa, those pairs that have a true orthologous relationship, said process comprising
(a) Estimating the TREx distance between each pair of homologs where silent sites have not equilibrated,
(b) Estimating the expected TREx distance between a pair of orthologous genes between the taxa involved,
(c) Interpolating the dates of divergence of various taxa
the orthologs are identified as those pairs in two taxa having TREx distances within one standard deviation of the expected distance of orthologs in the two taxa.
